(19) United States
(12) Patent Application Publication
(10) Pub. No.: US 2006/0041505 A1
(43) Pub. Date: Feb. 23, 2006

(54) Fee-based message delivery system

(75) Inventor: Robert A. Enyart, Arvada, CO (US)

Correspondence Address: PATTON BOGGS, 1660 LINCOLN ST, SUITE 2050, DENVER, CO, 80264, US

(73) Assignee: 900Email Inc., Arvada, CO (US)

(21) Appl. No.: 10/269,385

(22) Filed: Oct. 11, 2002

(51) Int. Cl. G06F 17/60

(52) U.S. Cl. 705/40

(57) ABSTRACT

The present invention relates to a system and method for fee-based messaging over a global communication network. A method is disclosed wherein a prospective recipient of messages establishes prices for a variety of services and for various tiers of senders. Generally, all messages to a recipient pass to a service provider which informs the sender of the price for a set of possible services, one example of which is the reading of an email text message. The sender then generally pays the price corresponding to the service requested, and the message is transmitted to the recipient.

### BACKGROUND OF THE INVENTION

1. Field of the Invention

The present invention relates in general to fee-based communication systems and in particular to an email communication system in which the person sending a message pays for the communication.

2. Statement of the Problem

Generally, a cost is incurred by a server system when transmitting electronic mail messages or other communication over communication networks. Accordingly, it is desirable to establish a mechanism for allocating the cost of operation of such servers to users transmitting data over such networks.

Existing systems have established procedures and mechanisms for charging users of a communication network to cover the costs of operating the networks. Specifically, U.S. Pat. No. 6,047,272, issued Apr. 4, 2000 to Biliris et al., which is hereby incorporated herein by reference, is directed to charging a sender and/or the recipient of a message a pre-determined price for the transmission of this message. U.S. Pat. No. 5,508,817, issued Apr. 16, 1996 to Toshio Kunigami, which is hereby incorporated herein by reference, discloses a system in which a sender, upon transmitting a message, designates which of the sender or recipient of a message will pay for the cost of message transmission.

U.S. Pat. No. 5,771,289 (the '289 patent), issued Jun. 23, 1998 to Andrew Kuzma, which is hereby incorporated herein by reference, discloses a system and method for selling credits for electronic mail communication. These credits are sold to users of a communication system and subsequently attached to message data along with authenticating information. These authenticated credits then indicate that the transmission with which each credit is associated has been properly paid for. It is noted that the '289 patent still concerns a means of transmitting value to the operators of a network or of servers on this network for their cost in conducting message communication.

Existing systems have provided mechanisms for collecting value from users of a communication network to benefit operators of the network. However, existing electronic messaging payment systems have not disclosed systems and methods for compensating users of communication networks for burdens caused by their interaction with such networks.

### SOLUTION

The present invention is directed to systems and methods for transferring value to clients of communication access to customers of a communication system which provides access to the clients for a fee. Generally, the operators of the communication system or communication network over which the clients and customers communicate keep a portion of the access fee paid by the customer. Effectively, a prospective recipient of a communication is able to require payment in exchange for granting access to the recipient.

In one embodiment of the present invention, a communication access client establishes an access fee for a particular form of communication, such as, for instance, electronic mail (e-mail) messaging. A customer wishing to communicate with this particular client preferably agrees to pay an access fee. Preferably, the customer may agree to pay the fee, or may agree to pay an additional fee beyond the access fee, in exchange for the assurance that a particular communication service will be performed by the client in connection with this message within a defined time period. For example, a customer may pay a fee to have a selected client read and/or reply to an electronic mail message transmitted by a customer within a defined time period.

It is desirable that verification be provided that service paid for has been performed. Accordingly, a suitable verification system may be implemented to allow the system to confirm that a particular client has retrieved a particular message, or further, to allow a client to declare that a particular message has been read. This declaration may be communicated to the customer by sending a reply message including an identification of the original message and the client, and an explicit or implied assertion that this original message was read by, or at least retrieved by the client. Alternatively or additionally, a client may charge a customer for having the client compose and send a message to the customer, preferably in response to an original customer message.

While the above discussion is directed to electronic mail messages, it will be appreciated that the inventive principles disclosed herein are applicable to a wide range of communication formats including, but not limited to, voice messaging, real-time (live) textual communication, such as in the form of a chat line, real-time voice communication, graphical communication (including photographs or animated images), and/or audio-visual data.

The services performed by a client for payment by a customer may include merely consuming the transferred data, such as by reading an email message or listening to a voice message. However, a customer may pay for, and a client may perform, additional services such as responding to a customer's communication or storing the customer's original communication in some permanent or semi-permanent record.

In a preferred embodiment, payment collected for a service performed on data transmitted by a customer is allocated in part to the client and in part to the provider of the communication service. However, payment may also be made to a charity selected by one or more of the customer, service provider, or the client.

The invention provides a method for conducting fee-based email messaging comprising: establishing by a prospective recipient of an email message a price for transmission of the email message; collecting a non-zero fee equal to the established price from a sender of the email message; and transmitting the email message to the recipient. Preferably the method further comprises paying at least a portion of the collected fee to an entity designated by the recipient. Preferably, the entity is the recipient. Preferably, the message is an electronic text message. Preferably, the message is an email voice message. Preferably, the message includes audio-visual information. Preferably, the collecting comprises receiving, along with the transmitted message, electronic postage corresponding to the established price. Preferably, the collecting comprises debiting a private account of the sender an amount corresponding to the established price. Preferably, the collecting comprises debiting the collected price from a credit card account of the sender.

Preferably, the establishing comprises: providing a plurality of sender tiers, each the tier corresponding to a different category of senders and each the tier having a separate established price; and determining the tier of the sender. Preferably, the price for one of the plurality of tiers is zero. Preferably, the establishing further comprises establishing by the prospective recipient of a client service price for performing a client service related to the email message; the method further includes performing the client service; and the collecting further includes collecting a client service fee corresponding to the client service price from the sender of the email message. Preferably, the service comprises a service selected from the group consisting of reading the message, responding to the message, and forwarding the message within a defined time period. Preferably, the service further includes reading the message, responding to the message, or forwarding the message within a rushed time frame. Preferably, the method further comprises guaranteeing the service. Preferably, the guaranteeing comprises: determining if the client service has been performed; and refunding the collected client service fee to the sender if the service has not been performed. Preferably, the establishing the client service price comprises: providing a plurality of sender tiers, each the tier corresponding to a different category of senders and each the tier having a separate established price; and determining the tier of the sender.

According to another aspect, the invention provides a method for conducting fee-based email messaging, the method comprising: establishing a plurality of tiers of senders of email messages to a recipient, each the tier corresponding to a different category of senders; and determining a price for email message transmission to the recipient for each the established tier of senders; determining the recipient of an email message; determining the tier of the sender of the email message to the recipient; and charging the sender the price corresponding to the tier for an email message sent by the sender to the recipient. Preferably, the determining comprises setting the message transmission price to zero for at least one of the established tiers. Preferably, the method further comprises transmitting the message from the identified sender to the recipient. Preferably, one of the plurality of tiers includes substantially only immediate family members and friends of the recipient. Preferably, one of the plurality of tiers includes substantially only work colleagues of the recipient. Preferably, one of the plurality of tiers includes substantially only commercial advertisers.

In yet another aspect, the invention provides a method for conducting fee-based messaging comprising: establishing, for each of a plurality of recipients, a plurality of tiers of senders of messages to the recipient; and determining a price for message transmission to the recipient for each the established tier of senders; determining the recipient; determining the tier of a sender of a message to the recipient; and charging the sender the price corresponding to the tier for a message sent by the sender to the recipient.

In yet another aspect, the invention provides a method for conducting fee-based messaging comprising: presenting a sender with a price for transmission of a message to a recipient; transmitting the message only if the sender pays the presented price; and guaranteeing a transmission by the recipient of a responsive message to the sender within a defined time period. Preferably, the guaranteeing comprises guaranteeing the transmission of the responsive message within a rushed time frame, wherein the rushed time frame is shorter than the defined time period. Preferably, the defined time period is between one day and three days. Preferably, the rushed time frame is less than one day. Preferably, the presenting comprises consulting a database of prices established by the recipient. Preferably, the guaranteeing comprises refunding the paid presented price to the sender if the recipient fails to reply to the sender within a defined time period. Preferably, the guaranteeing comprises refunding the paid presented price to the sender if the recipient fails to reply to the sender within a rushed time frame. Preferably, the message is an email message.

In yet another aspect, the invention provides a method for conducting fee-based messaging comprising: presenting a sender with a price for a transmission of a message to a recipient; collecting a fee from the sender corresponding to the presented price; transmitting the message to the recipient; and refunding the collected fee if the transmitted message is not read by the recipient within a defined time period. Preferably, the refunding comprises refunding the collected fee if the transmitted message is not read by the recipient within a rushed time frame. Preferably, the presented price is established by the recipient. Preferably, the presented price depends upon a tier of the sender. Preferably, the refunding comprises crediting an account of the sender. Preferably, the collecting comprises debiting a private account of the sender. Preferably, the collecting comprises debiting a credit card account of the sender. Preferably, the method further comprises paying a portion of the collected fee to the recipient. Preferably, the message is an email message.

In yet another aspect, the invention provides a method for conducting fee-based messaging comprising: establishing a price for a transmission of a message based upon an identity of a prospective recipient of the message; presenting a sender with the established price for the transmission of the message; and transmitting the message only if the sender pays the presented established price. Preferably, the price for transmission of the message is established by the recipient. Preferably, the establishing further comprises: providing a plurality of sender tiers, each the tier corresponding to a different category of senders and each the tier having a separate established price; and determining the tier of the sender. Preferably, the method further comprises paying a portion of the established price to the recipient. Preferably, the established price is also based upon a degree of promptness with which the transmitted message is read by the recipient. Preferably, the established price is paid employing stored indicia of electronic postal value. Preferably, the transmitted message is an email message. Preferably, the transmitted message is a voice message. Preferably, the transmitted message comprises graphical information. Preferably, the transmitting comprises a live telephone conversation. Preferably, the transmitted message comprises audio-visual information. Preferably, the method further comprises: establishing a price for composing and communicating a message to the sender in response to the transmitted message; and sending the composed responsive message to the sender only if the sender pays the established price for the composed responsive message.

In yet another aspect, the invention provides a computer program product having a computer readable medium having a computer program logic recorded thereon for conducting fee-based messaging, the computer program product comprising: code for receiving an identity of a recipient from a sender; code for determining a price for transmission of a message to the recipient based on the received identity; code for collecting the determined price from the sender; and code for transmitting the message to the recipient. Preferably, the computer program product further comprises code for maintaining a database of variables affecting a price of message transmission. Preferably, the database includes data describing a tier of the sender. Preferably, the database includes a list of services performable by at least one of a group of possible message recipients. Preferably, the database includes a registry of possible message recipients. Preferably, the database includes a list of data formats available for transmission to the recipient.

In yet another aspect, the invention provides apparatus for conducting fee-based messaging, comprising: a global network; a plurality of user sites, each the user site including communication equipment suitable for communicating data over the global network by both senders and recipients; a plurality of communication links coupling the plurality of user sites to the global network; and a service provider system coupled to the global network, the service provider system including a computer system and a database of communication recipients, and being configured to identify a price, determined by each the recipient, to be charged to a sender for contacting each the communication recipient. Preferably, the price is identified based on an identify of the sender. Preferably, the communication equipment included in at least one of the user sites is a personal computer. Preferably, the global network is the Internet. Preferably, the global network is a private network. Preferably, the user sites are usable by both the senders and the recipients. Preferably, the service provider system further includes a database of communication cost variables. Preferably, the database of communication cost variables includes information describing a tier of the sender. Preferably, the database of communication cost variables includes information describing a data format of a message. Preferably, the database of communication cost variables includes information describing a service performable by each the recipient.

In yet another aspect, the invention provides a method for authenticating the identity of a sender of a message to a recipient over a network, the method comprising: combining an identification of the sender and an identification of the recipient into a single combined identification; encrypting the combined identification; and transmitting a message including the encrypted combined identification. Preferably, the combining comprises establishing a defined time period after which the combined identification expires.

In yet another aspect, the invention provides a method for communicating over a network, the method comprising: composing a message, by a sender, for communication to a recipient in a fee-based messaging system; including an encrypted message within the composed message thereby creating a flagged message, the included encrypted message indicating a right to cost-free transmission of the flagged message through the fee-based messaging system; and transmitting the flagged message without charge to the recipient.

In yet another aspect, the invention provides a method for controlling access to a recipient, the method comprising: establishing a plurality of tiers of communication with a recipient by a sender; determining a separate access code for each the tier, thereby establishing a plurality of access codes; and providing a selected access code, of the plurality of access codes to the sender, corresponding to a particular tier of the tiers. Preferably, the providing comprises adding the sender to a list of senders authorized to access the particular tier.

Numerous other features, objects and advantages of the invention will become apparent from the following description when read in conjunction with the accompanying drawings.

### BRIEF DESCRIPTION OF THE DRAWINGS

FIG. 1 depicts a portion of a communications system suitable for use with a preferred embodiment of the present invention;

FIG. 2 depicts a portion of an exemplary computer system suitable for use with a preferred embodiment of the present invention;

FIG. 3 is a flow diagram showing a sequence of steps suitable for completing a communication service transaction according to a preferred embodiment of the present invention;

FIG. 4 is a block diagram showing the parties to a data transmission from a customer to a client and the service(s) which may be performed on this customer data according to a preferred embodiment of the present invention;

FIG. 5 is a block diagram showing the distribution of value paid by a customer according to a preferred embodiment of the present invention; and

FIG. 6 depicts a table of prices for communication services as a function of the type of service provided and of customer category.

### DETAILED DESCRIPTION OF THE PREFERRED EMBODIMENT

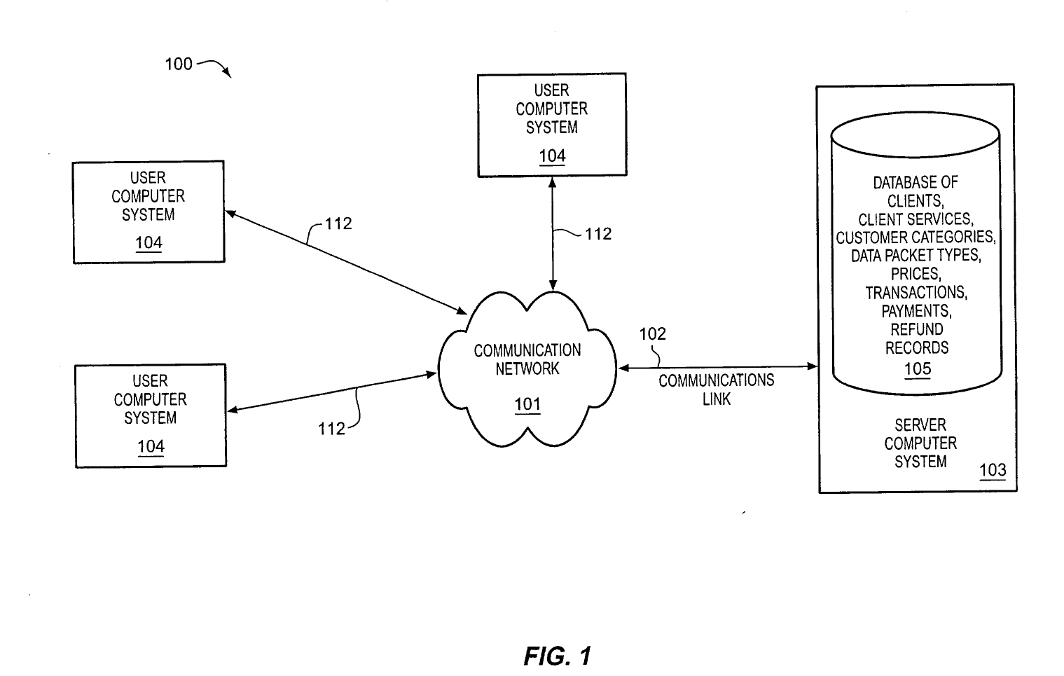

Herein the term “communication service” means a service provided by a service provider, such as the transmission of an email message or other communication from a sender to a recipient. The term “communication service provider” refers to an entity which provides such email service or other communications as described herein. The term “customer” generally corresponds to a person, group of people, institution, machine, or other entity which requests a communication service from a communication service provider in exchange for payment, by the customer, of an established price, or which requests a client service from a client in exchange for payment of a client service price. The term “tier” generally corresponds to an identification of a category of customers which may be employed to determine the cost of a communication service or a client service requested by a customer. Herein, the term “client” generally corresponds to a person, group of people, institution, machine or other entity that sells a communication service or a client service to a customer for a price. The term “client service” refers to an action performed by the client, such as retrieving a message received from a customer, reading a message received from a customer, responding to such a message, or forwarding such a message. In this disclosure, completion of this client service means completion thereof within a defined time period. Moreover, more than one defined time period may be established for completion of a client service. A schedule of time periods, or time limits, for performance of a client service may be established, with each such time period optionally having a separate cost. Generally, customers would expect to pay more for expedited service than for service within a conventional time period. Two time periods of these many possible time periods for response are referred to extensively in this disclosure. The “defined time period” is the usual time for response, while the “rushed time frame” corresponds to a client service to be performed in an expedited manner. However, these two periods are only two of a possibly large number of possible time periods for response which a customer may request, with each such time period optionally having a separate price associated therewith. Herein, the terms “customer data packet” and “data packet” generally correspond to one complete package of customer data transmitted to a client for rendering of a communication service. Herein, the term “service transaction” generally corresponds to one completed transaction involving payment of value by a customer and performance of a service by a service provider or a client. A customer may be a transmitter and/or a receiver of information. Likewise, a client may be a transmitter and/or a receiver of information. The term “email” is used as it is used in the computer art. FIG. 1 depicts a portion of a communications system 100 suitable for use with a preferred embodiment of the present invention. Preferably, each user computer system 104 is coupled to communication network 101 employing at least one communication link 112. Moreover, at least one server computer system 103 is preferably also coupled to communication network 101 via at least one communications link 102. In this manner, all data beneficial to operation of communication system 100 may be transmitted between any two user computer systems 104 and between server computer system 103 and any user computer system 104 or group of user computer systems 104. Although three user computer systems 104 are shown in FIG. 1, it will be appreciated that fewer or more than three such computer systems may be employed in connection with the present invention.

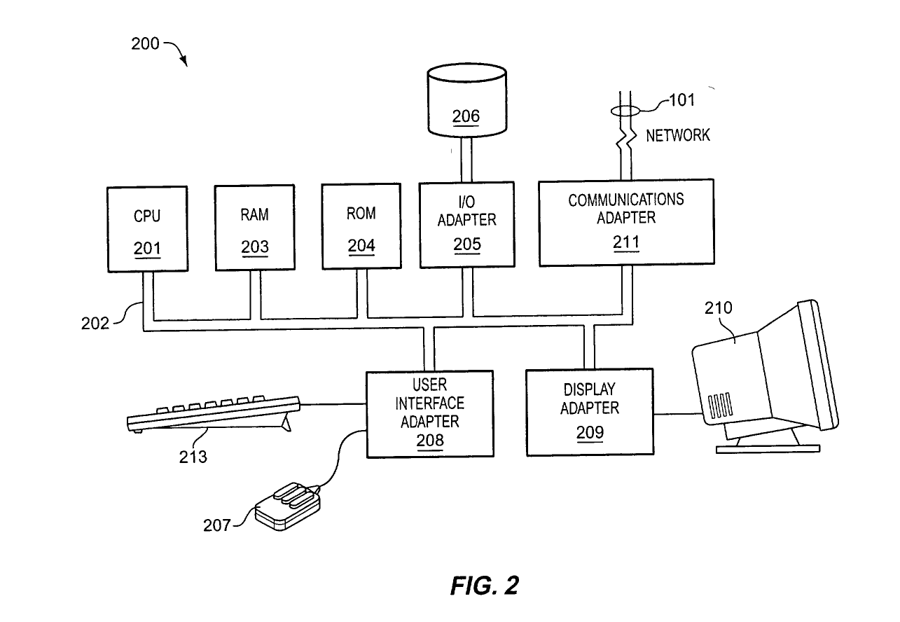

In a preferred embodiment, each of the instances of user computer system 104 preferably includes the equipment of computer system 200 described in connection with FIG. 2. Server computer system 103 also preferably includes the equipment described in connection with FIG. 2. However, a selection of the equipment included in server system 103 may be adapted to the particular needs of that system. For example, storage capacity sufficient for storing data associated with database 105 may be implemented within server system 103 although not necessarily in user computer systems 104. It will be appreciated that any of user computer systems 104 may be used by customers and/or clients of communication services according to a preferred embodiment of the present invention.

In a preferred embodiment, communication network 101 is a wide area network, which may be a global network such as the Internet, suitable for communicatively connecting user computer systems 104 distributed over a substantial geographical area. Alternatively, communication network 101 may be a local area network. Preferably, communication network 101 is a publicly accessible network. Alternatively however, communication network 101 may be a private network.

In a preferred embodiment, communication links 112 are suitable for connecting an array of dispersed user computer systems 104 with communication network 101. Thus, connection mechanisms usable for communication links 112 may include, but are not limited to, telephone modems, T1 connections, Digital Subscriber Line (DSL), and Cable modems, and all such variations are intended to be included within the scope of the present invention.

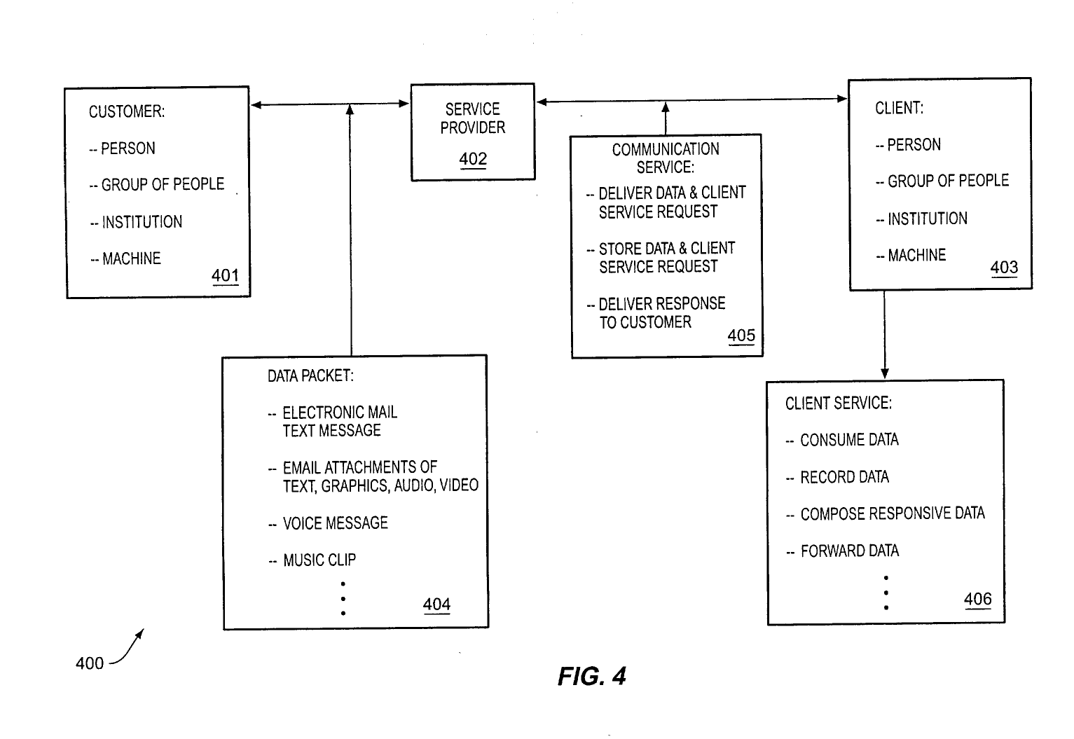

In a preferred embodiment, server computer system 103 preferably includes a general purpose computer, such as the one described in FIG. 2. Server computer system 103 preferably also includes a database 105 of clients, client services, customer types, data packet types, communication and service prices and cost variables, and records such as transaction records, payment records, and refund records. The various forms of data packet types and communication services are discussed in connection with FIG. 4.

FIG. 2 depicts a computer system 200 adapted to use the present invention. Central processing unit (CPU) 201 is preferably coupled to bus 202. In addition, bus 202 is preferably coupled to random access memory (RAM) 203, read only memory (ROM) 204, input/output (I/O) adapter 205, communications adapter 211, user interface adapter 208, and display adapter 209.

Preferably, RAM 203 and ROM 204 hold user and system data and programs, as is well known in the art. I/O adapter 205 connects storage devices, such as hard drive 206 or CD ROM (not shown), to the computer system. Communications adapter 211 couples computer system 200 to a local, wide-area, or communication network 101. User interface adapter 208 couples user input devices, such as keyboard 213 and pointing device 207, to computer system 200. Finally, display adapter 209 is driven by CPU 201 to control the display on display device 210. CPU 201 may be any general purpose CPU. The present invention is not restricted by the architecture of CPU 201, as long as CPU 201 supports the inventive operations as described herein.

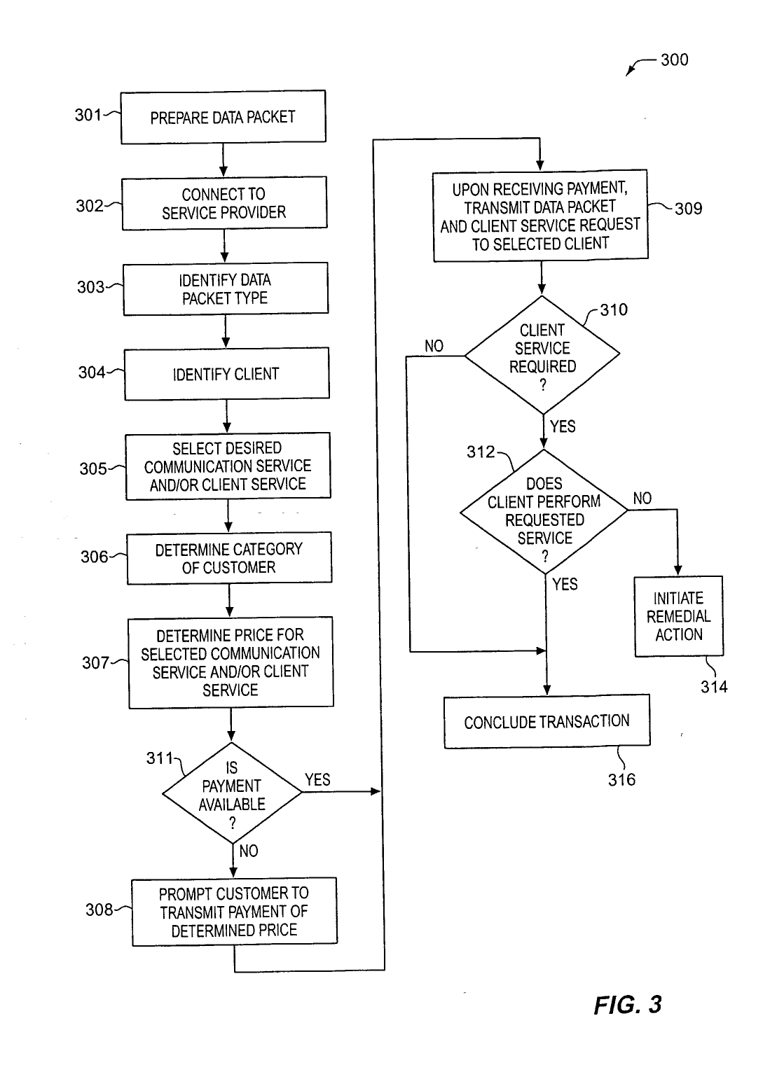

FIG. 3 is a flow diagram 300 showing a sequence of steps suitable for completing a communication service transaction according to a preferred embodiment of the present invention. At step 301, a customer 401 (FIG. 4) prepares a data packet for eventual transmission. This data packet may take various forms as will be discussed in greater detail in connection with FIG. 4. At step 302, the customer preferably establishes a connection with service provider 402 (FIG. 4) to enable an exchange of information between customer 401 and service provider 402.

In a preferred embodiment, customer 401 identifies the data packet type to service provider 402 in step 303. At step 304, customer 401 preferably identifies at least one client for which a communication service is sought or from whom a client service is sought. Of course, more than one client-recipient of such communication service or client service could be selected.

In a preferred embodiment, once the client is identified, a customer identifies at least one desired communication service and/or client service in step 305. For example, in the case of a text message, the communication service is preferably to send the text message to the client, and one common type of client service would be to have a selected client “read this text” message within a defined time period. However, a customer could additionally or alternatively request of the communication service that the message be stored in a record which could be subsequently accessed by any interested party. Further, a customer could request and pay for the service of having the client compose and transmit a message which is responsive to the customer's original message, or that the client forward the message to another entity.

In a preferred embodiment, the category or tier of the customer is determined in step 306. This determination may be made by service provider 402 based on the customer's name or other identification. Employing another approach, the customer could directly provide identification of his category. In yet another approach, the customer's category could be identified in advance by a client-recipient.

A preferred embodiment of the present invention provides a method for authenticating the identity of a sender of a message to a recipient over a network. This method preferably includes combining identifying information of a sender with information identifying a recipient into a single combined identification code. This combined identification code is then preferably encrypted. A message which includes this encrypted combined identification code is then preferably transmitted to the recipient. Using the described encrypted combined information preferably provides enhanced security over a system encrypting only a single piece of identifying information.

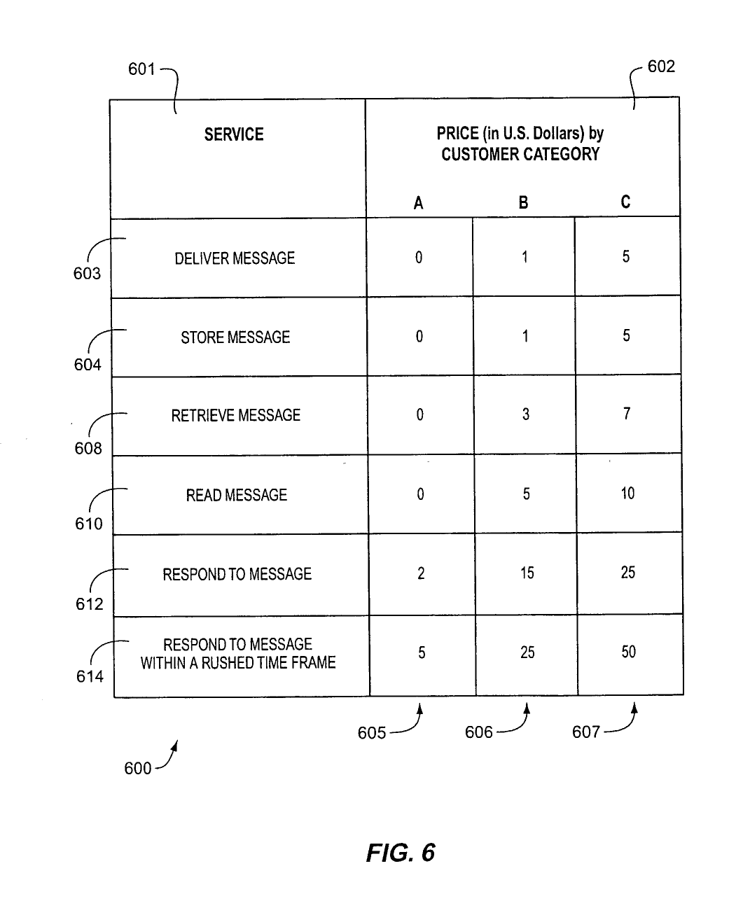

In a preferred embodiment, the price for the requested service or services is determined at step 307. It will be appreciated that the price for the selected service is preferably determined employing one or more of a set of factors including, but not limited to, the category (or “tier”) of the customer, the identity of the client, the type of communication service(s) provided, the type of client service(s) provided, and the time by which the service is sought to be completed. An example of a table of prices as a function of client identity, customer category, and type of communication service is shown in FIG. 6.

Preferably, decision block 311 determines whether payment for the requested service is available in manner other than having customer 401 transmit value over network 101. For example, value sufficient to cover the cost of the transaction could be available in a customer account with service provider 401, or in another account accessible by service provider 401. If the needed payment is “available,” in the manner described above, the required fee is collected, preferably by service provider 401, and step 308 is preferably skipped, with operation resuming at step 309. If the needed payment is not “available,” in the manner described above, operation continues at step 308.

Preferably, at step 308, service provider 402 prompts customer 401 to transmit payment of the fee corresponding to the price determined in step 307. Upon verifying receipt of payment from customer 401, service provider 402 preferably transmits the customer's data packet and client service request to the selected client. Verification of the customer's payment may occur through various means including, but not limited to, receiving a transmission of electronic credits, conducting an appropriate credit card transaction, debiting a private customer account with service provider 402, and/or accepting a customer's commitment to pay. The willingness to accept a customer's commitment to pay may be conditioned upon a particular customer's credit rating and the customer's past history in dealing with service provider 402.

In a preferred embodiment, at step 309, upon receiving payment from the customer, or upon accepting a customer's commitment for payment, the service provider transmits the customer data packet and communication service request to the selected client. In some instances, this transmittal may conclude the service transaction, and the process flows to 316. In other instances, the client must perform a client service, and the process flows to 312. If the client properly performs the requested service 312, the communication service transaction concludes at 316. If the client fails to perform the requested service 312, the service provider preferably initiates remedial action 314.

Preferably, any remedial action undertaken in step 314 depends upon the service requested by the customer. For example, where a customer requests a service including a guaranteed reply within a specified time period, a failure by the client to provide this reply within the stated time period constitutes a failure to perform the requested service. Accordingly, one remedy is to refund back to the customer any value received therefrom. Alternatively, where the client breaches an agreement to perform a service in the manner described above, the service provider may impose a financial penalty on the client and may transfer at least a portion of the value of this imposed financial penalty to the customer.

FIG. 4 is a block diagram 400 showing the parties to a data transmission from a customer to a client and the service(s) which may be performed on this customer data according to a preferred embodiment of the present invention. Generally, customer 401 interacts with service provider 402 to determine the cost of communication service 405 performed by the service provider or a client service performed by client 403 on data packet 404 prepared by customer 401. In the preferred embodiment, all communications to client 403 are routed through service provider 402, and then, if appropriate, further transmitted to client 403. Alternatively, data packet 404 may be sent directly from customer 401 to client 403 once authorization has been received from service provider 402.

In a preferred communication service transaction, the customer is a sender of information, and the client is a recipient of this customer information. However, in alternative embodiments, a customer may be a sender and/or a receiver of information. Similarly, a client may be a sender and/or a receiver of information. Moreover, a client may perform services instead of, or in addition to, sending and/or receiving information.

In one embodiment of the present invention, a customer is an individual person. However, a customer may be one of a group of entities including, but not limited to, a group of people, an institution, and a machine. For example, a group of people within an athletic team could pay to have a text message read, and/or responded to, by a celebrity, such as a professional athlete, in the name of their team. In this case, the entire team is a single “customer” for the purposes of the pertinent communication service transaction and the client service transaction.

The customer could also be an institution. For example, a school or company could pay to have a message or image viewed and/or responded to by a celebrity or government official on behalf of the entire school or company. In this case, the school or company or other institution would be a single customer.

Customer 401 could also be a machine. For example, a computer system could be programmed to pay a pre-determined price to receive proof that a party (a client) has received and read a message. This could be used to demonstrate that a particular party (client) has been given official notice of fact of legal or business significance. Alternatively, a computer system could use proof of data consumption (reading of a text message, viewing of an image etc.) by a client as proof that a desired advertising contact has been achieved for one or more possible consumers.

As with customer 401, client 403 may also be one of a person, group of people, institution, or machine. However, client 403 is not limited to being one aforementioned entity. In one embodiment, a client could be an entertainment celebrity, politician, or other famous person. In this case, customers would pay for access to this client, for example, by having a celebrity read and/or respond to an email text message. A customer could also be a group of people, such as the cast of an entertainment production, a professional sports team, or a political body. In this case, a customer could pay to have such a group read a text message or listen to an audio message and, optionally, provide a response to this message within a defined time period.

A client could also be an institution. In this case, a customer could pay to have a data transmission reviewed by and, optionally, responded to by this institution. For example, a customer could submit a text or audio message to a radio station conducting a contest and be required to pay to have the message reviewed by one or more responsible officials of the institution concerned. Where appropriate, the right to receive a responsive message could also be purchased by the customer.

A client could also be a computer or other type of machine. In this case, any money paid would generally be directed to a person or institution in control of this machine. However, review and processing of the customer's data could be performed by a machine. For example, a message optionally including an attached data file could be sent to a computer for long term storage and record keeping. In another example, a customer could pay to have a message analyzed and processed by a machine and receive a reply in connection with this analysis. More specifically, a customer could pay to have a document checked for originality and/or accuracy. For example, a mathematical computation, in the form of a text message, could be examined by a client-machine for accuracy. A text passage could be compared with a large library of text to determine its originality and return a list of documents most closely matching the content of the submitted document in terms of literal text.

In one embodiment of the present invention, customer data packet 404 is an electronic mail text message. In this case, “consumption” of data by client 403 generally involves retrieving the message, and, preferably, reading the message within a defined time period. Responding to a data packet in the form of an electronic mail message preferably includes having client 403 compose an electronic mail text message responsive to the customer's original text message. However, an email message from a customer could request a response in a form other than a text message. Likewise, other customer data packet types may call for responses in a form which differs from the form of the customer's original data packet type.

Alternative formats of customer data packet 404 include, but are not limited to, email voice messages, facsimile transmission, telephone messages, audio messages such as music clips, graphical information such as photographs or animations, and audio-visual information. It will be appreciated that more than one data format may be combined in a single customer data packet. For example, a text message could be accompanied by a photograph in a single customer data packet. One example of a communication service transaction involving one of the alternative formats includes having a customer pay to ensure that a selected celebrity or music industry employee listen to a music clip included in a customer data packet within a defined time period. This approach could provide an effective method of screening artistic efforts since the cost of accessing the desired client would tend to inhibit transmissions from customers lacking confidence in a particular musical or other artistic effort. The same principle is applicable to advertising for a musical or other artistic effort.

In a preferred embodiment, the service provider performs a communication service 405 in connection with data packet 404, which may be to deliver the data packet, deliver a client service request, or both, store the data packet for later delivery or reading by one or more clients, store a client service request for later delivery or later reading, delivering a client response to a customer, etc. Client 403 receives data packet 404 and/or performs a communication service 405 in connection with data packet 404 from customer 401. Services which may be performed by client 403 in connection with the customer's data include, but are not limited to, consuming data, recording data, composing data, and forwarding data in response to the customer's data. The implementation of the described services varies with the type of data transmitted by customer 401. Where the customer's data is a text message, consumption of this data generally involves reading the message. Preferably, some form of confirmation is sent by client 403 to indicate that the message has been read. Likewise, confirmations are preferably also sent to indicate completion of the various alternative forms of client service.

The manner in which the client consumes data preferably corresponds logically to the type of data sent by the user. Thus, where a customer sends a music clip to a client, the client consumes this data by listening to the music clip and then preferably transmitting a message confirming completion of this act. Where a customer transmits a photograph, a client generally “consumes” this photograph by looking at it. Similarly, a client would consume an audio-visual clip by watching and listening to the clip. Forwarding data, for example, may include forwarding an audio-visual clip by an agent to a studio. Although requests for the above-described types of data consumption would generally be expected for their respective data types, a customer is free to request any physically realizable form of data consumption for any data packet type.

A client may also record data transmitted by a customer. In the case of a text message, recording preferably includes storing the customer's message in association with a particular event or topic. The customer may store the message in several ways including, but not limited to, electronically and in printed form. In the case of a voice message or music clip, a client could “record” the customer's data by preserving the customer's voice message or music clip in an appropriate electronic file.

A client may also compose a response to a customer data transmission. In the case of a text message, a client response would preferably include having the client compose a text message responsive to the customer's message and transmit this message to the customer within a defined time period. Depending upon options selected by the customer, such a responsive message may or may not be guaranteed to arrive within a stated time period. Moreover, a failure to reply at all, or failure to reply within a particular time, could cause the service provider to refund the customer's payment and to impose a financial penalty on the client. This penalty may include but is not limited to debiting the client's account by a selected amount.

Elsewhere herein, assorted examples of data packets, communication services, and client services have been provided to illustrate the meaning of the various categories of customer data and services available for such data. In this section, a more extensive, although illustrative, list of such examples is provided, in order to better illustrate the breadth of the present invention. It will be appreciated that the present invention is not limited to the specific embodiments discussed below.

One benefit of imposing a cost for accessing a client is that of limiting email and other communication access to those willing to pay for such access. Many Internet users are subjected to a large amount of unsolicited commercial email traffic. Transmitters of such commercial messages can currently transmit email messages to an enormous number of recipients at very little cost. Imposing a cost on the senders of such “mass” mailings would tend to reduce the number of such unsolicited commercial messages received by many Internet email users. Moreover, the resulting payment to the client-recipient would operate as an inducement to this client to read the reduced number of messages actually transmitted. Accordingly, using the fee-based messaging disclosed herein would generally operate to reduce the unsolicited email traffic to the addresses of Internet email users and to provide such Internet email users with additional income. The described process of screening advertising communication is applicable to charging a customer for access to a client for purposes of receiving voice mail messages, live telephone contact, video-conferencing, and communication employing still other data formats.

In a preferred embodiment, the fee-based messaging system disclosed herein may be employed to efficiently conduct and compensate advertising efforts using various forms of communication. In one embodiment, an advertiser would select an initial list of recipients of an email advertising message. Preferably, this list includes the email addresses and the cost for having a message read for each recipient on the list. Optionally, the list could include additional advertising-related information such as the profession and income level of each recipient.

Thereafter, the advertiser preferably pays an appropriate fee to a service provider in order to transmit the message to recipients on the list. The fee amount is preferably distributed among the service provider and those message recipients who retrieve the message. Preferably, a confirmation is provided to the advertiser for each recipient who retrieves the transmitted message within a defined time period.

In a preferred embodiment, the advertiser could then use a list of confirmations arising from a mass mailing to quantify the amount of actual customer readership of the distributed advertising materials. This quantified customer readership could then be supplied to a manufacturer and/or distributor of a product to demonstrate the quality or quantity of advertising contact achieved. It will be appreciated that use of the fee-based messaging system for advertising is applicable to the use of data formats other than email text messages including, but not limited to, voice messaging, facsimile transmission, and live telephone contact.

In a preferred embodiment, the fee-based messaging system could be employed to submit artistic works for review or for modification by a recipient. In one embodiment, a musician could transmit a song, or portion thereof, to a recording industry executive. The price paid by the artist (sender) would ensure that the executive at least listens to the song. A separate charge could be imposed on the sender to procure a substantive review or comment on the song, or for the executive to forward the song to a particular entertainer associated with the recording company. As with fee-based advertising, discussed above, the imposition of a fee on the artist tends to encourage careful selection of artistic efforts submitted for review. The required fee preferably also serves as an inducement for the executive to listen to the submitted musical work. Further activity by the recipient (executive) may be motivated by a profit motive in addition to any fee provided to the recipient by the fee-based messaging system. The described method for submitting works of art for review is applicable to works of art, stored in other data formats, including, but not limited to, photographs, drawings, literature, and audio-visual works.

In a preferred embodiment, a customer may purchase a right to a guaranteed reply from the recipient (client) of the message. Optionally, this right to a guaranteed reply may include a guarantee of receiving a reply within a fixed period of time established by the service provider, the client, and/or the customer. Selecting this feature would generally be more expensive than merely requesting that a recipient read a sender's message. A failure by a client-recipient to respond within a stated time period (in the case of fixed time reply option) preferably causes the service provider to refund any collected amount to the customer and to optionally impose a financial penalty on a client breaching an agreement to respond to a message.

In a preferred embodiment, a customer is entitled to a refund of any collected amount when a client fails to perform a communication service paid for by the customer. Where the service requested is that of reading a text message, a client's failure to retrieve the message would preferably cause the service provider to refund to the customer any value paid for the unperformed service. The described refund policy may be applied to any communication service ordered by a customer and not performed by a client, as detectable by service provider 402.

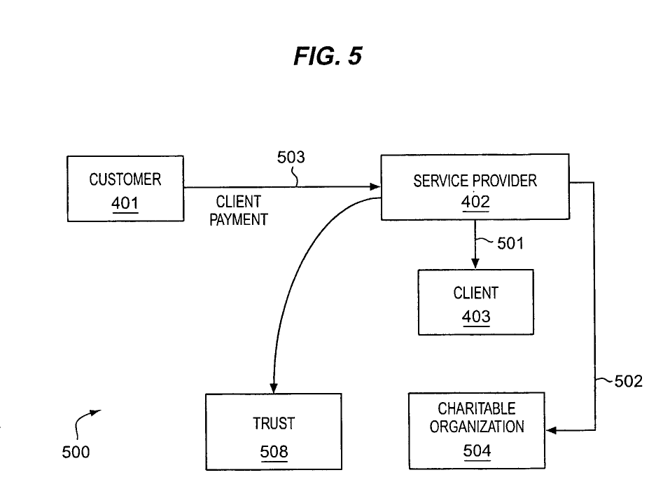

FIG. 5 is a block diagram 500 showing the distribution of value paid by a customer according to a preferred embodiment of the present invention. In a preferred embodiment, service provider 402 collects a payment 503 from customer 401 upon receiving a request for communication service from the customer. Customer 401 payment 503 is preferably distributed between service provider 402 and client 403 via payment 501. Payment 502 may optionally be made to a charitable organization 504, a trust 508, or other entity, if client 403 requests or agrees to such payment.

In a preferred embodiment, both customers and clients establish accounts with service provider 402. Preferably, both customers and clients establish various characteristics of their respective accounts. Specifically, a client generally establishes the prices to be charged for various services such as receiving a message, reading a message, guaranteeing a response to a message, and composing and sending a response to a message. Generally, any client may change the prices of the services available from that client at any time.

Generally, a client will establish a set of tiers into which prospective senders are classified. The client will generally also establish different prices for various services for different tiers. The determination of which tier a sender falls into may be made by service provider 402 or be asserted by the sender. Alternatively, the client may specify which tier particular customers or senders fall into. When even greater specificity is desired, a client may simply establish a particular price for a particular customer. For example, the price for reading a message could be $2 for members of the client's church, $5 for work colleagues, $10 for commercial advertisers, and $100 for a particular individual named “Sam”. Clients may also establish one or more tiers for which services are provided free of charge. Preferably, a sender may establish a maximum amount which may be debited from his account for any one communication service transaction and/or for a particular time period.

In one embodiment, a method is provided which allows a message to include a flag which signals that the message is entitled to cost-free transmission from a sender to a recipient. This method preferably includes having the sender compose a message for transmission to a recipient in a messaging system which is generally fee-based. An encrypted code or message is preferably added to the composed message to create a flagged message, which flagged message indicates a right to cost-free transmission of the flagged message through the fee-based messaging system. The flagged message is then preferably transmitted through the fee-based messaging system without charge.

FIG. 6 depicts a table 600 of prices for communication services as a function of the type of service provided 601 and of customer category 602. It will be appreciated that table of prices 600 is an exemplary set of prices associated with a single client. Different clients may establish different prices for a portion of, of the entirety of, the services and customer categories depicted in FIG. 6. It will be appreciated that the services which a client may provide are not limited to those depicted in table 600. Further, it will be appreciated that a number of customer categories fewer than or greater than three may be employed, and that many category definitions beyond the exemplary ones identified in FIG. 6 may be employed, and that all such variations are intended to be included within the scope of the present invention.

In a preferred embodiment, a client may charge a customer a different price depending upon the communication service provided. It may be seen, for customer category B 606, that delivering 603 or storing 604 the message costs $1, reading 610 the customer message costs $5, responding 612 to the customer message costs $25, and responding to the customer message within a rushed time frame 614 costs $50. The responding within a particular time service may be subdivided into different times. For example, responding within a week may cost one fee, while responding within one day may cost a higher fee. Clients may generally establish whatever prices they wish for particular services. However, services which are lesser included entities of other services would generally cost less than the service incorporating the lesser service. For example, responding to a customer message generally includes reading the customer message. Accordingly, the charge for responding to a message will generally exceed that for reading a customer message.

In a preferred embodiment, a client may charge different prices for different categories of customers for the same service. In the exemplary case of table 600, category A 605 is limited to non-profit customers, category B 606 primarily includes registered members of an association, and category C 607 primarily includes members of the general public. Other categories or tiers of senders may include members of the client's immediate family, more distant relatives, work colleagues, members of athletic or social clubs, and persons affiliated with government agencies.

In the exemplary case of table 600, the non-profit category pays the least, followed by members of a registered members category. In table 600, members of the general public pay the highest prices for each service. It will be appreciated that clients can readily modify this arrangement so as to charge whatever they wish for any category of customer.

In a preferred embodiment, at least one category of customer may receive at least one communication service free. It may be seen that in the case of the price schedule set out in table 600, customers in category A pay nothing for having a client read 610 a customer message or for having the service provider store 604 a customer message. In one embodiment, such free service may be affected by having the client pay for the customer's use of the service provider's resources. In an alternative embodiment, a client need not provide any services without charge.

In one embodiment, a client may enable a customer to communicate with the client without charge by establishing a “prepaid tier” and providing the names of customers falling within this tier. The client may assume responsibility for whatever charges are accrued by customers within this prepaid tier. Alternatively, the client may pay a fixed amount per month to allow selected customers to send an unlimited number of messages without charge.

A feature of the invention is that the price for delivering the message is determined by the identity of the recipient. Here, “identity” means who the recipient person or entity is. That is, the price for delivery to one specific individual will generally be different from the price for a second specific individual. This is to be distinguished from other forms of messaging in which the price depends only on the quantity contained in a message and on a category into which the person fits, such as living a certain distance away, having a certain area code, residing in a certain country, state, or city, etc.

There have been described what are, at present, considered to be the preferred embodiments of the invention. It will be understood that the invention can be embodied in other specific forms without departing from its spirit or essential characteristics. For example, while the system has been described in terms of an email provider also being the entity that determines and charges for the services, it is possible that the determining or charging for the services can be done by one entity and the actual sending of the message be done by a separate entity, such as a conventional email provider. As another example, each of the inventive features mentioned above may be combined with one or more of the other inventive features. That is, while all possible combinations of the inventive features have not been specifically described, so as the disclosure does not become unreasonably long, it should be understood that many other combinations of the features can be made. The present embodiments are, therefore, to be considered as illustrative and not restrictive. The scope of the invention is indicated by the appended claims.

The following appendix is a technical specification for system developers. The present invention is not limited to the specific systems, methods, and apparatus described in the provided appendix.

### APPENDIX

### 900Email Requirements Document

Overview

900Email provides our Clients with Email accounts that virtually eliminate incoming junk mail by charging email senders a postage fee. A 900Email Client who receives incoming email gets to keep a major percentage of the postage fee (currently 91%) and 900Email retains the balance of the fee (currently only 9%) as a primary revenue source. Senders can apply postage to email simply by purchasing “EPostage” online, buying enough to send one or more messages. 900Email will then automatically credit most of that EPostage, when used, to our Clients.
Definition—Client: Someone who has established a 900Email mail account with his own unique identifier (Email ID) on the system. (Ex. Johnsmith@900Email.com.)
Definition—Customer: Someone who maintains an EPostage account or who pays to send just a single message to a 900Email Client. The one who pays the bill is the true Customer. So, though the email senders may be far more remote from 900Email than our Clients, still, the email sender is our actual Customer to whom we have the greater obligation. We must please the Customer, or we fail. However, every Client automatically gets an EPostage account, so every Client is also a Customer.

900Email permits Clients to charge different rates to senders listed on different EPostage Tiers, and even enables the Client to receive “no postage necessary” emails from certain senders by prepaying for EPostage, much as people use self-addressed-stamped-envelopes and maintain 1-800 phone numbers. And among other major features, 900Email Clients can offer a Guaranteed Reply that would cost the sender an additional amount of EPostage (as determined by the Client), and again, the Client would get the major share of that Guaranteed Reply!

This requirements document has been written by the 900Email Product Manager, which is a marketing and not a technical position. So developers, please forgive any technically naïve elements and provide feedback so as to improve this document. Also, while our lawyers have informed us that this document may be included as an appendix to our patent application, it has not been written for public consumption and should not be otherwise distributed outside of the company.

Each requirement (and constraint) has a unique number to help improve clarity and track development status. “Requirements” typically lend themselves to alternative means of implementation. “Constraints,” on the other hand, impose a much more fixed and predetermined implementation. For example, different designers might choose differently defined data structures to manage EPostage accounts. Whereas, all designers supporting the ARPANET RFC 822 Email message standard will be constrained as to data fields, lengths, types, etc. This document attempts to distinguish between requirements and constraints by identifying a: [constraint] thusly. Also, these requirements ARE NOT SCOPED! That is, these requirements describe our service as it may exist by version 2.0, 3.0, or 4.0. The first public release will have a streamlined subset of the following features to achieve our goal of being the first to market with a sender-pays email system.

The chapters in this document correspond to the numbers on this list. These feature buckets comprise the entire 900Email corporate computing system:
1. General Requirements
2. Client Features
3. Customer Features
4. Website (900Email.com)
5. Desktop Client Software (900Email.exe & 3rd-party)
6. Customer Service
7. Operations support including reports
8. System Engine
9. Email Kernel Wrapper

This document has various target audiences. To get you quickly to the most relevant information for your needs, you can begin by looking at these sections, based on your role:

| | |
|---|---|
| Accountant | Client Features (section 2, p. 45) |
| | Customer Features(section 3, p. 92) |
| | Operations, Accounting Needs (section 7.7, |
| | p. 134) |
| Investor | Client Features (section 2, p. 45) |
| | Customer Features (section 3, p. 92) |
| | Mail Hosting and Licensing (sections 1.8, p. 39 |
| | and 1.9, p. 40) |
| Marketing | Client Features (section 2, p. 45) |
| | Customer Features(section 3, p. 92) |
| | Mail Hosting and Licensing (sections 1.8, p. 39 |
| | and 1.9, p. 40) |
| | Scan for Business Notes throughout |
| Programmer, General | Client Features (section 2, p. 45) |
| | Customer Features(section 3, p. 92) |
| | Plus other sections as assigned by the team leader |
| Programmer, Kernel | Kernel Requirements (section 9, p. 163) |
| | Client Features, Validating EPostage (section 2.8, |
| | p. 65) |
| | And for a fuller overview: |
| | Client Features (section 2, p. 45) |
| | Customer Features(section 3, p. 92) |
| Support Staff | Client Features (section 2, p. 45) |
| | Customer Features(section 3, p. 92) |
| | Customer Service (section 6, p. 121) |
| System Architect | Entire Document |
| Test Engineer | General Requirements (section 1, p. 28) |
| | Sections describing functions being tested |

Where applicable, the subsections in this suggested reading list will refer the reader back to General Requirements and other prerequisites, so that no important piece of the puzzle should be missed by skipping ahead.

1. General Requirements

900Email shall support ten areas of General Requirements (and constraints). The first seven areas depict customary requirements throughout the software industry. Our acronym PARSSUM refers to these areas of common functionality:
Performance,
Availability,
Reliability,
Scalability,
Security,
Usability, and
Maintainability.

The last three areas of General Requirements regard the 900Email-specific features of:
Multi-domain Support,
Licensing, and
Inter-Connectivity.
   1.1. Performance

900Email shall support the following Performance requirements:

1.1.1. Website Performance: 900Email shall support these Website performance requirements:

1.1.1.1. Internet Connectivity: 900Email web servers shall have very high-speed, state-of-the-art, access to the Internet backbone.

1.1.1.2. Webpage Response Time: The 900Email website shall perform with optimal efficiency providing comparable response time to the most popular and successful industry websites.

Business Note—Comparable Peifoirmailce: 900Email regards the most successful websites, like Microsoft.com, Yahoo.com, and Ebay.com, as establishing the benchmark for good performance. Whatever computing resources are required to achieve performance comparable to these leading Internet websites, those resources should be identified to management, and, if purchase is authorized, then obtained and utilized.

1.1.2. System Capacity: Capacity requirements will be based upon prototype performance and fine-tuned thereafter.

1.1.2.1. Web Page Servers: Shall be stated in terms of average visits per minute, pages per visit, and the percent of customized pages verses static pages.

1.1.2.2. Database Servers: Shall be stated in terms of transactions per minute.

1.1.2.3. Email Servers: Shall be stated in terms of number of messages per minute, the average message volume, and Clients per email server.

Business Note—Capacity Questions: At this early time, we are preliminarily expecting to support 30,000 Clients per email server. And we have not yet quantified many high-level capacity issues such as the average number of Customers (senders) that will attend to each Client. For every 1,000 Clients we sign up, in a one-year period how many Customers per Client will we also sign up? A percentage of Clients will become “Customers” to other Clients, when they send Email messages to other Clients. So, what percentage of Customers will also function as Clients? And what percentage of Customers will send only a single message? And what percentage of Customers will send messages to only a single Client? These questions are among those that need careful estimates in order to begin to quantify capacity requirements. Working backward from cost estimates, if 900Email could support 50,000 Clients (and the Customers who email them) for every six servers, that could lead to profitable operations. Our revenue projection spreadsheets forecast that for every 50,000 Clients, our company revenue shall be about $2 million. And our early first-year cost estimates forecast an annual expense of about $ 100,000 to install and maintain six production servers, not counting administrative and maintenance overhead. So if six production servers can support 50,000 Customers, that would keep our baseline system operating costs to about five percent of our gross revenue.

1.1.3. Performance Priorities: To the extent that design and development resources are allocated to obtain optimal efficiency in one area or another, to that extent, those resources should be apportioned based on the priority scale below.

Technical Note—Efficiency Priorities: Not all processes have the same need for high-performance. The following chart, based on marketing and operational considerations, lists functions in order of priority from greatest to least efficiency required:

| | |
|---|---|
| High | Web Servers (page display times and |
| | refresh rates) |
| | Purchasing EPostage |
| | Creating an Email/EPostage Account |
| | Receiving Email |
| | EPostage Debiting & Crediting |
| | Sending Email |
| Low | User Support Functions |
| | Operational Management Functions |
| | Month-End Processing of Accounting |
| | Data |
| | Closing an Email/EPostage Account |

Business Note—Efficiency Rationale: A low-priority efficiency function like month-end processing only occurs 12 times per year, as compared to a high-priority efficiency function like purchasing EPostage, which might happen 10⁶ times per year, or receiving email, which might happen 10⁷ times per year. The number of times an event may occur helps to define its efficiency priority, but the marketing factor, of system responsiveness to Clients and Customers, takes precedence even over the operational considerations. Thus, the greatest efficiency concern lies in point-of-contact sales functions with the marketplace. Of course, we welcome high efficiency in all system functions, and good performance should result from quality design and implementation. However, as stated in requirement 1.1.3, to the extent that resources are allocated to obtain optimal efficiency in one area or another, to that extent, those resources should be apportioned based on the priority scale above.

Business Note—Performance Objectives: Our desire to achieve high performance has three objectives. In order of priority, these performance objectives are:
to give Clients and Customers a speedy response in point-of-sale transactions;
to enable 900Email to service a large number of Clients and Customers with a minimal amount of hardware and software;
to enable 900Email employees to administer, operate, maintain, and manage the system efficiently.
   1.2. Availability

900Email shall support these Availability requirements:

1.2.1. Four Nines: 900Email operational hardware and software initially shall be designed toward achieving an availability of 99.99% uptime performance.

Business Note—Diminishing Returns: The requirement of planned for availability of 99.99% uptime allows for 53 minutes of downtime per year. 900Email management requires that the system be up and running reliably to build marketplace credibility, to protect our revenue stream, and for the convenience of our Clients and Customers. However, we are not initially planning for an availability goal of another nine (99.999%), because of the tremendous added expense in achieving each additional nine. The tradeoff between cost and benefit does not merit expending those greater resources at startup. But when our forecasted revenues begin to materialize, 900Email management requires the ability to increase availability.

| Availability | Annual Downtime | |
|---|---|---|
| 99.9 | 8.8 | hours |
| 99.99 | 53 | minutes |
| 99.999 | 5.3 | minutes |
| 99.9999 | 32 | seconds |
| 99.99999 | 3 | seconds |

To save more money, we could reduce the requirement from four to three nines, but that allows for almost nine hours of downtime, an unacceptably long period of unavailability. Increasing the availability goal to five nines (99.999%) allows for just 5.3 minutes of downtime annually; and six nines allows for 32 seconds. So, even though we have not taken the time to quantify the additional costs, based on years of experience, we judge the goal of initially achieving greater availability than 99.99% as not cost-effective for the start-up system design.

Further, Internet Service Providers (ISPs) typically guarantee only three nines of 99.9% availability, which is unacceptable service. This concern must be researched and addressed.

1.2.2. Future Uptime Goal: In a post-release version, 900Email shall seek to increase our availability goal to five nines (99.999%).

1.2.3. Scheduled Downtime: 900Email shall support these scheduled downtime requirements:

1.2.3.1. Inclusive: Scheduled downtime appears the same to our users as unscheduled downtime and so shall be included in all planning, calculations, and reports on actual availability.

1.2.3.2. 4:00 a.m.: 900Email administrators shall schedule maintenance upgrades for between 4:00 a.m. and 4:30 a.m. Eastern Time.

1.3. Reliability

900Email shall support these Reliability requirements regarding the physical dependability of the system:

1.3.1. Hardware Redundancy: 900Email shall be fault-tolerant, able to withstand severe hardware failure and continue operation.

1.3.1.1. Hard Disk Crash: 900Email shall continue to operate without loss of service or loss of data, even if any hard disk in the system crashes.

1.3.1.2. Server Crash: 900Email shall continue to operate without loss of service or loss of data, even if an entire server in the system crashes.

1.3.2. Internet Connectivity Redundancy: 900Email (or our hosting company) shall have redundant connectivity via different communication providers (e.g., AT&T, Sprint) to the Internet backbone available to our operation.

1.3.3. System Backup: 900Email shall regularly Backup (7.4, p. 128) the entire 900Email system, including the system software, Email webstore and all its contents, Customer and Client account information, transactions, etc.

1.3.4. Physical Plant: The 900Email system resides in a limited-access, secured facility with state-of-the-art protection against power outages, fire, and theft.

Note—For more Reliability requirements, see Operations (section 7, p. 123) including Alarms (7.3, p. 125), Backup (7.4, p. 128), and System Reporting (7.5, p. 129).

1.4. Scalability

900Email software shall support these Scalability requirements:

1.4.1. Initial Capacity: 900Email shall go online with enough system capacity to support 50,000 Clients.

1.4.2. Growth Capacity: 900Email shall be sufficiently scalable to add, if necessary, as many as 250,000 Clients in a single month.

Technical Note—Implementation: Development shall decide between using a hardware or software approach, whether to implement Microsoft's clustering technology, or to do load balancing in hardware, the latter of which may be more efficient.

1.4.3. Server Independence: Though the system hardware and software components may be duplicated over and over again to support a growing Client base, yet additional clustered hardware and software instances shall run as a seamless extension of the existing system, so that end users shall have no knowledge or concern about which set of servers their account is running on.

1.5. Security

900Email shall support Security requirements in three areas of threats, from hackers, from users, and from disloyal employees:

1.5.1. Hacker Controls: 900Email shall support these Hacker security controls:

1.5.1.1. Highly Secure Network: 900Email shall comply with industry standards for a Highly Secure Network.

1.5.1.2. Secure Sockets Layer: 900Email uses the Secure Sockets Layer (SSL) protocol whenever it needs to encrypt confidential information in transit from a Customer or a Client's computer to our system.

1.5.1.3. Automatic Encryption: Where possible, such as when Clients present passwords for login, 900Email shall perform encryption automatically, without user request or intervention.

1.5.1.4. Encryption Key Length: 900Email uses an encryption key length of 128-bits (the highest level commercially available).

1.5.1.5. Double Firewall Protection: Once account information reaches 900Email, it resides on servers that are heavily guarded electronically, sitting behind two tiers of firewalls so that no data is directly connected to the Internet, and a hacker would need to break and enter through two different security devices.

Technical Note—Firewall Manufacturers: If we use firewalls from only one manufacturer, a security hole in a device on our first tier of protection might exist identically on another device by the same manufacturer on our second tier of firewalls. So, if a hacker discovers a security hole in the first firewall he encounters, he might be able to get through the second, sneaking through the same overlooked pathway. Installing firewalls from different manufacturers would reduce the likelihood that the same hack will defeat security in both tiers. However, this increases complexity and administrative overhead. So our network architect should weight the cost versus benefit and make a recommendation.

1.5.1.6. Physical Security: Once account information reaches 900Email, it resides on a server that is heavily guarded physically in a limited-access, secured facility.

1.5.1.7. Fully Encrypted Email: In a future version, perhaps 900Email 4.n, Clients shall be able to send and receive fully encrypted Email messages via state-of-the-art 128-bit encryption.

Business Note—Increasing Vulnerability: Email typically travels the web in unencrypted, standard ASCII text format. Encryption typically applies only to the login password, and to separately encrypted attachments. However, security concerns have increased steadily, and our future Clients may demand the ability to send and receive fully encrypted Email messages.

1.5.2. User Controls: 900Email shall support these User security controls:

1.5.2.1. Approved Browsers: 900Email shall require Customers and Clients of our secured services to use an approved browser, one that uses SSL 3.0 or higher.

1.5.2.2. Required Passwords: 900Email shall require password-protected access for our Clients and Customers to their Email and EPostage accounts.

1.5.2.3. Change Passwords: 900Email shall not require a user to change his password on a regular basis, but shall list on his My Account webpage a recommendation occasionally to change his password to keep his account secure (4.4.1.2, p. 117).

1.5.2.4. Password Length: 900Email shall require a password of at least six characters up to a maximum of fifteen.

1.5.2.5. Password Makeup: 900Email shall require a password to consist of both letters and numbers.

1.5.2.6. Password Attempts Monitor: 900Email shall limit the number of attempts that a user can make to log in when he enters an incorrect password to five attempts.

1.5.2.7. Masked Passwords: 900Email software shall mask the passwords of our Clients and Customers as they type it in to log on to their Email and EPostage accounts (4.3.1.1, p. 115 and 4.4.1.1, p. 117).

1.5.2.8. Encrypted Passwords: 900Email shall be able to send and receive fully encrypted Email messages via state-of-the-art 128-bit encryption.

1.5.2.9. Forgotten Passwords: Upon authentication of a Customer or Client who claims to have forgotten his password, 900Email shall reset that password to a random, system-generated password (6.2, 121).

1.5.2.10. Access Control: Private information is available only to authorized Clients and Customers validated via their account name and password.

1.5.2.11. Prepaid EPostage Control: The Prepaid EPostage service shall be reasonably secure, making it difficult for an unauthorized message to get an unpaid Email message through to a Client via this service.

Technical Note—Trying to Spam Rush: 900Email shall enable Clients to prepay EPostage to allow certain senders to transmit Email messages free of charge (2.6, p. 55). A malicious user may attempt to deceive a client by unauthorized use of his Prepaid EPostage, and send him an Email message without paying his EPostage Rate. 900Email shall be designed with sufficient security to discourage this type of behavior.

1.5.3. Employee Controls: 900Email shall support these Employee security controls:

1.5.3.1. Business Rules Security: Only the highest level of authorization enables 900Email officials to effect a change in a Business Rule (7.6.1.8, p. 134), which change can affect then entire operation of our system, and all Customers and Clients.

1.5.3.2. Employee Access Control: Only authorized 900Email employees and agents shall have access to the hardware and software of the system and to system information. (For details of required access, see Operations, Administration, 7.2, p. 123.)

Technical Note—Authorized Access: 900Email employees and agents shall only have access to Customer EPostage accounts for valid business purposes like audits, performing necessary accounting functions, to make Client payouts, to issue Customer refunds, to fulfill IRS reporting requirements, and to close accounts.

1.5.3.3. Employee Validation: Employees obtain validation to access system information through the combined use of a password and an additional access technology (such as a security software credit-card key that displays an access code that changes minute-by-minute).

1.5.3.4. Employee Access Limits: 900Email employees shall not have access to any Client or Customer password.

1.5.3.5. Requesting a Password: 900Email shall never ask a Customer nor a Client to divulge his password except when entering it to send encrypted to logon to his own account. (This requirement applies to both employees and software.)

1.5.3.6. Front Door Access: Since no 900Email employee should have knowledge of any Customer or Client password, no 900Email employee shall be able to access an EPostage account through any Customer access software or web page.

Business Note—

Client Accounts: Without access to a Client password, no 900Email employee, from the CEO, to a system engineer, to a receptionist, shall have the ability to read a Client's mail, nor even access his inbox, sent mail, or deleted mail. Authorized 900Email employees and agents shall have, however, the ability to backup, restore, and delete entire Email accounts (see Operations, section 7, p. 123), yet without the ability to “look inside” of any such account.

Customer Accounts: Without access to a Customer password, no 900Email employee shall be able to access an EPostage account through any Customer access software or web page.

Authorized 900Email employees and agents shall only have access to Customer EPostage accounts for valid business purposes like audits, performing necessary accounting functions, to make Client payouts, to issue Customer refunds, to fulfill IRS reporting requirements, and to close accounts. (See Operations, Accounting Needs, 7.7, p. 134.)

Security Pledge: The 900Email system facilitates communication of potentially highly sensitive and private information between third parties. Also, 900Email transactions will combine sensitive Email messages with personal financial information. Therefore, 900Email pledges to design into our system a great degree of confidentiality, requiring careful security policies enforced electronically and physically, in software and through workplace facilities and employee policies. For our policies regarding governmental compliance, see our corporate Policy Publications regarding Legislation, Regulations, and Treaties Policy and Law Enforcement Investigations Policy.

1.6. Usability

900Email shall support these Usability requirements:

1.6.1. Website Interface: http://900Email.com web pages shall be designed to operate consistent with Windows Interface Guidelines (as expanded for web pages).

1.6.2. Desktop Client Interface: The 900Email.exe desktop email client program, if we decide to produce such software, shall be designed to operate consistent with standard Windows functionality including drop-down menus, dialogue boxes, etc. (For details, see 5.1, p. 119).

1.6.3. Date and Time References: Whenever a Client or Customer sees a date or time stamp, those indicators will be in reference to his local time zone (if possible), and they will not include seconds.

1.6.4. Management Tools Interface: 900Email requires a standard windows interface to operate its Management Tools to implementing various policy decisions (e.g., Business Rules for setting the Service Fee and the Minimum Postage Rate). (For details, see Operations, Management Needs, p. 7.6, p. 132).

1.6.5. Operational Tools Interface: 900Email shall design Operational tools with a standard windows interface. (For details, specific tools, and reporting requirements, see Operations, p. 123).

1.6.6. Foreign Language Support: 900Email system architecture shall be designed with multi-language support in mind, but our first version shall support only English.

Business Note: Planned Languages: After the initial release in American English, the first additional languages to be supported shall be the English dialect spoken in the United Kingdom, followed by German, French, and Japanese, and those followed by Spanish, Italian, and Romanian (Romanian only because we already have an eager translator identified). Our business goal of being first to market has influenced our decision not to support multiple languages in our first release. However, designing the architecture to support multiple languages is important so that adding that functionality later will not be unnecessarily expensive. Thus, our architect must familiarize himself with Internationalization design and coding practices. We've selected German as the first foreign language to support because of the revenue opportunity from Germany's strong e-commerce economy but also because their language is verbose and so requires longer text strings to communicate the same concepts. These longer strings will help our testing personnel confirm the integrity of our multi-language support. Also, American English will be used exclusively for all internal management and administrative user interfaces, system reports, alarms, etc.

1.6.7. Foreign Currency Support: 900Email shall support these foreign currency requirements:

1.6.7.1. Architecture: 900Email system architecture shall be designed eventually to support multiple currencies.

1.6.7.2. Initial Currency: 900Email's first version released to the public shall support only the U.S. Dollar.

Business Note: Planned Currencies: After the initial release, the first foreign currency to be supported shall be the Euro.

Technical Note—Guidelines: Support for foreign currencies in this application is non-trivial and the subject is dealt with throughout this document where relevant.

1.6.7.3. Rates & Fees by Currency: 900Email shall support complete pricing independence between currencies for all its Fees and EPostage Rates (7.6.1.2, p. 133).

Business Note—Currency Separation: For Customer and Client accounts paying with U.S. Dollars, we are currently paying a 91% Client Portion. 900Email management may decide to pay a higher or lower rate for users paying, for example, with Japanese Yen.

1.6.8. Default Nationality: 900Email web pages shall show by default their English language version (U.S. English) and display money in U.S. currency (4.1.4, p. 112).

1.6.9. Facilitate Policy Changes: 900Email management requires the ability to implement marketing and business policy changes as identified herein without need to modify or recompile the software.

Technical Note—Business Rules: This document highlights system variables, called Business Rules. Management requires the ability to alter, without any programming intervention, the numerical and text string values of these Business Rule variables. This enhances the usability of the system from the perspective of 900Email management and staff. Here is the first Business Rule:
1.6.10. Business Rule—Service Fee: Management shall be able to change the standard Service Fee to meet 900Email marketing and business requirements. Initial value: 9%.
Definition—Service Fee: The percentage of EPostage collected on each retrieved Email message that 900Email charges.

1.6.11. Logically Robust: 900Email shall be logically robust, making the system more useable.

Technical Note—Robust Functionality: The 900Email design shall strive to overcome hurdles that might tend to interfere with a Client's intended use of the system. 900Email seeks to function with the “intuition” of an artificially intelligent system. Therefore, Marketing makes this request of all developers: Please notify Marketing directly of any opportunity you may discover for improving the logical robustness of the system.

1.7. Maintainability

900Email shall support these Maintainability requirements:

1.7.1. Isolate Sub-Systems: Isolate 900Email's major subsystems.

Examples—Isolated Systems:
Email system engine (3rd-party)
EPostage database engine (on MS SQL Server 2000 Enterprise Edition or other database engine)
Transaction processing system
Client/Customer Payouts/Reporting/Taxes (on MS SQL Server 2000 Enterprise Edition or other database engine)
Web servers for 900Email.com (on MS Windows 2000 Advanced Server)
Administrative tools
System reporting (on MS SQL Server 2000 Enterprise Edition)
Desktop email client software (MS Outlook, 900Email.exe, etc.)
Corporate accounting system
Office automation system (MS Office 2002)

Technical Note: Advanced Server: If we do load balancing in hardware rather than software, we may need only MS Windows 2000 Server software, rather than Advanced Server. This will save money, but unless that decision is made, we will budget for Advanced Server.

1.7.2. Upgrades by Sub-Systems: 900Email can upgrade any individual sub-system to fix bugs, enhance performance, etc., without necessarily requiring an upgrade to other systems.

Business Note: Isolation: Isolating subsystems simplifies maintenance and upgrades of software to any of these subsystems, thus also improving reliability. Of course, this development process does not include creation of any office automation software, like a spreadsheet or word processor, nor of corporate accounting software. However, such software shall be used in the management of the 900Email system, for example, to analyze system performance via reports, charts and graphs, and to incorporate summary EPostage revenues into overall corporate profit and loss reports, etc. Therefore, these pieces of the overall picture are occasionally referenced herein.

Business Note—Microsoft Platforms: 900Email has made a strategic technical decision to use Microsoft Windows™ technology rather than go the Java-Sun-Unix route, although both can be used. This yields the constraints apparent in the list of Isolated Systems above, in the use of Microsoft operating system and server product platforms. We expect that the Microsoft approach shall give us better performance per dollar of resources allocated including quicker development time and price/performance hardware and software ratios, and that upgrades to MS platform software shall continue to outpace other competitive platforms and shall therefore maximize our ability to economically service our Clients and Customers.

1.7.3. Version Query: Each 900Email software module shall respond to a version query, informing an operator of which version is running on a given server at a given time.

1.7.4. Y2K-Type Concerns: 900Email shall support these Y2K-Type requirements:

1.7.4.1. Dates: 900Email shall not be designed with date restrictions through the year 2,200 A.D.

Business Note—Zeroes: Variables that represent 900Email fees shall support very large numbers in hopes of protecting 900Email from experiencing Y2K-type difficulties. Modern history tells of nations that have experienced hyperinflation, in which they pass through phases in which a zero per year could be added to prices. There is no way to predict the inflationary future over the next thirty years, and so 900Email software, throughout the system components, the 900Email.com Website, and the 900Email.exe desktop program, shall support upper limits for cash variables that seem ridiculously high today. Also, industry advances in the falling cost of disk storage, RAM, and processing speed and power lessens the concern over supporting larger numbers. Therefore, 900Email shall use variables and data structures that support fees into the millions, numbers of users into the billions, and revenue calculations into the trillions. So 900Email shall support extraordinarily large numbers for system variables, which could theoretically grow beyond expected magnitudes.

1.7.4.2. Fee Zeroes: 900Email shall be able to charges fees into the millions (e.g., see the EPostage Fee Maximum, 3.4.6, p. 96).

1.7.4.3. Account Zeroes: 900Email shall be able to count users into the billions (e.g., see the Clients Report, 7.5.3, p. 130).

1.7.4.4. Revenue Zeroes: 900Email shall be able to tally revenue numbers into the trillions (e.g., see the Revenue Report, 7.5.5, p. 132).

1.8. Multi-Domain Support

900Email shall support these Multi-Domain requirements:

1.8.1. Domain Independence: 900Email is not domain specific.

Example—Not Domain Specific: 900Email shall host email service for multiple domain names, for example, for Howard@900Email.com and for HowardSmith@coffeecompany.com.

Business Note—Mail System Hosting: Thus, 900Email can host other firms Email accounts as subsets of its Client base. We call this service Mail System Hosting. With this feature, 900Email has the option of running our own competing email systems under different domain names, 900Email.com, EMail.com, FirstClassEmail.com, Recluse.com, CelebrityEmail.com, etc. And we can operate email systems for other firms, such as AllEmailAccounts@Bigcompany.com.

1.8.2. Adding and Deleting Domains: 900Email shall enable an administrator to add or delete multiple domains per day without disruption to service for Clients of other domains supported by the same servers.

Scenario—Adding a Domain: The marketing department has just signed up Big Company as a Mail System Hosting Corporate Client. So an administrator must add a new email domain to the system, bigcompany.com. He shall be able to do so easily, without scheduling downtime or disrupting service to existing Clients. He was already managing the system for Email IDs at our own 900Email.com, and a few dozen other domains, with a combined 26,000 active accounts. Big Company has 18,000 email users, and so the new number of active accounts is 44,000. As long as there is capacity to handle the additional accounts on the current hardware platform, he shall not need to add any new servers to support the additional email domain. If there were insufficient capacity, however, then he will need to add servers (and install the software they require, such as MS Exchange or MS SQL Server). (See Operation Requirements, Administration, Adding a Domain, 7.2.6, p. 124.)

Technical Note—Virtual SMTP: Windows 2000 Advance Server supports Virtual SMTP. If we decide to use an Email engine that does not disable the Windows SMTP service, then, with that feature, incoming Email messages addressed to one Domain, like BigStar@900Email.com, would be handled by one instance of SMTP, and messages addressed to another Domain, like Bigname@TVstation.com; would be handled by another instance of SMTP running independently of the first instance. Thus, Virtual SMTP theoretically can support two or more Domains on a single server, with each instance of the SMTP service handling a different Domain.

At this early time (as these requirements are being written), we have little information on the performance implications of various requirements and of our system architecture in general. This is true also of this Virtual SMTP service. How efficient is its implementation? Is there overall performance degradation as each virtual instance is installed? What is the practical maximum number of instances that a single server could support without serious performance degradation? If marketing signs up a thousand Mail System Hosting accounts we will need to support hundreds of tiny Hosted Accounts with perhaps between 10 and 50 Clients each. So, can a single server hosting such small accounts be configured to support a dozen Domains, scores of Domains, or hundreds of different Domains, each serviced by a discrete instance of Virtual SMTP?

1.9. Licensing

900Email shall support licensing of our system by being able to clone the 900Email software, which will enable corporations to run our system in their own facilities, on their own computers.

Business Note—Clone Revenue: This licensing feature allows 900Email to benefit financially even from firms that will not outsource their email system for security or other reasons. Thus, a firm can license the 900Email system software, install and run it, and host its own internal email system to support, for example, Agencyhead@Agency.gov. And our EPostage requirement adds an additional layer of security (and track-ability) to Email messages, since senders must pay for mail delivery, and therefore, law enforcement would have another way of tracking a sender, by investigating the sender's checking account (credit card account, etc., 3.3, p. 94). Also, 900Email shall have authenticated the FROM email ID (3.9.5, p. 01) because we need to verify that the sender is not an imposter, and the Email ID a forgery, since we shall be debiting the Customer's EPostage account based upon that FROM Email ID.

1.9.1. Delivery Medium: We shall provide our licensed software to the licensee on a 900Email Installation CD ROM or make it available for downloading from our website.

1.9.2. Functional Equilvalency: Except as specified below, a corporate license for our 900Email system gives the corporate licensee the equivalent system functionality as is available through our own instance and use of 900Email.

Business Note—Fee Flexibility: We may want to charge a licensee a set annual fee, or, we may negotiate a Custom Service Fee and thereby charge the licensee a lower percentage of his EPostage volume, perhaps 3% instead of the 9% that we charge our own retail Clients.

1.9.3. Custom Service Fee: See the entire 2.3.7 section, p. 49.

1.9.4. Domain Limitation: 900Email restricts cloned systems, licensed to Corporate Clients, to support for a single domain, unless that Corporate Client pays a premium to license support for multiple domains.

1.9.5. Single Server Support: 900Email enables a Corporation Client that licenses our software to run all system components on a single PC server (whether on a single, dual-, or quad-processor box).

Business Note—Self-Determination: A Corporate Client licensing our system shall determine for itself how many servers shall be required to service adequately its own email universe. 900Email, expecting a huge Client base, has therefore isolated the major system components in part to run these components on separate servers. A corporate account that licenses 900Email may have a much smaller number of email Clients to support, and may therefore desire to run all separate system components on a single PC.

1.9.6. Multiple System Instances: 900Email shall be able to install completely separate instances of our own system software and operate them independently, acting much like one of our own Corporate Clients.

Business Note—Dedicated System Hosting: A Corporate Client who contracts up for our Mail System Hosting might request dedicated, non-shared service from 900Email to keep their corporate account separate from all other 900Email accounts. In this case, we would install a completely new instance of all our system software, without any overlap whatsoever. This separate instance of the system would operate identically to such a system installed independently by one of our Corporate Clients who has licensed our software from us.

1.10. Interconnectivity

900Email shall support the Interconnectivity requirements below for High-Speed Web Access, Web Browsers, Email Protocols, and Client Email Access:

1.10.1. High-Speed Web Access: 900Email Internet servers shall have very high-speed, state-of-the-art, access to the Internet backbone. (See General Requirements, Performance, p. 28.)

1.10.2. Web Browsers: Web surfers who use the popular browsers below must be able to view and use the 900Email.com web pages:

1.10.2.1. Internet Explorer: Users of Microsoft's Internet Explorer version 5.5 (released in July 2000) and higher can view and use all 900Email web pages. [Constraint]

1.10.2.2. Netscape: Users of Sun's Netscape version 4.7 (released in September 1999) and higher can view and use all 900Email web pages. [Constraint]

1.10.2.3. Mozilla: Users of Mozilla version 1.0 (released in June 2002) and higher can view and use all 900Email web pages. [Constraint]

Technical Note—Other Browsers: Users of other browsers that adhere to the conventions established by these industry standard programs shall be able to view and use 900Email.com. However, 900Email shall only support the browsers listed above, and non-conforming browsers shall not work, nor shall we expend resources or provide support for them. Regarding IE and Netscape, we have considered supporting older browser versions, but three factors suggest the above standards. First, the initial public release of 900Email is not expected until well into 2004, and that brings the amount of time which has passed since the introduction of Netscape 4.7 to a few years, more than enough time for users to migrate to that version or higher. (At the time of this writing, Netscape.com offers version 6.2.3 and pre-release 7.0. Microsoft.com offers 6.0.26. Mozilla offers a 1.1 Beta version.) Second, 128-bit encryption is not supported by earlier versions, and so 900Email could consistently use that level of encryption whenever we do use encryption. Third, supporting older browser versions add significantly to testing time, restrain the use of new features, and slows website development generally. Our goal of being first to market with a sender-pays email system argues in favor of supporting only the more recent browsers. Mozilla.org offers an open-source, portable web browser that is gaining in popularity.

1.10.3. Email Protocols: Worldwide Internet users shall be able to send and receive mail to and from 900Email Clients.

1.10.3.1. Sending Email: 900Email shall support this Email transmission protocol: [Constraint]

1.10.3.1.1. Clients Send via SMTP: Any 900Email Client can send Email messages to any other Internet Email account, whether at 900Email.com or otherwise, via SMTP (Simple Mail Transfer Protocol). [Constraint]

1.10.3.1.2. 3rd-Parties Send via SMTP: Any user on the Internet can send messages to 900Email Clients by using the standard email protocol SMTP. [Constraint]

1.10.3.2. Receiving Email: 900Email shall support these two Email access protocols, to be implemented and tested in the following prioritized order: [Constraint]

1.10.3.2.1. Receive via POP3: Messages successfully sent to 900Email Clients from an Internet Email account using SMTP can be received by our Clients using the industry standard email protocol POP3 (Post Office Protocol version 3). [Constraint]

1.10.3.2.2. Receive via IMAP4: Messages successfully sent to 900Email Clients from an Internet Email account using SMTP can be received by our Clients using the industry standard email protocol IMAP4 (Internet Mail Access Protocol, version 4). [Constraint]

1.10.3.2.3. Receive via X 400: Messages successfully sent to 900Email Clients from an Internet Email account using SMTP can be received by our Clients using the Open Systems Interconnect (OSI) standard email protocol X.400. [Constraint]

Business Note—Receive Protocols: The marketplace is primarily divided between use of POP3 and IMAP4. To avoid excluding millions of potential Clients, our initial release will have to support POP3 and IMAP4. X.400 could be added later.

1.10.3.3. Email Message Structure: The structure of each Email message shall follow the de facto RFC822 industry standard for electronic message formatting as defined by the Advanced Research Projects Agency (ARPA) of U.S. Department of Defense. [Constraint]

Technical Note—ARPANET Documentation: Find the Request for Comment RFC822 ARPANET standards document (about 40 pages) on the web at FAQs.org or as reprinted in the 900Email corporate library database with filename 9E ARPANET Email Standard.doc. The ARPANET standard defines the number, types, lengths, and purpose of fields. Thus, 900Email shall support these Email Message Structure requirements:

1.10.3.3.1. Header Fields: 900Email uses the industry standard format for email header information.
1.10.3.3.1.1. From: 900Email conforms to the standard email header “From” field.
1.10.3.3.1.2. To: 900Email conforms to the standard email header “To” field.
1.10.3.3.1.3. Date: 900Email conforms to the standard email header “Date” field.
1.10.3.3.1.4. Time: 900Email conforms to the standard email header “Time” field.
1.10.3.3.1.5. CC: 900Email conforms to the standard email header “CC” (carbon copy) field.
1.10.3.3.1.6. BCC: 900Email conforms to the standard email convention of “BCC” (blind carbon copy).
1.10.3.3.1.7. Subject: 900Email conforms to the standard email header “Subject” field.

1.10.3.3.2. Body: 900Email uses the industry standard format for the “Body” field.

1.10.3.3.3. Attachments: 900Email uses the industry standard format for the “Attachment” field(s).

1.10.3.4. Contents: As with all standard emails, in the body of the message and in attachments, 900Email messages can contain text, graphics, animation, audio, and video:
1.10.3.4.1.1. .gif,
1.10.3.4.1.2. .jpg;
1.10.3.4.1.3. .mp3;
1.10.3.4.1.4. .rm;
1.10.3.4.1.5. Etc.

Technical Note—No New Fields: 900Email defines no new message fields. 900Email implements its unique requirements, like Pre-Paid EStamps (2.7, p. 58) and Maximum Rates (3.9.3, p. 100) within the confines of the standard message fields.

1.10.3.5. Email IDs: 900Email shall support the industry standard naming convention for Email IDs, which defines an Email ID as a unique alphanumeric string of up to @n characters in length, beginning with an alphabetic character, and optionally including underscores and hyphens. [Constraint]
Definition—Email ID: The web-wide unique alphanumeric name, which distinguishes a single user's Email account. Arnold@900Email.com is an example Email ID.

1.10.3.5.1. Case Independence: 900Email shall not distinguish between upper and lowercase alphabetic characters when resolving Email IDs or Domain names.
Definition—Domain ID: (also, Domain) That part of an Email ID that lies to the right of the @ sign. Vatican.org is an example of a Domain ID from PopeJohnPaulII@Vatican.org.

1.10.4. Client Email Access: 900Email shall support two methods of access to Client Email accounts:

1.10.4.1. 900Email shall enable Clients to access their Email accounts via a web page at 900Email.com (possibly MS Outlook Web Access, 4.3.2.1, p. 115); and,

1.10.4.2. 900Email shall enable Clients to access their Email accounts via 3rd-party email client software like MS Outlook (for details, see Desktop, 3rd-Party, p. 119).

Business Note: Our Own Desktop Software: Perhaps eventually, in a later version, we will also enable Clients to access their Email accounts via a third method. We may decide to implement 900Email.exe desktop software (5.1, p. 119):

2. Client Features

900Email shall support these Client requirements:

2.1. Becoming a Client

900Email shall recognize a person as a Client when he successfully signs up for a 900Email Email account.

Technical Note—EPostage Account: The sign-up process will also result in the creation of an EPostage Account for the new Client. Remember, every Client is a Customer also (p. 25). If the new Client already had an EPostage Account (having already been signed up as a Customer), then 900Email would now simply link that Customer Account with this new Client Account. Also, the Client's choice of Account Culture (language and currency, 3.1.1, p. 92) is defined by his role as a Customer, since the currency he would typically use to pay for EPostage and Fees determines the currency setting of his account.

2.2. EPostage Rates

2.2.1. EPostage Minimum Rate: 900Email can establish an EPostage Minimum Rate.
2.2.2. Business Rule—EPostage Minimum Rate:

Management shall be able to change the EPostage minimum rate required for sending an email to a Client. Initial value: $0.05.

2.2.3. EPostage Maximum Rate: The technical, implemented maximum rate shall be at least $1,000,000,000,000 (1.7.4.2, p. 38). There is no business need for a maximum postage rate.

2.2.4. Client EPostage Rate: At sign-up, a Client selects an EPostage rate for his incoming messages at or above the minimum permitted rate (Client Sign-Up, 4.2.2, p. 113).

Technical Note—Public Rate: 900Email shall allow Clients to charge different rates to different senders (2.5.1, p. 50). So this Client EPostage Rate becomes his initial Public Rate, which he shall be able to change at any time.

2.2.5. Rate Change: A Client can change the postage rate he charges for his incoming messages at anytime during the lifetime of his account.

2.2.6. Effective Immediately: A Client's EPostage Rate goes into effect the moment he establishes it.

Technical Note—Real Time Updates: 900Email collects a Customer's EPostage just before his Email message is delivered into the Client's inbox. If the Client had changed his EPostage Rate just one second earlier, 900Email would have picked up that new Rate such that a Rate change is reflected throughout the 900Email system virtually instantly, in real time.

2.2.7. First-Class U.S. Stamp: A Client can set up his EPostage Rate to equal the price of a first-class U.S. stamp.

Scenario—The Price of a Stamp: A Client sets up his EPostage rate to match the price of a first-class U.S. stamp. As of the time of this writing, Customers would then be required to pay $0.37 to send him an Email message. Only with the approval of the United States Congress, the U.S. Postmaster can change the price of a first-class stamp. Whenever that occurs, within 24 hours, 900Email management shall match that change with a commensurate EPostage rate change for those Clients who have selected the price of a U.S. Stamp as their own EPostage rate. So when the United States Post Office raises the price of a first-class stamp to 0.40¢, then 900Email shall raise the EPostage rate for the Client in this scenario, and for all Clients, who charge the equivalent of a U.S. stamp for incoming email. This process repeats whenever the U.S.P.O. changes the price of a stamp.

Business Note—Tying EPostage to Postage: The U.S. Stamp Price feature benefits 900Email in three ways:
Reinforcing the parallels with paper and telephone communications helps to justify and promote the 900Email philosophy to the marketplace.
This feature may encourage a significant percentage of Clients to charge a higher rate for incoming email than they otherwise would have charged.
Whenever the U.S. government increases the price of a first-class stamp, a percentage of our Clients shall automatically have a rate hike for their incoming messages. This EPostage rate increase shall likely increase 900Email revenue.
2.2.8. Business Rule—US. Stamp Rate: Management shall be able to change this special EPostage rate to match the price of a first-class U.S. stamp. Initial value: $0.37.
   2.3. Client Portion

900Email shall support these Client Portion requirements:

2.3.1. Client Portion Standard Percent: 900Email currently charges a 9% Standard Service Fee (1.6.10, p. 36), meaning that the Client Portion Standard Percent is 91%.

2.3.2. Client Portion Amount: 900Email shall support these Client Portion Amount requirements:

2.3.2.1. Calculation: The standard Client Portion Amount is the Client's EPostage Rate minus the standard 900Email Service Fee.

Examples—Client Gets Lion's Share: If a particular Client charges $1.00 EPostage and 900Email charges a 9% Service Fee, then his Client Portion for reading a single Email message is 0.91¢ (and 900Email collects 0.09¢). If another Client charges $20 EPostage, then his Client Portion for reading a single Email message is $18.20 (and 900Email collects $1.80).

2.3.2.2. Minimum Service Fee: 900Email shall be able to charge a Minimum Service Fee per retrieved Email message.
2.3.2.3. Business Rule—Service Fee Minimum per Transaction: Management shall be able to set a Minimum Service Fee per retrieved Email message. Initial value: $0.01.

Business Note—Zero Income: Without a minimum fee, 900Email might have millions of transactions that produce no revenue. For example, a 9% Service Fee on delivery of a $0.05 Email message yields a $0.0045 fee, which being less than half-a-cent, rounds down to zero. With a one-cent minimum, the Client would receive four cents and 900Email would take one cent (which amounts to a twenty percent fee in such cases). If management decides to keep our fee as advertised (even for our lowest priced Clients), we could calculate our Service Fee by tracking the rounding amount per Client, allowing a Client to keep all five cents on the second such message, and then lose a penny on the third, and so on as the fractional cents dictate. Such tracking would be zeroed out at Client Payout 2.15, p. 82).
2.3.2.4. Business Rule—Service Fee Fractional Cents Tracking: Management shall be able to turn on or off Service Fee Tracking which keeps a running tally of fractional cents owed to individual Clients due to rounding errors. Initial value: Off

2.3.3. Regressive Service Fee: 900Email shall support the following Regressive Service Fee schedule:

2.3.3.1. Service Fee Level 2: When a Client generates above $1,000 in EPostage revenue at any point within a year's time, our Service Fee drops as of that month to 8%.

2.3.3.2. Service Fee Level 3: When a Client generates above $5,000 in EPostage revenue at any point within a year's time, our Service Fee drops as of that month to 7%.

2.3.3.3. Service Fee Level 4: When a Client generates above $15,000 in EPostage revenue at any point within a year's time, our Service Fee drops as of that month to 6%.

2.3.3.4. Service Fee Level 5: When a Client generates above $50,000 in EPostage revenue at any point within a year's time, our Service Fee drops as of that month to 5%.

2.3.3.5. Service Fee Level 6: When a Client generates above $250,000 in EPostage revenue at any point within a year's time, our Service Fee drops as of that month to 4%.

2.3.3.6. Service Fee Level 7: When a Client generates above $1,000,000 in EPostage revenue at any point within a year's time, our Service Fee drops as of that month to 3%.

2.3.3.7. Service Fee Level 8: When a Client generates above $3,000,000 in EPostage revenue at any point within a year's time, our Service Fee drops as of that month to 2%.

2.3.3.8. Service Fee Level 9: When a Client generates above $10,000,000 in EPostage revenue at any point within a year's time, our Service Fee drops as of that month to 1%.

2.3.3.9. Service Fee Level 9: For the purposes of calculating this Regressive Service Fee, 900Email shall use a rolling twelve-month period.

Business Note—Rolling Period: When processing our Client Payouts each month, we shall calculate the Regressive Service Fee using a rolling twelve-month period by taking into account all EPostage revenue generated by that Client in the previous year.
2.3.4. Business Rule—Service Fee Levels: Management shall be able to change the number of levels at which different service fees kick in. Initial value: 9 (counting the Standard Service Fee of 9%).
2.3.5. Business Rule—Service Fee Cutoffs: Management shall be able to change the annual EPostage revenue amount that triggers the application of each higher level of Service Fee. Initial value: see 2.3.3 through 2.3.3.8.
2.3.6. Business Rule—Service Fee Percents: Management shall be able to change the percentage of our Service Fee that we charge at each Service Fee level. Initial value: see 2.3.3 through 2.3.3.8.

Technical Note—Turning Off Fee Levels: Management can disable these Service Fee Levels by setting the Service Fee Levels value to 1. This effectively charges all of our Clients, by default, the same Standard Service Fee. (This Business Rule may very well be the first rule used by management as we will be carefully monitoring potential competition and we will likely change this value to 1 and charge the higher rates until signs of competition surface.)

2.3.7. Client Portion Custom Percent: 900Email shall provide a Client Portion Custom Percent field for each account.

2.3.7.1. Client Gets His Custom Portion Percent: 900Email shall ensure that a Client earns his Custom Client Portion Percent for the EPostage credited to his account and not the Standard Client Portion.

Technical Note—Translation: 900Email requirements might specify the EPostage split in terms of Service Fee in some places (1.6.10, p. 36; 2.3.3, p. 47), and in terms of the Client Portion elsewhere (2.3.2, p. 46; 2.3.7, p. 49). Of course, these are interchangeable, and as long as they total 100%, there should be no confusion. However, the implementation should take these English language requirements and standardize all this in terms of the Service Fee. Thus when we require a Custom Service Fee, the administrative software interface may allow a 900Email employee to specify a 99% Client Portion Custom Percent, but the program will enter that into the system actually as a 1% Custom Service Fee.

2.3.8. Client Portion Obligation: 900Email owes to the Client the “Client Portion” of all the EPostage on the messages which he has retrieved, either by displaying on his monitor or by downloading.

2.3.9. Client Portion Accrual: Only after a Client views or downloads a message shall 900Email credit his Client Portion to him.

2.3.10. Client Portion Recording: 900Email records (credits) the Client Portion into the Client's own EPostage account.

Technical Note—Client Portion Recording: 900Email shall credit any revenue generated from the Client Portion into the Client's EPostage account. Thus, the Client uses the same account to pay for EPostage and receive EPostage commission. 900Email credits Client Portion funds in real time, as new Email messages are retrieved. The Client can view his account balance and history by logging into his 900Email.com personal EPostage account web page.

Business Note—Lost Client Portion: If the Client does not retrieve (access by viewing or downloading) an Email message for any number of reasons in various circumstances, then 900Email records a credit for the EPostage back to our Customer, the sender, and the Client loses the opportunity to collect his Client Portion from that Email message. (See Refunds, 2.16, p. 86)

2.3.11. Escrow Account: 900Email temporarily holds all Client Portion funds in a consolidated escrow account.

2.3.12. Escrow Dispensing: On a monthly, quarterly, or annual schedule, depending upon the amount of money owed to a Client, 900Email dispenses to the Client his share of the funds in the consolidated escrow account (Client Payouts, p. 82).

2.3.13. Service Fee Accrual: As a corollary to the Client Portion Accrual, 900Email records (collects) its own Service Fee immediately after a Client retrieves (views or downloads) a message, but never before.

2.3.14. Rounding: 900Email shall round all Customer and Client financial calculations to the nearest penny, except for the Service Fee when the Service Fee Fractional Cents Tracking is turned ON (2.3.2.4, p. 47).

Technical Note—A Half Rounds Up: Any fraction of a penny under a half cent shall round down to the next lowest whole penny, and any fraction at or above 0.005¢ shall round up to the next penny.

2.4. Client EPostage

900Email shall support these Client EPostage requirements:

2.4.1. Automatic EPostage Setup: An EPostage account is automatically created during the Client's sign-up process.

Technical Note: A Client can use this EPostage balance to pay for messages sent to other 900Email Clients, and 900Email shall credit any revenue generated from his Client Portion into this same EPostage account (2.3.10, p. 49).

2.4.2. Initial EPostage: At Sign Up, 900Email asks the Client if he would like to purchase some amount of EPostage to simplify sending email messages to other Clients.

2.4.3. Default EPostage Purchase Suggestion: When the Client signs up and has the opportunity to first purchase EPostage, 900Email suggests an amount, the Default EPostage Purchase Suggestion.

2.4.3.1. EPostage Purchase Suggested Amount: 900Email shall calculate the first $5 multiple above the average initial EPostage purchase by our new Clients.

2.4.3.2. Suggested Amount Updates Weekly: The EPostage Purchase Suggested Amount updates once a week automatically, without requiring a Policy variable adjustment by management, and is initially set to $10.

2.4.4. Retained EPostage: In addition to actively purchasing EPostage, a Client can also specify an amount threshold below which his earned Client Portion deposits shall be retained for his use to pay for sending future Email messages.

2.5. Tiered EPostage

900Email shall support these Tiered EPostage requirements:

2.5.1. Multiple Rates Per Client: 900Email shall allow Clients to charge different rates to different senders.

2.5.2. Tiered EPostage Rates: Different senders may pay different rates because 900Email shall enable a Client to setup Custom Tiers charging different EPostage rates on different Tiers.

Business Note—Tier Rational: Some Clients shall not want all senders to pay the same EPostage rate. Thus, they may be tempted to keep other Email accounts so that family, friends, and clientele, for example, can continue to email them for free. So, to encourage those Clients to get rid of their other (junk-vulnerable) Email accounts, 900Email enables them to use Customer Tiers with varying EPostage rates.

Example—Family and Friends Tier: Tiered EPostage Rates allows a Client to charge a default rate of, say, 0.50¢ to the general public, and if he so chooses, the EPostage Minimum Rate of $0.05 to friends and family members. To accomplish this, he can list the Email IDs of his family and friends in his Family and Friends Customer Tier.

2.5.3. Email IDs in Tiers: 900Email Custom Tiers shall support an unlimited number of Email IDs per Tier.

2.5.4. Domains in Tiers: 900Email Custom Tiers shall support an unlimited number of Domain IDs per Tier.

Technical Note—Domain ID: (also, Domain) That part of an Email ID that lies to the right of the @ sign. Group.org is an example of a Domain ID from Leader@Group.org.

2.5.5. Public Tier: 900Email shall identify the Client's default Tier as his Public Tier.

Technical Note—Default Rate: When a Client selects his sign-up EPostage Rate, that rate will price his Public Tier. All senders who are not specially listed on a Custom Tier will be required to pay the Public Tier rate, which can be thought of as the Client's default rate. The Client can change the Public Tier rate, of course, as he can change any of his Tier rates (2.2.5, p. 45).

Examples—

Two Tiers: A typical Client might use two postage rates: a lower rate of 0.05¢ on a Custom Tier for his business associates, family and friends; and a higher rate of 0.50¢ for unknown (and even known) senders that get charged his default rate, at which he priced his Public Tier.

Three Tiers: A Client might use three rates: a lower rate on his Public Tier of say 0.34¢; a higher rate for family members and acquaintances of, say, 0.50¢; and his highest rate of 0.75¢ for any Email ID originating at a specific ISP because of some characteristic of, or relationship with, that provider.

Four Tiers: A manufacturer of heavy-duty shocks might use four rates: charging the general public 0.75¢; and on his Custom Tiers, his Family 0.25¢ (to discourage the frequent, time-wasting emails he gets even from family); emails originating from the domain Autocompany.com pay no EPostage (see the Prepaid Tier feature, 2.6.4, p. 56); and his competitors at ACME-Shocks.com pay $2.50.

2.5.6. Custom Tier: 900Email shall identify Tiers created by the Client as Custom Tiers.

2.5.7. Search for Sender on Tiers: When attempting to collect EPostage on an incoming message, 900Email shall determine whether a sender is listed (by Email ID or Domain) on any of the recipient Client's Custom Tiers.
Definition—Custom Tier: A list of Email and Domain IDs, which list a Client creates, names and prices, which price 900Email charges to deliver an incoming message sent by a member of this group; a Client rate grouping.
Definition—Public Tier: A default category for all senders not identified on a Client's Custom Tiers, which Tier a Client cannot name, but he can price, which price 900Email charges to deliver an incoming message sent by a member of this group (i.e., sent by anyone not identified on any of a Client's Customer Tiers); a Client's default EPostage Rate.

2.5.8. Charging by Tier: When processing an incoming Email message, if a Client has listed (by Email ID or domain) a Customer (the sender) on an EPostage Tier, then 900Email shall charge the Customer whatever rate the Client has applied to that Tier.

Technical Note—Superceded: This 2.5.8 requirement also appears in the context of the various ways of charging senders, by EStamps, Tiers, and Customer EPostage. The requirement to search Tiers for a sender (2.5.7, p. 51) and, if found, charge based on that Tier rate (2.5.8), is superceded if the sender uses a No Postage Necessary EStamp (2.7.1, p. 59).

Business Note—Last Resort: The Public Tier is the Tier of last resort. Always, 900Email shall exhaust all other payment options and EPostage Tiers before charging a sender the Public Tier rate. Thus, if a Client prices his Public Tier as Prepaid, then those senders identified on his differently priced Tiers will have to pay to email him even though the “public” could send messages for free.

2.5.8.1. Tier Conflicts: If a Client has listed a particular Email ID (or Domain ID) on more than one Tier, 900Email shall charge that Customer whatever rate applies to the first Tier on which it finds a match with the sender.

Technical Note—Email & Domain Conflicts: As 900Email searches a Client's Tiers looking to identify a particular sender, it checks those Tiers sequentially, one at a time. As soon as it finds a match, it stops checking, even if there were more Client Tiers it could have looked at. Thus, if a Client lists the same Email or Domain ID on multiple Tiers, 900Email will stop as soon as it encounters the first Tier containing that Email or Domain ID. So, 900Email will be unaware of other instances and rates for that Email or Domain ID. Similarly, if a Client has listed a particular Email ID on a Tier, and separately, a Email or Domain ID even if on that same Tier, 900Email will stop searching for an applicable rate as soon as it identifies the first instance of a Domain or an Email ID which identifies or includes the current sender. For example, JohnSmith@specialtyhouse.com and the Domain ID, specialtyhouse.com both match an incoming message from Mr. Smith, so 900Email will use the first match it encounters.

2.5.8.2. Tier Search Order: 900Email shall support these requirements on the order Tiers will be searched looking for the correct EPostage rate to charge a particular sender:

2.5.8.2.1. Ascending Rate: 900Email shall search Tiers in order from the lowest priced to highest priced Tier.

2.5.8.2.2. Public Tier: Regardless of the price for the Public Tier, of course, 900Email shall leave the Public Tier for last.

Business Note—Ascending Rate Rationale: If a sender can be located on more than one Tier, most likely the Client will have intended to charge that sender the rate on the lower-priced Tier. For example, if anyone at Xcompany.com is charged $0.25, but a friend, Wally@Xcompany.com is listed on a Friends&Family Tier at $0.05, the Client almost certainly intends to charge Wally the cheaper rate.

2.5.9. Manage Tiers

900Email shall support these requirements to Manage Tiers by providing the user interface to accomplish this on the 900Email.com website (4.3.7, p. 116):

2.5.9.1. Add Tier: A Client can create an EPostage Tier by naming it.

2.5.9.1.1. Tier Naming: Tier names (alphanumeric, etc) have the same constraints as Email IDs supported by 900Email.com (1.10.3.5, p. 43), that is, they can contain no spaces, and must begin with an alphabetic character, etc.

2.5.9.2. Price Tier: A Client can apply any valid EPostage Rate to any given Tier.

Technical Note—Postmaster Pricing: A Client can price a Tier the same as a U.S. Stamp (2.2.8, p. 46), or any price from the EPostage Minimum Rate on up. If a Client priced one or more Tiers at the price of a U.S. Stamp, then when the U.S. Postmaster increases the price of a first-class stamp, then 900Email will change the price of all so-designated Tiers.

2.5.9.3. Modify Tier: A Client can modify the spelling of the name of a Tier, or the price of a Tier.

2.5.9.4. View Tier: A Client can view Tier names, their EPostage Rates, and their Email ID and domain ID contents.

2.5.9.5. Delete Tier: A Client can delete an EPostage Rate Tier.

2.5.9.6. Add Email ID: A Client can add Email IDs to a Tier.

2.5.9.7. Add Domain ID: A Client can add Domain IDs to a Tier.

2.5.9.8. Modify ID: A Client can modify the spelling of Email IDs and domain IDs on a Tier.

2.5.9.9. Delete ID: A Client can modify the spelling of Email IDs and domain IDs on a Tier.

2.5.10. Tier as Group: When 900Email sees the name of a Tier in the To: field of an outgoing Email message (or the CC: or BCC: fields), it shall replace the Tier name with the Email ID members of that Tier.

Scoping Note—Version 2.0: 900Email shall not support this feature in its first public release.

Technical Note—Domains Don't Fly: When a Client sends an Email message addressed to a Tier, 900Email will send that message to all the members of that Tier. However, Tiers may contain both Email IDs and domain IDs. So in this function, 900Email ignores the domain IDs.

Business Note—Reinforcing 900Email: Everything that our company does and that our software does should reinforce our worldview of how communications should function. Using Tiers in the role of the convenient, traditional email groups helps users to think in a new way—our new way. Not only do groupings of Email IDs help simplify communications, but those groupings may often imply varying degrees of value of communication, heretofore unexploited. Think of the email group lists of an important CEO: BoardOfDirectors, FamilyAndFriends, DivisionManagers, IndustryAnalysts, MediaContacts, TopClients, IndustryAssociationMembers, AllCompanyEmployees, and, he even has a public Email ID published on their corporate Contact US web page which generates mail that his hopeless secretary is required to suffer through. In a limitless world, he may want to give full attention to any number of communications from all members of all these lists. But, not being divine, he has normal human limitations. So, 900Email offers him the ability to subjectively value input from each of these lists. At the very least, he is now free of junk mail. Then, our EPostage Minimum Rate might help to reduce the unnecessary anecdotes, unimportant FYIs, and mindless cute stories that he might otherwise get from some of the inconsiderate people on his lists. And further, he can charge a high rate for his public Email ID (at least now enabling the public actually to reach him, something they could not do before). And he might charge a significant rate for Industry Association Members, and perhaps even a rate of $25 or so for employees (which would most likely come out of the employee's department budget) to make them think twice before emailing him.

Technical Note—Naming Convention: On the construct of Tier names (2.5.9.1.1 above), they must be formed the same as standard Email IDs eventually to allow Tier names in the To: fields of outgoing messages. However, a Client, say, Patsy@900Email.com, using MS Outlook cannot just send an email To: Friends&Family, for his SMTP server would not know where to route his messages. For this purpose, we will implement the following syntax: To: Patsy.Friends&Family@900Email.com, to be read as “send this message to everyone on Patsy's friends and family Tier.” When that message arrives at 900Email, we will parse it, and find the Client's Email ID, followed by one of his Tier names, and then route copies of the message to all the constituent members on that Tier. Marketing requests input from development on the feasibility of this feature.

Example—Tier Usage: A famous author enlists 700 former armed forces personnel for a web-based research project. They participate over six months, interacting by email. The author normally charges $100 to receive emails. But of course, for this project, he either lists the participants on a Prepaid Project Tier, or charges, say, 0.05¢. After the project terminates, he may keep that Tier but up the rate on it to $5 so that he could still get follow-up input from those participants, but the small fee keeps their correspondence from overwhelming his personal inbox. Of course, he could fine-tune the amount of response he gets from this group by increasing, or lowering that Tier EPostage rate over time. Also, if he gets too much email from the most aggressive people in the group (along with the burden of their expectation that he reads their emails), then he could selectively increase the rate for those individuals, by, for example, moving their Email IDs to a new Tier titled ProjectActivists and charging perhaps $20. The higher EPostage rate would slow down the flow of mail, increase its value, and may thereby change the author's attitude about reading it.

2.5.11. Tier Access Code: 900Email shall enable a Client to establish an access code for each of his tiers which code he may then provide to a potential sender, which if the sender includes such code in a message to the client, the system shall automatically add the sender to the Tier indicated by that code.

Business Note—Access Code: Thus a Client can easily add new senders to his established tier structure without manually adding each sender's email ID.

2.6. Prepaid EPostage

900Email shall support these Prepaid EPostage requirements for Prepaid Tiers and for EStamps:

2.6.1. No Postage Required: 900Email shall enable a Client to allow senders to Email messages to him, free-of-charge (via Prepaid Tiers & EStamps, 2.6.4 & 2.7.1, p. 59) by paying for the EPostage himself.

Business Note—No EPostage?: With 900Email, every message is paid for by someone. So in the case of an auto company purchasing agent emailing a supplier, say at AutoShocks@900Email.com, AutoShocks can elect to pay the EPostage itself. Some Clients will want to pay this EPostage for the same reason that they maintain toll-free 800 numbers, and send out self-addressed stamped envelopes. Regarding Tiers vs. EStamps, Prepaid Tiers address the Client need to pay for incoming messages when he knows the identity of the senders. EStamps address the Client need to pay for incoming messages when he does not know the identity of the senders.
2.6.2. Business Rule—EPostage Prepaid Rate: Management shall be able to change the amount we charge Clients who pay for Prepaid EPostage. Initial value: EPostage Minimum Rate (currently $0.05)

Business Note—Client Pays: Using a Prepaid Tier, the Client does not have to charge a particular list of senders any postage (e.g., on an Investors Tier), so that they shall be able to email him for free. The Client should maintain a positive EPostage account balance sufficient to pay for incoming Prepaid messages. See EPostage Automatic Purchases (3.6, p. 97).
Definition—Prepaid Email: The Client can pay (with actual funds or with his good credit) to cover the cost of an incoming message. Thus, the sender does not have to pay EPostage to transmit a message to a recipient in this situation, and for this service 900Email charges our Client our EPostage Prepaid Rate of $0.05 (which currently equals our EPostage Minimum Rate).

Business Note—Prepaid Freight: In some industries, Prepaid means that the apparent customer does not need to pay for the service. The trucking industry classifies freight as collect when the recipient must pay, and as Prepaid when they know they must bill the manufacturer. So, the term Prepaid, though counter-intuitive, does not necessarily mean that a service is paid for prior to use, but that the responsible party will be billed later, covering the cost by the good faith and credit of the actual customer. This document's Glossary states in the definition for Customer, “The one who pays the bill is the true Customer.” In the case of 900Email Prepaid EPostage, the Client is the actual Customer, since for those messages he is the one paying the bill.

2.6.3. No Prepaid Client Portion: 900Email shall not credit a Client Portion to the recipient for Prepaid Email messages that he himself has paid to receive.

2.6.4. Prepaid Tier: 900Email shall support these Prepaid Tier requirements:

2.6.4.1. Pricing a Prepaid Tier: A Client shall be able to price a Tier (2.5.9.2, p. 53) as Prepaid by entering the word “Prepaid” in the same field wherein he would otherwise enter a dollar amount.

Technical Note—A Prepaid Tier: If a Client lists a sender's Email or Domain ID on a Tier, and marks that Tier as Prepaid, then that sender shall be able to transmit messages to that Client for free, with the Client paying the EPostage due per message.

2.6.4.2. Displaying the Prepaid Fee: When a Client enters the word “Prepaid” to price a Prepaid Tier, 900Email shall append in that field the dollar amount of the rate we charge Clients to receive Prepaid messages.

Example—Append the Prepaid Rate: When the Client prices his CityCouncil Tier at “Prepaid” 900Email then displays the following in that pricing field: Prepaid: at 0.05¢ per message. Also, if his city council members all have IDs at HometownUSA.gov, he could list only that Domain ID, HometownUSA.gov, on the Tier, rather than list each of their Email IDs separately.

Business Note—Prepay Opportunity: Consider an Investment Company with two hundred employees, almost all of whom use email and spend time online each day. They hope to get email inquiries from potential investors. Of course, they have no idea from which Email IDs they might get requests for information, and they don't want to discourage any prospect by forcing him to pay for EPostage. Yet the company's employees are drowning in junk mail and management estimates a loss in productivity of 15 minutes daily per employee, of the kind of distracting interruptions that are scattered throughout the day. 900Email can help Investment Company recover that productivity. Investment Company contracts with 900Email to host their email system. Every employee at Investment Company keeps his current Email ID, and management puts a 0.25¢ fee on all their accounts. But they set up one account, Info@Investmentcompamy.com, as a Prepaid EPostage account. Investment Company maintains a toll-free 800 number for sales, and so now, they have a toll-free Email account. With this solution, they liberate their entire workforce from junk mail, except for the one sales account. With 200 employees, this recovers 2,495 hours of productivity per month, and at an average labor cost of $15 per hour, this recaptures $16,200 monthly and $194,400 annually of actual losses, and potentially increased revenue. Their newly found incoming EPostage revenue, the improved email communications, and the increased productivity, combined, will cover the cost of the one pre-paid EPostage account a thousand times over.

Technical Note—Charging the Client: This requirement works as follows: when an incoming message arrives from a sender listed on a Prepaid Tier, 900Email shall debit the recipient Client's EPostage account by the EPostage Prepaid Rate amount (2.6.2, p. 55). That is, we shall charge the Client whatever the going rate is for receiving Prepaid email, currently $0.05.

2.6.4.3. Monthly Fee: Alternatively, 900Email shall enable a Client to pay a monthly fee to allow passage of an unlimited number of messages from senders listed on Prepaid Tiers.

2.6.4.4. Displaying the Monthly Fee: When a Client has signed up for our monthly Unlimited Prepaid Messages service, when he enters the word “Prepaid” to price a Prepaid Tier, 900Email shall append in that field the monthly fee automatically charged to his EPostage Account.

Example—Append the Monthly Fee: When the Client has signed up for Unlimited Prepaid Messages, and he then prices his CityCouncil Tier at “Prepaid,” 900Email displays the following in that pricing field: Prepaid: unlimited messages for $5.95 per month.
2.6.5. Business Rule—Unlimited Prepaid Messages Fee: Management shall be able to change the amount we charge Clients monthly to receive an unlimited number of Prepaid messages. Initial value: $5.95

2.6.6. Accept All Public Tier Messages: 900Email shall enable a Client to price his Public Tier as Prepaid, without disregarding other Tier prices.

Technical Note—Prepaid Public Tier: If a Client expects an important email, but from an unknown source, he may want to temporarily price his Public Tier as Prepaid. If a sender's Email ID appears on some other Tier, 900Email shall charge that sender that Tier rate even if the Client has priced his Public Tier as Prepaid. That is, the Prepaid Public Tier does not override the other Tier prices, but rather, has a lower precedence. This is the normal handling of the Public Tier, as intentionally determined by these requirements. 900Email always must first determine that a sender does not exist on any Custom Tier before pricing him according to the Public Tier. And remember, the Client may price his Public Tier as Prepaid, without disregarding other existing Tiers. Imagine a Client with four differently-priced Tiers with dozens of Email IDs on each Tier. He expects an important email during the next week from an unknown source, so he prices his Public Tier as Prepaid. However, he still expects that other senders specifically listed on his other Tiers will pay the prices he has established for those Tiers. This requirement, Accept All Public Tier Messages, effectively pauses the “filter” function of 900Email, allowing delivery of unpaid messages. A Client would most likely use this feature only temporarily. If for some reason a Client wants to suspend all filtering, even for his existing priced Tiers, he must mark each Tier as Prepaid. We will listen to Client feedback and consider adding a feature that allows a Client to change a Tier to Prepaid temporarily, for a certain length of time, or until a certain number of messages arrive, at which time the system would automatically revert his price to its previous setting.

2.7. EStamp

900Email shall support the following EStamp requirements:

Business Note—U.S.P.S. Model: The use of 900Email EStamps, to some extent, parallels the practice of the U.S. post office and its customers in their effort to simplify the purchase and use of postage. In another way, it extends the concept of what a stamp can do. First, consider the tradition functionality.

The U.S.P.S. enables a recipient to pay for the delivery of some of the mail he receives. The recipient can pay for the delivery of mail he receives in two ways.

One: The recipient can provide senders with pre-printed No Postage Necessary envelopes that can be used to pay to send an Email message only to that recipient.

Two: Or, the recipient might send out an SASE, that is, a self-addressed stamped envelope. (A variation on this second method is to use it with large packages, and not just with envelopes. The recipient pays for the delivery of a large package that requires many dollars worth of postage, for which the recipient has provided face-value stamps to the sender, of a sufficient amount to pay for the delivery of the package.)

A different practice makes it easier for senders to buy and use postage. Pitney Bowes Corporation sells U.S. postage to their customers in bulk amounts, which postage logically fills their meter machines, and as the customer needs postage, the machine prints out metered postage. If the sender needs to affix $9.42 postage to mail a particular package, the meter can print out a single stamp for that amount.

Three: The sender purchases postage in bulk, and applies it as needed, to his mail messages.

Four: Regarding the non-traditional use of a stamp, 900Email EStamps can function as an authentication mechanism, rather than as payment for delivery. That is, an EStamp can have encoded into it an encrypted representation of the Customer's Email ID. For security, 900Email shall enable the sender to identify the recipient of a particular Email message within the encoding of this EStamp. In this way the EStamp, even though represented by easily readable ASCII characters, and fully in view of hackers while traveling over the web, would not lend itself to the theft of funds, since a hacker could see the EStamp, and copy it, but it would only be useful to send a single message from the sender to that sender's intended recipient. Thus, hackers could not reroute funds into their own Client accounts, or to others. Hackers could do to an EStamped message what they do with any clear text Email message: they could disrupt the transmission or modify the message, but they could not steal or reroute the funds without breaking our encryption code. We will use state-of-the-art encryption to generate the EStamp's ASCII string.

Thus, 900Email shall support four kinds of EStamps, No Postage Necessary, Face Value, and Metered Postage EStamps; and also, the non-traditional use (for stamps that is) of Authentication. This fourth type of EStamp is definitely scoped into the first version of the product, and has the highest development priority of the four kinds.

2.7.1. EStamp Type 1: 900Email shall support No Postage Necessary (NPN) EStamps.

2.7.1.1. Clients Only: 900Email shall only issue NPN EStamps to our Clients (we will not issue them to Customers, but of course, any sender, including our Customers, can use NPN EStamps that are given to them by our Clients.)

Technical Note—Scope: A Client eventually will be able to obtain NPN EStamps in four different ways. They are presented below in order of development priority.

2.7.1.1.1. From Website: 900Email shall make NPN EStamps available to our Clients directly from our website.

2.7.1.1.2. By Email: 900Email shall make NPN EStamps available to our Clients who email a request for them to NPNEStamps@900Email.com.

2.7.1.1.3. From Meter: 900Email shall make NPN EStamps available to our Clients via our EPostage Meter software, which shall dispense both Face Value EStamps and NPN EStamps.

2.7.1.1.4. By SMTP Request: 900Email shall make NPN EStamps available to a Client who uses our own ISP service (who therefore also uses our 900Email SMTP server to originate his outgoing email) when he indicates in his outgoing message that he wants an NPN EStamp attached to that message (for the benefit of the recipient, who will then be able to use that EStamp to reply to our Client).

Technical Note—Implementation: Marketing realizes that some initial requirements may turn out to be technically unachievable. Whenever that occurs, Marketing requests suggestions from Development on alternative methods of meeting the relevant user needs.

2.7.1.2. Obtained Freely: Just like with U.S. Post Office customers, 900Email shall enable our Clients freely to obtain the first kind of EStamp, the No Postage Necessary, i.e., NPN EStamp.

2.7.1.3. Client Identity Encoded: 900Email shall encode the identity of the Client to whom an NPN EStamp has been issued into each EStamp itself.

2.7.1.4. Only Good for that Client: 900Email shall only honor an NPN EStamp when it is used for delivery of an Email message to the Client who had first requested the EStamp.

2.7.1.5. Charged When Used: Only when a sender actually uses an NPN EStamp does our Client pay for that EStamp.

Business Note—U.S.P.S. Comparison: With the U.S. Post Office, a business gets an account number, and then freely prints any number of No Postage Necessary envelopes that display his account number, and then the Post Office only bills him for those stamps that senders actually use to mail him items. Thus, unused EStamps are never paid for.

2.7.1.6. Rate Charged: For this type of EStamp, 900Email shall charge the recipient Client the standard Prepaid Rate (2.6.2, p. 55) for delivery of that message, which rate is currently $0.05.

2.7.2. EStamp Type 2: 900Email shall support Face Value EStamps.

2.7.2.1. From Website: 900Email shall sell Face Value EStamps to our Customers directly from our website whereby the purchaser requests and pays for the EStamp by remitting the amount of money required to cover the Face Value of that EStamp.

Business Note—EPostage Purchase Fees: EPostage Purchase Fees (3.4, p. 95) apply.

2.7.2.2. Denomination: 900Email shall sell Face Value EStamps in any denomination, that is, for any Face Value, for example, $0.37, $5.00, $125, or $15,000.

2.7.2.3. Security: 900Email shall support the following security features for use with Face Value EStamps.

2.7.2.3.1. Encrypted: 900Email shall encrypt EStamps so that they cannot be counterfeited.

2.7.2.3.2. Transferable: 900Email shall default to dispensing transferable EStamps which can then be used to send Email messages from any Email account.

2.7.2.3.3. Non-transferable: At the time of purchase, 900Email shall enable the Customer to request that an EStamp be non-transferable, which can then only be used to send Email messages from the purchaser's Email account.

Technical Note—Non-transferability: A Customer who purchases a high-dollar EStamp may want it to be non-transferable to improve security, to reduce the possibility of him losing it to a thief. A non-transferable EStamp can only be used for delivery of Email messages that indicate that they originated from the purchasing Customer's Email ID. This feature is similar to travelers' checks, as opposed to cash; for cash can be used by anyone, but travelers' checks can only be cashed by the purchaser. A 900Email Customer might want this level of security if he has purchased a high-dollar EStamp, say for $5,000, to make sure that no one else can use that EStamp in the case of it being lost or stolen.

2.7.2.3.4. Pre-Destined: At the time of purchase, 900Email shall enable the Customer to request that an EStamp be hardwired for use to deliver Email messages to one specific Email account.

Business Note—Predestination: A Customer who purchases a high-dollar EStamp may want it to be hardwired for use to deliver an Email message to a specific account, say BigStar@900Email.com, to reduce further the possibility of losing it to a thief. Thus, he can hard code that this $15,000 EStamp can only be used to deliver an email from his account, to Rush's account, thus reducing the likelihood of it being stolen or misused. Another example: if Big Star charges $500 for access to his inbox at BIGSTAR@900Email.com, then John Smith can purchase a $500 EStamp and restrict its use so that it is only valid when delivering a message, from John Smith, to Big Star. Such an EStamp cannot, therefore, be transferred to a third party or used for to send messages to other Clients, however, it could be brought to our 900Email Post Office by the Customer for exchange or refund.

2.7.2.3.5. Free Will: 900Email shall enable a Customer to change his mind and freely exchange a previously hardwired EStamp for standard EPostage or for one or more different EStamps.

2.7.2.3.6. Unauthorized Use: If we find an EStamp being used in an unauthorized way, 900Email shall return the EStamp to its rightful owner.

2.7.2.3.6.1. Unauthorized User: If we find an EStamp being used by an unauthorized sender, 900Email shall send an automated warning message to our Customer.

2.7.2.3.6.2. Unauthorized User Notification: If we find an EStamp being used by an unauthorized sender, 900Email shall send an automated warning message to that sender.

2.7.2.3.6.3. Unauthorized Use Report: If we find an EStamp being used in an unauthorized way, 900Email shall report that circumstance to the appropriate Operations personnel.

2.7.3. EStamp Type 3: 900Email shall support Metered EPostage EStamps.

Business Note—Postage Meter: The third kind of EStamp parallels the postal meter machine concept. Rather than buying a single EStamp, a Client or Customer can purchase a dollar amount of EPostage and then use it as needed, in the same way that U.S. Post Office customers use postage meter machines. Via our 900Email.com website, or via desktop software, the Customer can draw upon EPostage he has purchased in bulk to dispense and affix an EStamp to an Email message. Type 3 EStamps differ from Type 2 only in their manner of purchase; beyond that, they are identical; so that, our EStamp Meter machine actual issues Type 2 EStamps. Thus, Type 3 EStamps will function like Type 2, and so Type requirements, such as the actions to take upon detection of unauthorized use, will parallel Type 2 functionality.

2.7.3.1. Bulk Purchase: 900Email shall enable a Customer to purchase any amount of EPostage for his use so that he can then easily obtain Face Value EStamps of any denomination out of his purchased EPostage.

Technical Note—Scope: A Customer eventually will be able to obtain Metered EPostage EStamps in two different ways, as dispensed from our website out of his EPostage account balance, or as dispensed from our EPostage Meter software running on his desktop out of the balance of EPostage he has purchased which balance is maintained within that Meter software. These methods are presented below in order of development priority.

2.7.3.2. From Website: 900Email shall dispense Face Value EStamps (of any denomination up to his current EPostage balance) to our Customers directly from our website.

Business Note—Type 2 Difference: For this requirement, the only difference between issuing a Type 2 and a Type 3 EStamp from our website is that the Type 2 transaction requires payment for the Face Value of that EStamp at the time of issuance. Whereas, the Type 3 transaction draws from existing funds in the Customer's EPostage account, which act as his online EPostage Meter.

2.7.3.2.1. Paid from EPostage Account: The requested EStamp value will be deducted from his standard 900Email EPostage Account.

2.7.3.3. From Meter Software: 900Email shall enable a Customer to dispense Face Value EStamps (of any denomination up to his current Meter balance) out of his EPostage Meter software running on his desktop.

2.7.3.3.1. Paid from Meter Balance: The requested EStamp value will be deducted from his current balance as maintained in his desktop EPostage Meter.

Technical Note—Scope: Our 900EMail EPostage Meter software shall run in the user's local environment in four different configurations: as a plug-in for MS Outlook and Outlook Express (which together make up 62% of the email client desktop software market); as a Windows Tray Utility (on the right side of the task bar near the clock); as a Java Applet (for Linux and Unix users); and as an Apple operating system desktop utility.

2.7.3.3.2. MS Outlook Plug-in: The 900Email EPostage Meter shall run as an Outlook plug-in.

2.7.3.3.3. Windows Tray Utility: The 900Email EPostage Meter shall run as a Windows Tray Utility.

2.7.3.3.4. Java Applet: The 900Email EPostage Meter shall run as a Java Applet.

2.7.3.3.5. Apple Desktop Utility: The 900Email EPostage Meter shall run as an Apple desktop utility.

2.7.3.4. Excess Face Value: If a Sender uses an EStamp of higher face value than necessary to send a message to a recipient Client, 900Email shall refund the excess EPostage amount to the sender.

2.7.3.5. Excess EPostage to a Customer: When refunding EPostage to a Customer, which refund resulted from the use of a Face Value EStamp of excess value, 900Email shall credit the excess amount to the Customer's EPostage Account.

2.7.3.6. Excess EPostage to a Non-Customer: When refunding EPostage to a non-Customer, which refund resulted from the use of a Face Value EStamp of excess value, 900Email shall send an email with the excess amount encoded into an EStamp attached to that Email message.

2.7.3.7. Explanation of Refund: When refunding EPostage, 900Email shall notify the Customer by email of the credit.

Business Note—Keep the Money?: Of course, the U.S.P.S. keeps excess postage, and takes it as income, which is a theoretical option for 900Email also. Alternatively, we could pay the Client his Client Portion percent on the entire amount, including the excess EPostage amount. However, the sender is our true Customer, and it is to him that we owe the greatest consideration. Therefore, the requirement has been written to refund the sender.

Technical Note—Implementation: The technical design required to implement EStamps appears to be a non-trivial issue. It is possible that the marketing constraint of interoperating with other email systems, according to de facto industry standards, over the public Internet, might make implementation of some or all of these EStamp requirements impossible or impractical. In this case, Marketing may either delete these requirements, change the constraints, or attempt to redesign these features to meet Client needs in a different way.

Regarding implementation, especially initially given the current Email landscape, an EStamp could be a unique string of encrypted ASCII-7 characters that the Sender pastes into his outgoing Email message beginning on the first line of the message.

Alternatively, perhaps in a subsequent version, an EStamp could be a unique, encrypted file that functions similarly to a digital certificate. An EStamp worth $450 dollars might be an encrypted file titled 450.9ES, with the face value as the file name left of the extension, and the extension of 9ES identifying the file as a 900Email EStamp. 900Email identifies the actual value of such an EStamp not by the file name, which the Customer could change, but by the encrypted information within the file. A No Postage Necessary EStamp might be contained in a file titled NPN-BigStar.9ES. If a Client or Customer has more than one EStamp with the same value, say $5, those EStamps might reside in a directory with filenames like: 5-1.9ES, 5-2.9ES, 5-3.9ES, 5-4.9ES, etc., and the same with NPN-BigStar-1.9ES, NPN-BigStar-2.9ES, NPN-BigStar-3.9ES, etc. A Customer could attach such a file to pay for an outgoing Email message. A problem with that approach, however, is that sending an attachment leaves the original file unaffected. It is not reasonable to expect that Customers will manually delete an EStamp file after having used it to send an outgoing message. Thus, the Customer can easily forget that he had already used a particular EStamp, and of course, with this approach, the encoded information in the EStamp would not get re-written to indicate that it has already been used. So, apart from using EStamps in conjunction with 900Email software (plug-in or website), they might be rather difficult for the public to use.

Also regarding implementation, consider the matter of encryption, and whether a message encrypted by the sender would make the EStamp attachment invisible, and therefore unavailable, to 900Email. Would it be possible to append our encrypted EStamp attachment as the last attachment on an encrypted message, so that when 900Email looks for an EStamp, it will be able to find it, if it is there, even with encrypted messages?

2.7.4. EStamp Type 4: 900Email shall support Authentication EStamps.

2.7.4.1. Authentication Mechanism: 900Email shall issue EStamps that can function as an authentication mechanism, authenticating the sender.

2.7.4.2. Purchased from Website: 900Email shall make Type 4 Authentication EStamps available to our Clients directly from our website.

2.7.4.3. Purchased from Meter: 900Email shall make Type 4 Authentication EStamps available to our Clients via our EPostage Meter software, which shall dispense Authentication, Face Value, and NPN EStamps.

2.7.4.4. EStamp Uniqueness: 900Email shall generate EStamps that are unique.

2.7.4.5. EStamp Expiration: 900Email shall generate EStamps that expire after a specified length of time.
2.7.4.6. Business Rule: Authentication EStamp Expiration Period—Management shall be able to change the length of time that must transpire before a Type 4 Authentication EStamp expires. Initial value: 1 week.

Technical Note—Expiration Option: 900Email can achieve increased security by shortening the expiration period of Authentication EStamps. When we generate these EStamps by way of our EPostage Meter software on the Client's desktop, we could optionally enable a shortened expiration period, as short of, say, five to ten minutes, or perhaps an hour. The EStamp encryption could have the time and day encoded into the ASCII string, thus enhancing the security of the EStamp and further frustrating hackers. We can reduce the expiration period by a greater extent when the Customer generates the EStamp from his desktop software, because standard usage in that scenario will be that he generates the EStamp just as he is about to send that Email message. Marketing requests input from development on this idea, and if we decide to implement this, then we will add another Expiration Period Rule that will apply only to desktop-generated EStamps.

Additionally, enabling the Customer to generate Authentication EStamps on his desktop (2.7.4.3), requires development to implement a mechanism whereby those remotely generated EStamps are recognized as valid when they arrive at 900Email.com.

2.7.4.7. Expired EStamps Rejected: 900Email shall reject expired EStamps as payment for delivery of an Email message.

2.7.4.8. Expired EStamp Reply: 900Email shall send an Automated Reply to the sender informing him of the rejection and inviting him to obtain a new EStamp.

2.7.4.9. Sender Encoding: 900Email shall encode an encrypted representation of the Customer's Email ID into an ASCII string.

Business Note—Authentication EStamp Transferability: An Authentication EStamp, by definition, is not transferable. However, a Customer who wishes to give EPostage to someone else could purchase a Face Value Type 2 EStamp, and give that EStamp, which contains no sender authentication, to another person who could then freely use it to pay for delivery of a message.

2.7.4.10. Recipient Encoding: 900Email shall require the sender also to identify the recipient of a particular Email message within the encoding of this EStamp.

2.7.4.11. EStamp Encryption: 900Email shall use state-of-the-art encryption to generate the EStamp's ASCII string.

2.7.4.12. Unauthorized Type 4 Use: If we find an Authentication EStamp being used in an unauthorized way, 900Email shall refuse to deliver the Email message to which it is attached.

2.7.4.12.1. Unauthorized Type 4 Use: If we find an Authentication EStamp being used in an unauthorized way, 900Email shall invalidate the EStamp.

2.7.4.12.2. Unauthorized User: If we find an EStamp being used by an unauthorized sender, 900Email shall send an automated warning message to our Customer.

2.7.4.12.3. Unauthorized User Notification: If we find an EStamp being used by an unauthorized sender, 900Email shall send an automated warning message to that sender.

2.7.4.12.4. Unauthorized Use Report: If we find an EStamp being used in an unauthorized way, 900Email shall report that circumstance to the appropriate Operations personnel (see 7.5.10, p. 132).

2.8. Validating EPostage

900Email shall support these EPostage Validation requirements until it either locates sufficient funds or exhausts all options:

Business Note—Accounting Definitions: The following definitions will help clarify accounting statements made throughout this document.
Definition—Physical Account: Money is described as residing “physically” in an account when that account is an actual bank account. Also, an actual bank account (as contrasted with an internal bookkeeping account), is referred to as a “physical” account.
Definition—Logical Account: Money is described as residing “logically” in an account when that account is an internal booking account, rather than in an actual, physical bank account.
Definition—Purchase: Acquiring EPostage (or some other product or service) by paying for it with actual money out of a Customer's physical bank account or other third-party payment service (like PayPal.com).
Definition—Credit: Adding a sum to the balance of an internal, logical bookkeeping account.
Definition—Debit: Deducting a sum from the balance 10 of an internal, logical bookkeeping account.
Definition—Validate: Identifying the availability of a sufficient EPostage balance to pay for delivery of a particular Email message to a recipient Client. When validation occurs, we immediately thereafter collect that EPostage just prior to delivering the Customer's Email message to the Client's inbox.
Definition—Collect: Crediting an EPostage amount consisting of the Client's required Rate (which includes his Client Portion and our Service Fee) to the Internal Collected Funds Account (by debiting the Customer's EPostage Account). These funds will not be recorded to the Client's EPostage Account, nor to our own Accrued Revenue Account, until the Client retrieves his message.
Definition—Charge: Moving logical funds, like those needed to cover our Service Fee, from one account, like the Internal Collected Funds Account, into another, like our own corporate Accrued Revenue Account.
Definition—Record: After the Client retrieves an Email from his inbox, we charge our Service Fee (by debiting the Internal Collected Funds Account and crediting our own corporate Accrued Revenue Account), and we credit the recipient his Client Fee (by again debiting the Internal Collected Funds Account and crediting the Client's EPostage Account). Similarly, regarding Guaranteed Replies, we do not record the Client Portion, nor our Service Fee, until the Client sends a reply to the Customer. However, we charge our Service Fee on Prepaid messages immediately upon delivery of such messages into the Client's inbox.
Definition—Accrued Revenue: 900Email recognizes our income only after we have completed our obligation to our Customer, that is, after the Client has retrieved the message (or in the case of a Guaranteed Reply, after he has replied).
Definition—Pay Out: Transferring physical funds out of a 900Email bank account to a Client in the form of a check or an electronic transfer into his own physical bank account or other third-party financial services account (like PayPal.com).

Technical Note—Validation, Collection, and Recording: 900Email shall take the following steps in attempting to validate, collect, and record EPostage transactions required for delivery of an incoming Email message:
900Email shall determine whether the recipient Email ID has an active account at 900Email.com (or at a hosted domain).
Based on the sender's Email ID, 900Email shall determine the EPostage Rate for delivery for that particular message to that particular recipient.
900Email shall check to see if any particular EPostage source (EStamps, Prepaid Tier, or EPostage Account) is available to cover the cost of delivery indicated by the Client's applicable EPostage rate.
If the available EPostage source is an EPostage Account, 900Email shall determine if a sufficient balance exists to cover the required EPostage.
If there is no EPostage source, or, if an insufficient balance exists in the EPostage Account, then 900Email shall terminate the validation effort by sending an Insufficient EPostage Reply to the sender.
If a No Postage Necessary EStamp or a Prepaid Tier status is being used to cover the cost of delivery for this Email message, then 900Email charges and records its Service Fee immediately by directly debiting the Prepaid EPostage rate (currently $0.05) or No Postage Necessary EStamp rate (currently $0.05) from the Client's EPostage Account and crediting that amount to our Internal Accrued Revenue Account (8.2.5, p. 143).

If taken, this step ends the validation and collection process, otherwise:
If a Corporate EPostage Account is being used to cover the cost of delivery for this Email message, then 900Email shall attempt to validate the existence of the required EPostage in that account.
If a Customer EPostage Account is being used to cover the cost of delivery for this Email message, then 900Email shall attempt to validate the existence of the required EPostage in that account.
Pending retrieval of the new message by our Client, 900Email shall collect validated EPostage by charging the responsible EPostage account and crediting our Internal Collected Funds Account.
Upon Client's Retrieval of a message, 900Email shall record the Client Portion to the Client's Internal EPostage Account (8.2.3, p. 142).
Upon crediting a Client's Portion to his EPostage Account, 900Email shall then immediately record our Service Fee to our Internal Accrued Revenue Account (8.2.5, p. 143). Most times the validation process will reach this step.

Business Note—Early Paycheck: When the Client pays the EPostage to receive an email (either with an EStamp or via a Prepaid Tier), then he is the Customer, the sender is not! When our Client is also the Customer, 900Email will have fulfilled its obligation to him when we deliver the Email message to his inbox. That is why we record our Service Fee in this situation upon delivery, instead of waiting to verify a Retrieve. Since he is the one paying to have the message sent to him, 900Email has no financial obligation to the actual sender, and thus, we can justifiably take our Service Fee at that point of delivery and not wait until the Client Retrieves the message that he himself paid us to deliver to him. Of course, even if we did wait, and the Client never accessed that message, he would theoretically have caused a Refund event, for which we would charge him the Refund Fee (2.16.4, p. 87, currently $0.05), which is currently defined as the same amount as the Prepaid EPostage Rate, that is, $0.05.

2.8.1. Delivery Rate: 900Email shall determine the appropriate amount of EPostage required to deliver the sender' incoming email to the intended Client (2.5, p. 50), based on the Client's established Tier Rates.

Technical Note—Rate Determination: In order for 900Email to deliver a particular sender's Email message to a particular Client at a particular time, unless the sender is using a No Postage Necessary EStamp, 900Email shall determine the EPostage Rate the sender must pay by checking to see if the sender is listed on a custom Tier of the recipient Client. If so, the sender must pay whatever rate is assigned to that Tier. If the sender is not listed on any Custom Tier, then he must pay the Client's Public rate, that is, the default EPostage rate that the recipient Client has assigned to his Public Tier (2.5, p. 50). Of course in all this, if the applicable Tier is marked Prepaid, the sender pays nothing to send his Email to that Client.

2.8.2. Payment Source: 900Email shall determine which EPostage Source, if any, the sender is using. 900Email makes that determination by following the following sequence of inquiries (explained in more detail in the Searching for Money note below):
2.8.2.1. EStamp Presence: 900Email checks for the presence of an EStamp (2.7, p. 58);
2.8.2.2. Prepaid Tier: 900Email checks the recipient Client's Prepaid Tiers (2.6, p. 55) trying to locate the sender's Email ID or domain; and finally,
2.8.2.3. Corporate EPostage: (3.8, p. 99) 900Email checks to see if a Corporate EPostage account (funded perhaps his employer) identifies this sender (either by Domain or Email ID).
2.8.2.4. Customer EPostage: 900Email checks the sender's Customer EPostage account (identified by Email ID, 3.9.5, p. 101) for sufficient EPostage as defined by the Client's Tiered pricing for that sender.

Technical Note—Searching for Money: The bullets below each correspond to a validation step above. To follow the required validation sequence, 900Email scans every incoming Email message looking to validate a sufficient source of EPostage. 900Email:
looks first, for the presence of an EStamp. If an EStamp is found and if that EStamp is encoded for delivery to the recipient Client, then 900Email validates that EStamp. If the EStamp is encoded for delivery to another Client, it is returned with a message explaining that detail to the sender. If the EStamp is determined to be a forgery, 900Email does not continue searching for other forms of EPostage, but issues an Invalid EStamp Reply (8.5.7, p. 150). But if no EStamp is found, 900Email then:
looks second, for a Prepaid Tier to determine whether the recipient Client has listed the sender, or the sender's domain, on a Prepaid Tier (2.6, p. 55), in which case 900Email does not need to authenticate the sender (3.9.5.6, p. 105). 900Email always looks last at the Public Tier so that it first determines whether a sender is listed on any other Tier. Thus, if the Client has priced his Public Tier as Prepaid, 900Email shall deliver any message through as Prepaid except for messages from senders listed on Tiers priced otherwise. But if no such Tier match is found, 900Email then:
looks third, for a Corporate EPostage Account (3.8, p. 99) in the name of the sender's Domain. To charge EPostage to a Corporate EPostage Account, 900Email must first be able to authenticate the sender (3.9.5, p. 01). Most Corporate Clients will identify their members (e.g., employees) by their corporate Domain (such as SoAndSo at the Domain Cricket.com). If a Corporate Account lists some or all members of their Corporate EPostage Account by individual Email ID, then as regards collecting EPostage, those sub-accounts will appear identical to standard Customer EPostage Accounts. (The only difference between a standard Customer EPostage Account and a Corporate sub-account is that the Corporate Customer is responsible to pay the EPostage for all his sub-accounts.) But if no Corporate EPostage account is found, 900Email then:
looks fourth, for a Customer EPostage Account (3.2, p. 92) in the name of the sender's Email ID. To charge EPostage to a Customer's EPostage Account, 900Email must first be able to authenticate the sender (3.9.5, p. 101).

2.8.3. Charge the EStamp: 900Email shall debit the recipient Client's EPostage account (3.13, p. 107) by the EPostage Prepaid Rate amount.

Technical Note—Charging for the EStamp: What rate do we charge for EStamps? We charge the same as the EPostage Prepaid Rate. That is, 900Email shall charge the Client whatever the going rate is for receiving Prepaid email. Currently, the EPostage Prepaid Rate (2.6.2, p. 55) is the same as the EPostage Minimum Rate (2.2.1, p. 45). Thus, 900Email charges $0.05 to deliver Prepaid EPostage and EStamped messages.

Business Note—Negative EPostage: Paying for Prepaid EPostage involves tiny incremental amounts ($0.05 per message). Therefore, 900Email allows debiting the Client's EPostage account, even if that account balance is negative or is brought into a negative balance by this transaction, as long as that account is not marked as Inactive due to an unacceptable outstanding balance (3.13.2.4, p. 108). Funds owed to 900Email are dealt with separately (Client Collections, 2.17, p. 89), and a Client who has an ongoing debt in arrears.

2.8.4. Charging by Prepaid Tier: 900Email shall decrement (debit) the recipient Client's EPostage account by the EPostage Prepaid Rate amount (2.6.2, p. 55).

Technical Note—Pay the Prepaid: That is, we shall now charge the Client whatever the going rate is for receiving Prepaid Email, currently $0.05, by recording the debit in his EPostage Account and the credit to our Internal Accrued Revenue Account (8.2.5, p. 143). We do not need to wait for the Client to retrieve this Email before taking our service fee because he is paying to receive it (see the Early Paycheck note near the top of this section).

2.8.5. Collecting from Corporate EPostage: 900Email shall collect (by debiting) the Delivery Rate (2.8.1) from the Corporation's EPostage Account according to our Corporate Collections process (3.13.1, p. 107).

2.8.6. Collecting from Customer EPostage: 900Email shall collect (by debiting) the Delivery Rate from the Customer's EPostage Account according to our Customer Collections process (3.13, p. 107).

Technical Note—Only Collected: At this point, 900Email has not yet recorded its Service Fee but has only “validated” and “collected” the EPostage (ensuring its availability). We shall actually take payment, that is, record our Service Fee out of this collected amount, as soon as the recipient Retrieves the message (2.8.9). In the meantime, we have collected out of the sender's EPostage Account whatever amount the recipient Client has established to receive Email messages.

2.8.7. Deliver the Mail: If we have collected the appropriate EPostage, 900Email shall then deliver that Email message to that Client's inbox, otherwise:

2.8.8. Insufficient EPostage: If EPostage could not be collected by any means, then 900Email shall follow its Insufficient EPostage procedure (2.9, p. 72).

Business Note—Persistence: 900Email benefits financially by delivering valid Email messages to our Clients. Therefore, we are willing to expend extra resources to validate messages that might appear, on first take, to be invalid. Such efforts help to achieve the Usability requirement of Logical Robustness (1.6.11, p. 37). Also, the apparent intuition of the system might impress our Clients and keep them intrigued with the possibilities of 900Email.

2.8.9. Charge on Retrieve: If the Customer is paying for the email out of an EPostage Account, then 900Email shall record its Service Fee (out of the Internal Collected EPostage Account) when the Client Retrieves a message from the server.
Definition—Retrieve: When a Client accesses an Email message from his inbox, whether simply by displaying it on his screen, or by downloading it to his local disk storage.

Business Note—Point of Sale: Our point of sale is the actual moment when 900Email takes its Service Fee. We first collect the EPostage, then after the Client Retrieves the Email message, we pay the Client Portion, and then we accrue our own income, which concludes the sale. Charging on Retrieve may require us to add unique functionality to whatever Email server engine we utilize. That added functionality enables us to provide a high quality product to our Customer. We then can guarantee him that his message will be accessed by the Client account, or his money back! If we had taken our fee just for delivering the message into the Client's inbox, the recipient may have simply deleted that message without ever retrieving it, or he may have just left it sitting there to rot. And still, the Customer would have paid a fee expecting that his email had been accessed by the recipient. But by charging on Retrieve, we offer the Customer a better product. And we thereby give the Client an added financial incentive to access the Email message, since he will not get his Client Portion otherwise. And with this functionality, we can ascertain exactly when a Client account has accessed a message (either by displaying it on screen or by downloading it to a hard drive). Thus, if the Client never accesses the message, we will grant the sender a refund, helping the marketplace perceive our product as reliable.

2.8.9.1. Collect Once: 900Email shall only collect once, of course, for delivering an email, even if a Client retrieves that Email message from the server multiple times.

2.8.10. Foreign Currencies: 900Email shall support these foreign currency requirements:

2.8.10.1. Exchange Rate Timing: When a Customer sends email to a Client whose EPostage rate is set in a different currency, 900Email shall lookup and apply the foreign currency exchange rate at the moment of delivery into the recipient's inbox (rather than at the time of retrieval).

2.8.10.2. Exchange Burden: Whenever necessary to accommodate the exchange, the amount the Customer must pay will be rounded up (rather than the amount the Client receives being rounded down), so that the Customer pays the cost of exchange, and any rounding loss.

2.9. Insufficient EPostage

900Email shall support these Insufficient EPostage requirements:

2.9.1. Insufficiency Determination: 900Email shall determine that an incoming Email message has Insufficient EPostage when all attempts to validate EPostage (2.8, p. 65) prove futile.

2.9.2. Insufficient EPostage Reply: When an Incoming Email message has Insufficient EPostage, 900Email shall return it with an Automatic IEP Reply (8.5.4, p. 148), that is, an Insufficient EPostage Reply (either standard or customized).
Definition—Insufficient EPostage: An incoming Email message has this status when 900Email exhausts all possible sources of payment on behalf of the sender, Client Prepaid, Customer EPostage Account, and Automatic Purchase, while trying to cover the Client's delivery Rate.

2.9.3. Post Office Dumpster: 900Email shall throw into our Post Office Dumpster all Email messages undelivered because of Insufficient EPostage.
2.9.3.1. Business Rule—Dumpster Message Lifespan: Management shall be able to change the length of time in which junk mail rejected for Insufficient EPostage remains in the Post Office Dumpster. Initial value: 7 days.

2.9.3.2. Access: A Client, without incurring a fee, can pick through the Post Office Dumpster looking at discarded mail that had been sent to him, and can view:
2.9.3.2.1. ID: the sender's Email ID;
2.9.3.2.2. Date: the date the message was sent;
2.9.3.2.3. Time: the time the message was sent (without seconds); and,
2.9.3.2.4. Subject: the subject line.

2.9.3.3. It's Not Too Late: 900Email shall enable a Client to reclaim one of these discarded messages by clicking a “To Read, Pay $0.05 Postage Due” button.

Technical Note—Display Prepaid Rate: The $0.05 price listed above is the standard Prepaid Rate. The Post Office Dumpster interface will display whatever the current EPostage Prepaid Rate is, since our Client would effectively be paying for this service just as though he had the foresight to prepay for delivery of any message he reclaims.

2.9.3.4. Reclamation Fee: After a Client clicks on “To Read, Pay $0.05 Postage Due,” 900Email shall charge (3.13, p. 107) a Client our EPostage Prepaid Rate as the Reclamation Fee.

2.9.3.5. Deliver Message: After payment has been collected, 900Email shall deliver the formerly discarded message out of the Post Office Dumpster and into the Client's Inbox.

2.9.3.6. Display Reclamation Message: After a message is moved from the Dumpster to an Inbox, 900Email displays a message to the Client.
2.9.3.7. Business Rule—Dumpster Reclamation Message: Management shall be able to change the text of the Reclamation Message. Initial value: “The selected message has been moved to your inbox. Thank you for payment. -900Email.com”

2.9.3.8. Extended Dumpster Access: 900Email shall retain discarded Email messages in a Client's area of our Post Office Dumpster for longer than the default 7 days with a Premium Service (2.12.2, p. 79).

Technical Note—Looks Familiar: To a Client, picking through the Post Office Dumpster will look like he were viewing his own inbox. But instead of his inbox, he will be looking at Email messages sent to him but discarded by 900Email into our Post Office Dumpster for Insufficient EPostage. The Client will be able to reclaim those messages from this access point, but he will not be able to view them until he opens his Inbox. To keep our user interface clean, 900Email shall not enable the Client to view this message from the Dumpster Access webpage (or from the Desktop 900Email.exe Dumpster screen), but he can view these salvaged messages from his inbox.

2.9.3.9. Toss the Trash: 900Email shall enable a Client permanently to delete a message from the Dumpster by tossing it into the incinerator (bit bucket).

Technical Note—A Tidy Dumpster: A Client may be picking through a large number of messages in his Dumpster inbox and he may want to delete messages he knows he will not want so he can focus better on the remaining ones as he is deciding whether to pay to keep some of them or not. This feature will be helpful to Clients who extend the lifespan of their Dumpster messages through our Deluxe Dumpster premium service (2.12.2, p. 79).

2.10. Guaranteed Reply

900Email shall support these Guaranteed Reply requirements:

2.10.1. Guaranteed Replies: 900Email shall enable Clients to charge a different EPostage fee to Guarantee a Reply to an Email message.

Business Note—Money Back Guarantee: 900Email shall guarantee to a sender that the recipient shall reply to his Email message, or the Customer will get his money back! 900Email does not makes any guarantee whatsoever as to the quality of the Guaranteed Reply. However, the Client does pledge to give a non-automated, human-generated personal reply to the sender. The Guarantee means that a Customer gets his full EPostage Guaranteed Reply fee refunded. A Customer might spend $5 paying BillSmith@900Email.com for a Guaranteed Reply. But Bill has changed jobs and has stopped accessing his 900Email account. He had Retrieved that Email message, but did not Reply throughout the Guaranteed Reply Refund Period (2.10.9, p. 76, currently 1 month). Therefore, 900Email follows the same refund policies as with all un-accessed messages.

Example—Golf Great: Golf Great might set up his Public Tier to charge $20 to receive an Email message, and price his Guaranteed Reply on that Tier at $80. An new golf enthusiast might want Golf Great's opinion on which set of clubs to purchase for the courses he plays and his skill level, and so sends off an $80 Email. The next week, at the first hole his foursome buddies ask him why he bought that particular brand. “Well, Golf Great told me that since we usually play here at Great Golf Course, that these clubs are probably the best match between my skill level and the course requirements, especially where I need the most help, on the second nine.” Their response alone makes the EPostage cost worth it.

2.10.2. Syntax: 900Email shall enable a Customer to communicate his instructions through the following syntax:

2.10.2.1. Request Reply: A Customer requests a Guaranteed Reply by addressing an Email message not To: BigStar@900Email.com, but To: BigStar@reply.900Email.com.

2.10.2.2. Authorize High Payment: A Customer authorizes payment for an EPostage amount higher than his default upper limit with the syntax To: BigStar.1000@reply.900Email.com.

Business Note—Intentions: 900Email must be able to discern the Customer's intention, regarding whether or not he wants to pay to receive a Guaranteed Reply. 900Email shall debit his EPostage account to pay for a Guaranteed Reply only when he has actively so specified according to the above syntax. In 2.10.2.2, the syntax indicates that the Customer requests a Guaranteed Reply, and also, it authorizes payment of $1,000 out of his EPostage account to BigStar@900Email.com.

2.10.3. Guaranteed Reply by Tier: 900Email shall enable Clients to charge different Guaranteed Reply rates by Tiers (4.3.7, p. 116).

Technical Note—Tier by Tier: A Client can charge different rates for a Guaranteed Reply on each of his Custom Tiers and on his Public Tier. Also, he can simply not select a Guaranteed Reply rate on a Tier, and then 900Email would not offer that service for a sender's Email coming in via that Tier. Some Clients may only implement a Guaranteed Reply rate on a single Tier, say, the Public Tier, and other Clients may not use this feature at all, on any Tier.
Definition—Guaranteed Reply: 900Email assures the Customer that a Client has pledged to respond personally to any Email message for which the sender pays both its EPostage Rate and the “Guaranteed Reply Rate.” The recipient Client has selected this rate, and expectedly, most Clients will price this feature higher than their EPostage Rates. If the Client does not Reply to the sender within the Guaranteed Reply Refund Period of 1 month, then 900Email will refund to the Customer both his EPostage and the Guaranteed Reply Rate that he paid to send that message. And to help cover our costs for the refund event, we charge the Client as though he had given the sender Prepaid EPostage, that is, $0.05.

2.10.4. Guaranteed Reply Rate: 900Email shall determine the particular Guaranteed Reply Rate for a particular sender, based upon which Tier prices his Email message, whether a Custom Tier or the Public Tier.

Technical Note—Regional Conflicts: If a Client has listed a particular sender on more than one Tier, 900Email shall be unaware of that fact since it stops looking to match a sender with a Tier as soon as it finds the first match (2.5.8.1, p. 52). Thus, if a Client has priced a Guaranteed Reply at $1.00 on one Tier, and $500 on another, a sender identified by the membership lists on both Tiers will be charged the lower rate, since 900Email shall search the Tiers in ascending Guaranteed Reply rates when the sender indicates a request for a Guaranteed Reply. In most such instances, the Client will have wanted to charge the sender the lower amount. The Client would be responsible for charging the sender the lower rate, since he is the one who listed the sender on two Tiers. (See Tier Search Order in 2.5.8.1, p. 52, except that the Public Tier is processed last.)

2.10.5. Client Rate Prevails: If a sender indicates a willingness to pay two dollars for a Guaranteed Reply (by mailing to JohnSmith.2@Reply.900Email.com), but the Client requires more, say, $2.25 to Guarantee a Reply for that sender, 900Email shall return that message for Insufficient Guaranteed Reply EPostage.

Technical Note—Ignore Overage: In the reverse case, if a Client selects a $1 fee to Guarantee a Reply to a particular sender, and that sender indicates a willingness to pay $25 (JohnSmith.25@Reply.900Email.com), 900Email shall of course charge the Client's lower Reply fee.

Business Note—Special Delivery: We do not want to offer a feature whereby a sender could pay an extra fee for, say, Special Delivery, or Certified Email Delivery, because such a feature would tend to lower our standard delivery and reply services in the valuation of the marketplace. That is, since we are already promising that for a certain fee, an Email will be read, and even replied to, why should we offer a higher priced service to guarantee the same thing? That diminishes the value of our core service. On the other hand, we will offer another delivery service, a time-sensitive EPostage Rate, like overnight delivery (or Zap Mail), which guarantees a retrieve (or even a reply) in a certain amount of time, or your money back.

2.10.6. Guaranteed Reply Service Fee: 900Email shall calculate its charge for processing the Guaranteed Reply separately from the standard delivery Service Fee.
2.10.7. Business Rule—Guaranteed Reply Service Fee: Management shall be able to change the Guaranteed Reply Service Fee. Initial value: 50% of our standard Service Fee (which currently would be 4.5%).

2.10.8. Guaranteed Reply Refund Period: 900Email shall enable Clients to charge different Guaranteed Reply rates by Tiers.
2.10.9. Business Rule—Guaranteed Reply Refund Period: Management shall be able to change the Guaranteed Reply Refund Period. Initial value: 1 month.

2.10.10. Guaranteed Reply Refund Charge: 900Email shall charge a Client a Refund fee when he causes this refund event.

Business Note—Refund Fee Rationale: 900Email charges the Client who causes a refund just as though he had sent that Customer a Prepaid EStamp. We charge the Client this Refund Fee to discourage such behavior, to help cover our costs incurred by that event, and of course for our own financial benefit to pay ourselves for the delivery of that sender's Email message into the Client's inbox.
2.10.11. Business Rule—Guaranteed Reply Refund Fee: Management shall be able to change the Guaranteed Reply Refund Fee that we charge a Client for causing this refund event. Initial value: EPostage Prepaid Rate (currently $0.05).

2.10.12. Out of Cash: If the Client has Insufficient Funds in his EPostage Account to pay the Refund Fee, the Fee will still be processed:

2.10.12.1. Automatic Purchase: If the Client has signed up for EPostage Automatic Purchase (3.6, p. 97), the Refund Fee charge will trigger an Automatic Purchase (if monthly funds are still available) if that charge would otherwise bring the Client's balance negative.

2.10.12.2. Going Negative: If EPostage Automatic Purchase cannot be used to pay the Refund Fee, 900Email regardless shall debit his EPostage Account even if that brings the Client into a negative balance (or further increases an existing negative balance, 3.13.2.4, p. 108).
2.10.13. Business Rule—Guaranteed Reply Minimum Rate: Management shall be able to change the Minimum Rate, in percentage, for the Guaranteed Reply fee, which the Client shall charge his senders. Initial value: 100% (of the Client's EPostage Rate applicable to that sender).

Business Note—Minimum Concerns: Some Clients may want to charge no additional amount, but still offer a Guaranteed Reply to anyone emailing them. The above business rule gives us the flexibility to support that, if we so choose, or, to force Clients to charge more for a Guaranteed Reply than for standard EPostage. We do want our product itself to reinforce the general principle behind it, that of valuing a Client's time, attention, and response. There is no such thing as a free Email, nor a free reply. If we impose upon Clients the requirement that they charge at least 120% of the EPostage rate for a Guaranteed Reply, then since our EPostage Minimum Rate is $0.05, the lowest they will be able to charge for a reply will be 6¢.

2.10.14. All or Nothing: If a sender has requested a Guaranteed Reply, and that Customer has sufficient EPostage in his account to pay for delivery, but not to cover the cost of the Guaranteed Reply, then 900Email shall not even deliver that Email message. (See Automatic Replies, Guaranteed Reply, 8.5.18, p. 161.)

2.10.15. Client Portion Crediting: 900Email shall not credit the recipient's Client Portion to his EPostage Account until that recipient has replied to the Customer.

2.10.16. GR Service Fee Crediting: 900Email shall not record (take) our own Guaranteed Reply Service Fee until the Client has replied to our Customer.

Technical Note—Timing is Everything: In processing a Guaranteed Reply Email message, we do not credit any of the Client Portion until that Client replies to the sender. We credit neither the standard EPostage Fee that came with the Email, nor the additional Guaranteed Reply fee, both of which get credited at the same time, immediately after the Client replies. We also accrue our Guaranteed Reply Service Fee at the same time.

2.11. Corporate Client

900Email shall support these Corporate Client requirements:

2.11.1. Establish Account: 900Email shall enable corporations to sign up as Corporate Clients:
2.11.1.1. Online: through our Website (3.8, p. 99); and,
2.11.1.2. By Phone: by phoning 900Email Customer Service.

Technical Note—Corporate Customer: 900Email also allows users to establish a Corporate Customer Account (3.8, p. 99). EPostage issues are addressed in the Customer Features, Corporate Customer section (3.8, p. 99).

2.11.2. Sub-Accounts: 900Email shall support an unlimited number of sub-accounts contained within a Corporate Client Account.

2.11.3. Administrator: 900Email shall require a Corporate Client to establish an Administrator sub-account responsible for managing the Corporate sub-accounts.

2.11.4. Central Management: Sub-accounts shall behave just like typical Client accounts, except that 900Email shall enable the Corporate Client Administrator to manage those accounts centrally.

2.11.4.1. Compartmentalize: 900Email shall enable the Corporate Client Administrator to manage sub-accounts individually or by department (or any arbitrary subdivision of the corporation like division or subsidiary, etc.).

2.11.5. Administrator: 900Email identifies Clients (and Customers) as members of a corporate account by the unique domain name in the Email IDs or by the Corporate Client maintaining a list of employee Email IDs.

Technical Note—Corporate Account Flagging: 900Email uses the Corporate Client's membership (sub-accounts) lists to flag appropriate Client accounts as sub-accounts of the appropriate Corporate Client.

2.12. Premium Services

900Email shall support these Premium Services requirements:

Business Note—Levels, not Limits Philosophy: Rather than limit Client accounts regarding matters such as number of messages stored, and megabyte size of attachments, we will offer premium services so that Clients can purchase more storage, and increase various account limits. Regarding the free Client Accounts described throughout this document, we will implement Business Rules that will enable 900Email management to change the limit of messages stored per account, the size of attachments permitted, the number of messages sent daily, attachment size and the total storage limit per account. The philosophy of our service offerings is never to say, “No,” but, “Yes, that is an upgrade.” Thus, like the U.S. Post Office, we will offer Clients a Bulk Mail Permit to send out huge numbers of Email messages, but for a very small fee.

Unlike most other Email systems, 900Email gets paid for each and every message. Thus, even our free Email account limits shall support a larger message size as compared to the industry norms. For example, Microsoft's Hotmail limits message size to 1 MB for their free service and 1.5 MBs for their paid, premium service which costs $20 per year. AOL limits attachments to 16 MBs within the AOL system and to 2 MBs when sending to non-AOL Email accounts. AOL, which costs $23 per month, allows users theoretically to store 235 GBs (yes gigabytes) of Email attachments with each account. Per account, that's 7 screen names*(1,000 new msgs+550 old msgs+550 sent msgs)*16 MBs per msg=235 GBs. But AOL users can hardly take advantage of this great storage potential, because AOL deletes messages in as few as 3 days and at most, 29, and because of the difficulty of storing Emails on seven different screen names (sub-accounts). However, 900Email understands that the majority of email users may use as much storage as is easily available to them. 900Email management, with a minimum of Client awareness, will use our Business Rules to adjust account storage and usage limits over time as experience and economics dictate. Initially, 900Email will allow up to 1,000 messages per account, which can remain online for five months, with 20 MB attachments per message. This defines a theoretical 20 GB storage limit per account, but deletion policies, Client behavior, and limit adjustments will keep the actual average storage used per account far, far, far below this limit.
2.12.1. Business Rule: Megabyte Monthly Charge: Management shall be able to change the price charged to Clients monthly per megabyte (or any part thereof) of storage used above the limits provided freely with our standard 900Email accounts. Initial value: 0.48¢.

2.12.2. Deluxe Dumpster Service: 900Email shall enable a Client to increase the lifespan of a message in the Post Office Dumpster (2.9.3, p. 72).

Business Note—Lifespan and Cost of Living: A Client can extend the length of time that he will keep messages in his Post Office Dumpster by selecting any extended time period (in days, weeks, months, or years) and the maximum number of megabytes he is willing to pay for in monthly storage.

2.12.2.1. Increase Lifespan: 900Email shall enable a Client to increase to any limit the number of days that his messages remain in the Post Office Dumpster.

2.12.2.2. Client Storage Authorization: 900Email shall enable a Client to authorize, for his Deluxe Dumpster Service, a certain number of megabytes for which he is willing to pay our Monthly Megabyte Charge of 0.48¢.

Technical Note—The Janitor: For a Client with Deluxe Dumpster Service, 900Email shall delete his messages from the Dumpster based on a combination of three factors, the free storage automatically allotted to all of our Clients, the length of a particular message's stay, and the number of megabytes of storage in use by all the messages combined for that Client. As a standard feature, we give all Clients 7 days of unlimited Dumpster usage per message. If a Client elects to keep messages for 60 days, then 900Email shall incinerate any message remaining into its 61st day. Also, if a Client elects to pay monthly for up to 5 additional megabytes for this service (for messages older than 7 days), then as a Client's messages begin to exceed 5 megabytes in storage, 900Email shall automatically delete as many messages as is necessary to bring the total storage usage under the Client-specified limit, beginning with the oldest messages. However, 900Email shall NOT delete messages that are less than the standard Dumpster Message Lifespan of 7 days.

2.12.3. Premium Automatic Replies: 900Email shall support Premium Automatic Replies:

Business Note—Further Customization: 900Email requirements already enable a Client to customize the Automatic Replies (8.5.5, p. 150) we return to senders who have Insufficient EPostage on their messages. But a business opportunity exists in enabling them to customize further their replies based on criteria in the incoming message. For example, if certain keywords are found in the incoming message, such as lyrics, or resume, or birthday, or retirement, a reply customized for that criteria can be sent, helping our Clients provide more effective automated replies. So, for example, rather than charging a Service Fee of 9% to such a Client, if 9E charged 2% for this service, the fee charged against incoming Client EPostage would be 11%.

2.12.3.1. Intelligent IEP Replies: 900Email shall enable a Client to customize based on keywords the Automatic Replies (8.5.5, p. 150) we return to senders who have Insufficient EPostage on their messages.
2.12.3.2. Business Rule: Premium Replies Fee—Management shall be able to change the amount of the added percentage charged to the Client's Service Fee for enabling the Client to customize his automatic response to incoming emails with Insufficient EPostage based on keywords. Initial value: 1%.
   2.13. Typical Email Functions

900Email shall support typical Email functionality including the ability to send, receive, read, forward, reply to, download, and attach documents to Email messages, maintain address books, mailboxes, and retrieve recently deleted mail. For details, see the requirements listed at Desktop, 900Email.exe (1195) and Website, 900Email.com (4, p. 112).

2.14. Communicating with Client/Customer

2.14.1. Postage Required: 900Email shall not deliver an Email message to a Client without pre-payment of that account's postage rate, except for Mailer Daemon return notifications of incorrectly or insufficiently posted email, and for necessary 900Email communications to Clients for which 9E shall pay the minimum postage rate.

2.14.2. Mailer Daemons: 900Email shall allow valid Mailer Daemon messages free passage into the system.

Business Note—Mailer Daemons Treatment: Email system servers generate mailer daemon messages that inform Clients of outgoing Email messages that were not delivered to the intended party, perhaps due to an incorrect Email address or a server malfunction. World Wide Web mailer daemons never pay postage, as they are responding to Client or delivery errors. They enter our 900Email system by way of a de facto system-paid Prepaid EStamp. Reliably identifying mailer daemons will be non-trivial, but we shall do so by looking for standard format and features of mailer daemons.

Business Note—900Email Pays Too: What happens when 900Email, Inc. must communicate with one Client or with all of our Clients? 900Email cannot pay the Clients required postage, for some Clients shall charge hundreds or even thousands of dollars postage. So, there are three possibilities:
1) we never communicate with our Clients;
2) we pay our minimum postage rate to email a Client;
3) we email our Clients for free.

The first possibility is unworkable. The third undermines the validity of our corporate vision. The second possibility works best. However, we should not pay to email our Clients to inform them of their own errors (for example, from using an expired EStamp), for in this case, a Client could simply send thousands of erroneous messages, and thereby write his own check from 900Email. But for general communication, 900Email system software must override each account's specified postage rate and deliver mail from 900Email, Inc. at the Minimum EPostage rate.

2.14.3. Support@900Email.com: Our Clients and Customers must pay our EPostage Minimum Rate of 0.05¢ even to email Support@900Email.com (6.4, p. 121).

Business Note—Charging for Support: Charging people a small fee for Customer Support is not bad marketing. Rather, it is part of the discipline needed to change the way people communicate on the Internet. 900Email pays the minimum rate to email our own Clients, and our Clients pay the minimum rate to email us.

2.15. Client Payouts

900Email shall support these Client Payout requirements:

2.15.1. Client Payout Schedule: 900Email pays the Client Portion to our Clients either annually, quarterly, or monthly, depending upon the amounts owed to them.

Business Note—Retaining Revenue: The more frequently we deliver money to our Clients, the more appealing they may consider our 900Email service. Thus, when 900Email owes a Client at least $250, we pay him monthly; at least $25, we pay quarterly, and under $25 we pay annually.
2.15.2. Business Rule—Payout Monthly Cutoff Management shall be able to change the amount which triggers a monthly payout schedule for Clients. Initial value: $250 or more.
2.15.3. Business Rule—Payout Quarterly Cutoff: Management shall be able to change the amount which triggers a quarterly payout schedule for Clients. Initial value: $25 or more.

2.15.4. Annual Payout—900Email shall schedule payouts annually for all Clients who do not qualify for monthly or quarterly payouts because of their low Client Portion revenues.

2.15.5. Client Payout Dates: 900Email shall support these Client Payout Date requirements:

2.15.5.1. Annually: 900Email makes annual payments by the 15th business day of each January for the previous year.

2.15.5.2. Quarterly: 900Email makes quarterly payments by the 15th business day of April, July, October, and January for the quarter having just ended.

2.15.5.3. Monthly: 900Email makes monthly payments by the 15th business day of each month for the previous month.

2.15.6. Payout Currency: 900Email shall make the Client payout in the same supported currency that he has selected for his account.

2.15.7. Direct Deposit: 900Email makes an electronic deposit into a user's checking account (savings account, PayPal.com account, etc.).

2.15.8. Client Paid by Check: 900Email shall pay a Client his Client Portion by check for a $5 fee.
2.15.9. Business Rule—Check Fee: Management shall be able to change the check fee charged against an account for issuing a paper financial instrument as opposed to making an electronic funds transfer. Initial value: $5.

2.15.10. Rounding to the Penny: For rounding to the nearest penny requirements, see 2.3.14, p. 50.
2.15.11. Business Rule—Payout Minimum: Management shall be able to change the minimum amount paid out to a Client. Initial value: $0.

Business Note—Minimum: A minimum, say of $1 to $3 may be imposed for processing a Client payout. Funds under this amount may, perhaps, be retained in the Client EPostage account to be used as potential EPostage.
Definition—EPostage System: This software enables the continuous buying, consuming, and crediting of the electronic postage used to send 900Email messages.
Definition—Month-End System: This software enables 900Email to process accounts at the end of each calendar month in order to payout funds owed to our Clients.

2.15.12. Payout Calculation: Each month, the 900Email Month-End System shall calculate the funds due to be paid out per client, as of the moment of calculation, as generated from their Client Portion revenue.

2.15.12.1. Determine Cutoff 900Email shall determine the payout cutoff for that month (see Monthly and Quarterly Cutoffs, 2.15.2, p. 82ff.).

Technical Note—Cutoff Schedule: (See Payout Dates, 2.15.5, p. 82) On the first of day of:
January the cutoff amount for December processing is any sum owed above $0;
February the cutoff amount for January processing is any sum owed above $250;
March the cutoff amount for February processing is any sum owed above $250;
April the cutoff amount for March processing is any sum owed above $25;
May the cutoff amount for April processing is any sum owed above $250;
June the cutoff amount for May processing is any sum owed above $250;
July the cutoff amount for June processing is any sum owed above $25; August the cutoff amount for July processing is any sum owed above $250;
September the cutoff amount for August processing is any sum owed above $250;
October the cutoff amount for September processing is any sum owed above $25;
November the cutoff amount for October processing is any sum owed above $250;
December the cutoff amount for November processing is any sum owed above $250.

2.15.12.2. Determine Payout Amount: Per Client, the 900Email Month-End System shall calculate the amount to be paid to the Client based on the following factors:

2.15.12.2.1. Retain Purchased EPostage: 900Email shall not payout to a Client EPostage funds that he has purchased (whether manually or automatically).

2.15.12.2.2. Retain Minimum Balance: 900Email shall not payout to a Client funds that do not exceed the EPostage Minimum Balance (3.5, p. 97) which he has specified.

2.15.12.2.3. Funds Not Retained: 900Email shall payout to a Client only funds in excess of the combined total of his specified EPostage Minimum Balance plus the EPostage he has purchased but not consumed.

Formula—Payout Amount: Payout Amount=(Current EPostage Account Balance−(EPostage Minimum Balance+(Purchased EPostage−Consumed EPostage)) or zero, whichever is greater. If the Payout Amount is zero for a Client, 900Email makes no Payout to that Client in that cycle.

2.15.12.2.4. Payout Pointer: 900Email shall be able to distinguish between a Client's purchased EPostage and his Client Portion credits.

Technical Note—Payout Pointers: To accomplish the above requires keeping track of a Client's purchases and Client Portion credits. If a Client receives Client Portion credits of $50 and that $50 remains in his account above his specified minimum, 900Email should payout that $50. On the other hand, he may have purchased that $50 and is planning to use it to email a celebrity, and therefore would not want it returned to him. If he purchases and consumes $50 worth of EPostage, and has $14 remaining in his account over his specified Minimum Balance (3.5, p. 97), he should expect a payout of $14 in mid-January. So, 900Email must know whether funds above his Minimum Balance are purchased, or whether they are credited from Client Portion income. One way 900Email can do this is with a “pointer” in each account, which moves forward with a purchase of EPostage, and backward with each use of EPostage. The Client Payout amount will always then be the total funds above the pointer. The following note, copied here from EPostage Minimum Balance section, along with the material following it, will help explain these requirements: [Business Note—Minimum Balance Usage: A Customer may wish always to keep funds in his EPostage account to enhance the convenience of sending messages to 900Email Clients. By specifying a Minimum Balance Customers may avoid getting messages returned to them for Insufficient EPostage. For example, a Customer may specify a $20 minimum, and authorize the Automatic Purchase (3.6, p. 97) of up to $60 per month in EPostage, in $20 Increments (3.6.5, p. 98). When his account dips below $20, 900Email shall automatically purchase $20 worth of EPostage for him and deposit it into his account. If his EPostage account balance had been at $20 exactly, and he sends an email to a Client for $0.05, then his account balance will hit $19.95 and shall trigger the purchase of $20 in additional EPostage, giving him a new balance of $39.95.]

Thus, when 900Email calculates the payout, we cannot payout the entire Client EPostage balance, nor can we simply pay everything above the Client's EPostage Minimum. Rather, we must payout the funds above the Payout Pointer (or some similar indicator). The Payout Pointer will equal the sum of the Client's EPostage Minimum Balance and the amount of any purchases made (whether manual or automatic) minus EPostage consumed since those purchases. This logic should work even if the Client specifies no minimum balance. Then, the Payout Pointer will equal the amounts of all EPostage purchased and not yet consumed, not less than the Client's EPostage Minimum Balance.
Definition—Payout Amount: The dollar total which 900Email calculates to remit to a Client that consists of funds in excess of the combined total of his specified EPostage Minimum Balance plus the EPostage he has purchased but not consumed (consumed, that is, by way of sending emails, refunds, premium fees, storage purchases, etc.).

2.15.13. Issue Payouts: Monthly and automatically, 900Email shall pay to Clients, by electronic transfer, their due earnings according to the above requirements using the Controlled Transfer Tool (7.7.1, p. 134).

2.15.14. IRS 1099 Reporting: Annually, 900Email shall report to qualifying Clients, as required by federal law, their Payout earnings.

Business Note—Qualifying Clients: The Internal Revenue Service currently requires form 1099 reporting of non-employee compensation to those earning over $600, which will be a very small percent of our Client base.

2.16. Refunds

900Email shall support these Refund requirements:

Technical Note—Document Organization: 900Email pays refunds to Customers, not to Clients. Yet the Client's action (or inaction) triggers the refund process. Thus, these requirements appear in this Client Features section and are cross-referenced in the Customer Features, Refunds section (3.12, p. 107).
2.16.1. Business Rule—Refund Period: Management shall be able to change the length of time that must transpire before an un-accessed message is returned to the sender and the EPostage refunded to the Customer's EPostage Account. Initial value: 3 months.
Definition—Refund Period: The length of time during which a Client can retrieve (view or download) a message from his inbox and receive his Client Portion. If the Refund Period expires without the Client ever accessing a message, that message is returned to the sender and his EPostage refunded to the Customer's EPostage Account.

Business Note—Refund Period Factors: If the Refund Period expires, 900Email returns the message to the sender and refunds his postage.

2.16.2. Internal Refunds: When refunding EPostage, 900Email shall first attempt to record (credit) refunds to a Customer's (Internal) EPostage Account (8.2.3, p. 142).

Technical Note—Internal vs. External: Most refunds simply make journal entries changing the balances on our internal logical accounts (see System Accounts, 8.2, 138), recording a debit to our Internal Collected EPostage Account and recording a credit to the Customer's Internal EPostage Account. If the Customer has closed his EPostage Account, then 900Email will attempt to make an actual electronic funds transfer into the Customer's physical bank account.

2.16.3. External Refunds: If a Customer has closed his EPostage Account, then 900Email shall attempt to make an actual electronic funds transfer into the Customer's physical bank account.
2.16.4. Business Rule—Refund Fee: Management shall be able to change the Refund Fee. Initial value: EPostage Minimum Rate (currently $0.05).

Business Note—Refund Fee Justification: If a Client does not fulfill his obligation to read, in a timely manner, a message in his inbox, he causes a Refund Event. This requires 900Email to refund the Customer's EPostage, which involves expenditure of resources including money. Thus we charge the Refund Fee against a Client's EPostage account to help cover the cost incurred when he triggering the refund. A Client may cause a refund event in one of four ways:
by Deleting (intentionally or accidentally) an un-accessed Email message in his inbox;
by Not Accessing a particular Email message throughout the duration of the Refund Period;
by allowing his account to become Inactive through lack of use; and,
by Canceling his account while un-accessed messages remain in his inbox.

If the Client actively or passively causes a refund event, it is as though he had given the sender a No Postage Necessary EStamp (2.7.1, p. 59), since the Customer did successfully send an email through to a 900Email account.

2.16.5. Refund Timeout Event: When a Client does not access an email for a specified time period, 900Email refunds the EPostage on that message to the Customer who sent it.
Definition—Refund on Timeout: 900Email shall return a Customer's money to his EPostage Account whenever a Client has failed to retrieve a message from his inbox throughout the duration of the Refund Period.

2.16.6. Refund on Account Closure: 900Email shall refund the EPostage on all messages left un-accessed in a Client's account upon cancellation of that account.
Definition—Refund on Account Closure: 900Email shall return a Customer's money to his EPostage Account whenever a Client has failed to retrieve a message from his inbox throughout the duration of the Refund Period.

2.16.7. Refund by Request: 900Email shall allow a Client to request a refund be paid back into a sender's Internal EPostage Account for any message received.
Definition—Refund by Request: 900Email shall return a Customer's money to his EPostage Account whenever a Client has failed to retrieve a message from his inbox throughout the duration of the Refund Period.

2.16.8. Refund on Delete: If a Client deletes an Email message without viewing or downloading it, then 900Email refunds the EPostage amount to the Customer who sent that email.
Definition—Refund on Delete: A refund triggered by a Client's active deletion of a message from his inbox without having been retrieved.

Business Note—Handle With Care: Due to the Client's active role and probable intent in deleting an incoming email without having retrieved it, 900Email handles this type of refund differently than one caused by account inactivity or cancellation.

2.16.8.1. Refund on Delete Delay: 900Email sends refunds to Customers 24 hours after a Client has deleted his message.

Technical Note—Pending Refunds: A Client has 24 hours after deleting an email in which to resurrect that message from limbo and return it to his inbox. Deletion of a message that has been neither viewed nor downloaded triggers a refund scenario and appends an entry on the Pending Refunds queue. That Pending Refund Entry contains a date and time stamp and a pointer to the actual message in limbo, and each entry remains in the queue for 24 hours. Whenever a Client un-deletes a refundable message, 900Email strips the marker that was placed in the header, in the From field. But after 24 hours, if the Refund is still pending so that the entry still exists, 900Email deletes the Pending Refunds entry and continues the refund process by sending a “Refund on Delete” Reply to the Customer, returns his original message with any attachments, and refunds his EPostage.

2.16.8.1.1. “Refund on Delete” Fee: Whenever a Client deletes a never-retrieved message from his inbox, 900Email charges him the $0.05

2.16.8.2. Refund Transfer Failed: When 900Email cannot transfer the refund to the Customer, then 900Email shall notify the Customer of the situation asking him to update his financial information.

2.16.9. Pay the Refund: 900Email shall use its own Reliable Funds Transfer utility (8.4, p. 145) to pay the Refund.

2.17. Client Collections

Since all Clients are also Customers by definition (p. 25), 900Email shall deal with a Client who owes money (by accumulating Prepaid EPostage debt) in that Client's capacity as a Customer (3.13, p. 107), but with special treatment.

2.18. Inactive Client Account

900Email shall support these Inactive Client Account requirements (see also, Inactive Customer Account, 3.14, p. 109):

2.18.1. Incoming Messages Refused: If a Client account is marked Inactive (through non-payment of an outstanding bill, or by inactivity), 900Email shall return incoming messages as though the Inactive Client Account did not exist.

2.18.2. Talk to Us: When a Client logs in with his username and password to an Inactive Email account, 900Email shall allow that Client to receive and send Email messages only to and from Customer Service accounts at 900Email.com.

2.18.3. Inactive for Non-Payment: 900Email shall support these Inactive for Non-Payment (3.13.2.7.1, p. 109) requirements:

2.18.3.1. Payment Due Inbox: When a Client attempts to access an Email account that has been marked as Inactive for Non-Payment, 900Email shall redirect him to a Payment Due Inbox.

2.18.3.2. Payment Due Message: When a Client first accesses his Payment Due Inbox, he shall find a single automatic message there (see Automatic Replies, Payment Due Message, 8.5.15, p. 159):

Business Note—Special Inbox: Since the Client's account is Inactive, we want to prevent him from accessing his inbox to encourage him to bring his account current. So, while 900Email restricts such Clients from accessing their inboxes and other account features, we do allow them to access this special Payment Due Inbox.

2.18.4. Inactive by Timeout: 900Email shall support these Inactive by Timeout requirements:

2.18.4.1. Mark Inactive by Timeout: If a Client does not access his account for the duration of the Inactive Account Eligibility Client Period, 900Email shall deactivate his Email account by marking it as Inactive by Timeout.
2.18.5. Business Rule: Inactive Account Eligibility Client Period—Management shall be able to change the length of time that must transpire from the last use of an account until deeming that Client Account inactive. Initial value: 1 year.

2.18.5.1. To Reactivate Your Account: When a Client attempts to access an Email account which has been deactivated by being marked as Inactive by Timeout, 900Email shall redirect him to a Reactivate Your Account Inbox.

2.18.5.2. Reactivate Account Message: 900Email shall send an Email into the Client's Reactivate Your Account Inbox (8.5.16, p. 160).

2.18.6. Inactive Account Client Grace Period: 900Email shall support these Grace Period requirements:
2.18.6.1. Business Rule: Inactive Client Grace Period—Management shall be able to change the length of time that must transpire after a Client Account is marked as Inactive before 900Email shall close that account. Initial value: 1 year.

2.18.6.2. Grace Period Expires: When a Client does not reactivate an account for the duration of the Grace Period, then 900Email shall Close the Client Account (2.19.2, p. 90).

Business Note—Deactivate by Refund Activity?: Consider whether the above criteria is sufficient for marking a Client account as Inactive by Timeout, or should there also be a criteria related to Refund Activity, such as: Deactivate a Client Account if he causes only Refund Events in a three-month period, or, if he creates at least ten Refund Events and his Refund Events account for more than 90% of his received messages in a three-month period [this is to deter Clients from tarnishing 900Email's reputation as a reliable Email carrier, and also, because generally speaking, we want to keep the percent of refund events low.]

2.19. Close Client Account

2.19.1. Terminate Account: 900Email shall be able to terminate a Client's Email Account without necessarily affecting his EPostage Account.

2.19.2. System Closes Account: 900Email shall be able to close a Client's Email account when the system has determined that the Client has not reactivated an Inactive account within the Grace Period (2.18.6, p. 90).

2.19.3. Customer Service Closes Account: 900Email shall enable our own Customer Service personnel to close a Client's Email account (for violation of our corporate policies, for intervention on non-payment of an account, etc.)

2.19.4. Client Closes Account: A 900Email Client shall be able to close his own Email and EPostage accounts via the 900Email.com website (4.3.10, p. 117).

2.19.4.1. EPostage Account: 900Email shall ask the Client if he would like to close his EPostage Account also, or just his Client Email account.

2.19.4.1.1. Close EPostage Last: If the Client wants to Close his EPostage Account also, Close that account only after going through the rest of this Email Close Account process, since this Close Email Account process may generate last minute Client Portion funds to be credited into his EPostage Account.

2.19.4.2. Offer Him: If the Client's inbox has any un-accessed mail, 900Email shall offer him the opportunity to read any of his Inbox messages before it's too late.

2.19.4.2.1. Urge Him: Calculate the amount of Client Portion that remains un-credited to his EPostage Account, and if it is above zero, inform him of the available EPostage which can be credited to him, which EPostage has been collected already and is sitting and waiting only for him to view the Email messages.

2.19.4.3. Ask Him: 900Email shall offer a Client closing his account the chance to start an Instant Message session with ServiceRepNAME@900Email.com to give us the chance to find out why he is closing his account, and to determine if we can keep him as a Client.

2.19.4.4. Thank Him: 900Email shall thank the Client for the honor of serving him.

2.19.4.5. By Request Only: 900Email shall only trigger the Customer Close EPostage Account process (3.15, p. 110) if so requested by the Client (2.19.4.1, p. 91).

2.19.5. Refund Unrecorded EPostage: 900Email shall generate Refund Events for this 5 Closed Account (2.16.6, p. 88) to return EPostage to senders for any remaining un-retrieved messages in the Client's inbox.

2.19.6. Ignore EPostage Account: When closing a Client Email account, 900Email shall not close an EPostage Account unless directed otherwise by the Client (2.19.4).

3. Customer Features

900Email shall support these Customer requirements:

3.1. Becoming a Customer

900Email shall recognize a person as a Customer when he successfully signs up for a 900Email EPostage account.

3.1.1. Account Culture: 900Email shall support these Account Culture requirements:

3.1.1.1. Default Culture: 900Email shall default to using the culture (language and currency) currently displayed in the sign-up web page as by default or by the selection of the visitor.

3.1.1.2. Language Selection: 900Email shall enable a Customer to choose the language setting for his account from among our list of supported languages (1.6.6, p. 35).

3.1.1.3. Currency Selection: 900Email shall enable a Customer to choose the currency setting for his account from among our list of supported currencies (1.6.7, p. 36; 7.6.1.2, p. 133).

3.2. EPostage Account

3.2.1. EPostage Purchase: 900Email shall enable Customers to purchase EPostage.

Technical Note—EPostage Usage: Customers may use that electronic postage to send Email messages to our sender-pays email Clients. 900Email can automatically identify the sender by his Email ID as an EPostage account holder, and shall deduct the required EPostage and deliver the Customer's message to the recipient.

3.2.2. Currency Specific: 900Email shall support EPostage purchases in various currencies (1.6.7, p. 36; 7.6.1.2, p. 133):

3.2.2.1. Currency Supported: 900Email shall make EPostage purchases available to Customers in various supported foreign currencies (7.6.1.2, p. 133).

3.2.2.2. Not Commingled: 900Email shall not commingle supported currencies in the same physical EPostage account.

Technical Note—Conversion When Necessary: As with every supported currency, 900Email shall keep in a separate bank account EPostage purchased and used in German Marks. This enables German Customers and Clients to purchase EPostage, to spend EPostage on emails sent to one another, and to receive their Client Portion Payouts, all without requiring currency conversions. Whenever, however, a German Mark Customer emails a US Dollar Client, then the currency conversion will occur in real-time using timely conversion rates.

3.2.2.3. EPostage Conversion Rate: 900Email shall charge a Customer the appropriate EPostage rate as converted into the Client's selected currency.

3.2.2.4. Currency Unsupported: 900Email shall enable a Customer to purchase US Dollar EPostage (or EPostage in any of our supported currencies) with funds from any other foreign currency that are otherwise unsupported by 900Email, but which currency is electronically accepted by our financial institution, assuming that our bank will automatically convert foreign funds into US Dollars (or whatever supported currency applies) at the proper and timely conversion rate.

3.2.2.5. EPostage Purchased with Foreign Funds: When a Customer purchases EPostage with a foreign currency different from his selected account currency, then 900Email shall credit to his EPostage Account the actual conversion amount as resulted from the conversion/funds transfer transaction itself (8.4.12, p. 147), and not, of course, the amount as quantified in the purchasing currency.

Technical Note—Looks American To Me: EPostage purchased with foreign funds but transparently converted by our bank into US Dollars will function, for all purposes, the same as EPostage purchased with US Dollars. The same is true for EPostage funds of any supported currency, regardless of their source of pre-conversion origin. Thus, the Customer pays the conversion rate at the time of purchase, and 900Email does not concern itself thereafter with the origin of the purchasing currency. If someone has selected the Euro for his default currency, and on one occasion purchases EPostage with a U.S. Debit Card drawing funds from an American bank, the conversion occurs at the time of purchase and from then on, he has “Euro” EPostage in his account.

3.2.2.6. Cost of Conversion: The Customer sending an Email message to a Client bears the burden of paying for the currency exchange and for large differences in currency units.

Scenario—I Paid Too Much!: A Client, Jose@900Email.com, has an EPostage rate of 5 pesos. A Customer, Marshall@900Email.com, uses a currency whose smallest unit of measure is equal to 5,000 pesos. There is no way to subdivide Marshall's currency so that he can pay Jose's rate. In order to send a message to Jose, Marshall must pay 1,000 times more than Jose requests. The sender (Customer) must bear the cost when he sends a message to a Client using a highly inflated currency. Then the Client receives a higher Client Portion than he may have expected.

3.2.3. Internet Payment Services: 900Email shall enable Customers to use 3rd-party Internet Payment Services as a primary or secondary EPostage account.

Business Note—3r-Party EPostage: Upon successful negotiations with a 3rd-party Internet Payment Service, a Customer shall be able to specify use of his IPS account as a secondary EPostage account. Thus, when that Customer emails a Client, 900Email shall recognize his account as a IPS-enabled account, and shall debit his EPostage account, or, if funds there are insufficient, debit his IPS account in the amount of the postage due. Alternatively, he can specify his IPS account as his primary source for paying for his EPostage. In this case, his actual EPostage account becomes his secondary method of payment. A Customer establishes a IPS-enabled EPostage account either when he first opens his account, or afterward, whenever he authorizes 900Email to charge his IPS account for EPostage. Assuming successful negotiations, IPS management shall enable their Customers to sign up for a IPS EPostage feature that shall automatically create a record of that IPS Customer in our 900Email Customer database, giving him a 900Email EPostage account. To accommodate IPS's interest in protecting their own Customer base, we will not encourage these IPS-enabled Customers to access their EPostage funds from our 900Email.com website, but directly through their IPS accounts. Using this IPS feature in this way would effectively create a hidden EPostage Account for such a Customer. This hidden account will, of course, be flagged as a IPS-enabled account. Then, 900Email shall debit the Customer's IPS account for all EPostage charges. That hidden EPostage account is “visible” to the Customer when he logs into it, but he never needs to do so. His EPostage account uses the same Email ID that names his IPS account. If he logs into his EPostage account, 900Email recognizes the IPS-enabled Email ID, and confirms with the Customer that he has two methods for viewing and/or paying for EPostage, his IPS account, and his 900Email account. 900Email shall allow the Customer to specify which account is primary, and which is secondary. [If he plans to keep most of his EPostage money in one account or the other, listing them as primary and secondary shall save on system communications and processing resources by reducing the need to query a second time after finding insufficient funds in the first account checked.]

3.2.3.1. Internet Payment Service Refunds: Regardless of which account a Customer used to pay for delivery of a message, 900Email shall credit any refund due to the sender's primary account, whether his EPostage or IPS account.

3.3. Payment Methods

900Email shall enable a Customer to purchase EPostage with funds from all convenient payment sources:
3.3.1. Checking Account
3.3.2. Savings Account
3.3.3. Credit Card
3.3.4. Debit Card
3.3.5. PayPal Account: PayPal.com is the Internet's leading financial transaction service.
3.3.6. QuickCheckout Account: QuickCheckout is an Internet transaction service competing with PayPal backed by AOL, Sun, etc.
3.3.7. Etc: 900Email management shall continue to look for new methods of electronic funds transfer and payment.

3.3.8. Expiration Date: 900Email shall automatically request the new expiration date from a Customer when his current credit card expiration date is about to expire.
3.3.8.1. Business Rule—Credit Card Expiration Date Lead Time: 900Email management shall be able to change the lead time prior to a Customer's credit card expiration date by which we shall. Initial value: 21 days.

3.3.8.2. Ask for New Expiration Date: 900Email shall automatically email the Customer (8.5.14, p. 158) informing him of the approaching expiration, and ask him if he could provide us with an updated expiration number, or a brand new card number.

3.4. EPostage Purchase Fee

900Email shall be able to charge Customers an EPostage fee (although we may chose not to) for purchasing EPostage.
3.4.1. Business Rule—EPostage Purchase Fee Switch: Management shall be able to turn on or off a fee charged to Customers for purchasing EPostage. Initial value: On.
3.4.2. Business Rule—EPostage Purchase Fee Mode: Management shall be able to change whether the EPostage Fee will be charged by percent of purchase, or in dollars and cents. Initial value: Percent.
3.4.3. Business Rule—EPostage Purchase Fee Minimum: Management shall be able to change the EPostage Minimum Purchase Fee. Initial value: 0.10¢ (ten cents).

3.4.3.1. Minimum Effect: 900Email shall only apply the EPostage Minimum Fee rule when the EPostage Fee is charged by percentage.

Technical Note—Dollars & Cents: The 900Email Business Rules InterFace program (BRIEF.exe, 7.6.1.4, p. 133), shall allow entry and shall display dollar and cents amounts with the same format as shall our website and all other 900Email software (4.1.4, p. 112).
3.4.4. Business Rule—EPostage Purchase Fee Percent: Management shall be able to change the Percent of EPostage Purchase Fee specifying a percentage, from 0% up to 100%. Initial value: 2.5%.
3.4.5. Business Rule—EPostage Purchase Fee Amount: Management shall be able to change the Amount of EPostage Purchase Fee specifying an amount, from 0¢ on up. Initial value: 0¢.
3.4.6. Business Rule—EPostage Purchase Fee Maximum: Management shall be able to change the Maximum EPostage Fee per transaction. Initial value: $20.

3.4.6.1. Maximum Effect: 900Email shall only apply the EPostage Maximum Fee rule if we are charging an EPostage Fee by percentage.

Technical Note—De facto Limits: If we do not charge an EPostage purchase fee by percentage but by a dollar amount, then that amount simultaneously defines the de facto minimum and maximum fees. But if 900Email charges an EPostage Purchase Fee by percentage, like 2%, then the minimum and maximum EPostage fees become independent lower and upper limits.
3.4.7. Business Rule—EPostage Purchase Fee Waived Threshold: Management shall be able to change the purchase threshold above which an EPostage Fee would be waived. Initial value: $100.

Technical Note—Any purchase of EPostage for an amount above the EPostage Fee Waived Threshold would waive the EPostage Fee. Management shall specify the threshold with any whole-penny value from 0¢ (waiving all fees) on up to at least $1,000,000,000, which effectively turns off the feature. Setting this Threshold value at $100 waives the fee for purchases of $100 of EPostage and more. This waiver takes effect whether the EPostage Fee is charged by percentage or by amount. For an explanation of the large maximum threshold, see Maintainability, 1.7.4, p. 38.
3.4.8. Business Rule—EPostage Minimum Purchase:

Management shall be able to change or suspend the EPostage Minimum Purchase. Initial value: 0.25¢.

Technical Note—Buy At Least This Much: 900Email management shall be able to specify whether or not we will sell EPostage in amounts as low as 0.01¢ or whether we shall impose a higher minimum purchase.

3.5. EPostage Minimum Balance

900Email shall support the following Minimum Balance requirements:

3.5.1. Minimum Balance: 900Email shall enable a Customer to specify an EPostage Minimum Balance.

Business Note—Minimum Balance Usage: A Customer may wish always to keep funds in his EPostage account to enhance the convenience of sending messages to 900Email Clients. By specifying a Minimum Balance Customers may avoid getting messages returned to them for Insufficient EPostage. For example, a Customer may specify a $20 minimum, and authorize the Automatic Purchase (3.6, p. 97) of up to $60 per month in EPostage, in $20 Increments (3.6.5, p. 98). When his account dips below $20, 900Email shall automatically purchase $20 worth of EPostage for him and deposit it into his account. If his EPostage account balance had been at $20 exactly, and he sends an email to a Client for $0.05, then his account balance will hit $19.95 and shall trigger the purchase of $20 in additional EPostage, giving him a new balance of $39.95. In addition to purchasing EPostage, a Client can also maintain his Minimum Balance through Client Portion earnings that 900Email shall deposit into his EPostage account.

3.5.2. Minimum Maintenance: 900Email shall attempt to maintain the Minimum Balance requested by a Customer in his EPostage account by triggering the Automatic Purchases of EPostage (3.6, p. 97) whenever the account drops below its minimum setting.

3.6. EPostage Automatic Purchase

3.6.1. Automatic Purchases: When so authorized, 900Email shall be able to purchase EPostage automatically for a Customer according to the following requirements:

3.6.2. Automatic Purchase Maximum: 900Email shall enable a Customer to specify an EPostage Maximum monthly Automatic Purchase amount.

Business Note—Maximum Automatic Purchase: A Customer can limit the amount of EPostage that 900Email will automatically purchase per month. This EPostage shall be purchased if his EPostage Account balance runs below a Customer-defined minimum balance, or if he attempts to send email to another Client but has insufficient funds in his EPostage account. However, whatever the need, 900Email shall not, by Automatic Purchase, buy EPostage in excess of the authorized maximum monthly amount.

3.6.3. Below Minimum: When so configured, 900Email shall Automatically Purchase EPostage when that Customer's EPostage Account balance falls below the Minimum Balance he has defined (3.5, p. 97).

3.6.4. Insufficient EPostage: When so configured, 900Email shall Automatically Purchase EPostage when a Customer attempts to send email to another Client but has Insufficient Funds in his EPostage account.

Technical Note—Paying Automatically: The Customer pays for the automatic EPostage purchases by having authorized 900Email automatically to debit his checking account (credit card, etc., 3.3, p. 94).

3.6.5. Automatic Purchase Increments: 900Email shall enable a Customer to specify an Increment Amount which amount it shall use to make automatic purchases of EPostage.

Technical Note—Incrementalism: A Customer may specify a $20 minimum balance for his EPostage Account. He also may authorize the purchase of up to $60 per month in EPostage. If he then specifies those purchases to occur in increments of $20, then 900Email shall purchase EPostage for him automatically in blocks of $20 worth of EPostage. (These Increment Amounts will be equal to or exceed the EPostage Minimum Purchase, which currently is $0.25.)

3.7. Return Receipt

900Email shall support these Return Receipt requirements:

3.7.1. Return Receipt Feature: 900Email offers a premium feature with which a Customer can receive a return receipt email notifying him that a Client has accessed a particular Email message that had been sent by that Customer.

3.7.2. Return Receipt Contents: 900Email includes in the Return Receipt the Email ID of the recipient Client and the date and time at which that particular Email message was accessed.
3.7.3. Business Rule—Return Receipt Fee: Management shall be able to change the fee charged to send a Return Receipt Email message to a Customer. Initial value: the price of a U.S. Stamp (currently $0.37).

3.7.4. Return Receipt Syntax: 900Email shall enable a Customer to request a Return Receipt by addressing an Email message to, for example, BigStar@ReturnReceipt.900Email.com.

3.8. Corporate EPostage Account

900Email shall support these Corporate EPostage Account requirements:

3.8.1. Establish Corporate EPostage: 900Email shall enable any organization (or corporation) to sign up as corporate Customer in order to centralize their purchase of EPostage.

3.8.2. Unlimited Sub-Accounts: 900Email shall enable a Corporate EPostage Account administrator to manage an unlimited number of sub-accounts, each of which behaves just like a typical 900Email EPostage account, except that all those accounts draw their EPostage from this shared Corporate EPostage Account.

3.8.3. Grouping of Sub-Accounts: 900Email shall enable a Corporate EPostage Account administrator to manage his sub-accounts (one account for each sender) individually or by a grouping of sub-accounts (that is, by department or by any arbitrarily named subdivision of their organization, like division, subsidiary, workgroup, etc.).

3.8.4. Accounting by Group: 900Email shall enable Corporate Customers to establish separate accounts for purchasing EPostage per department (division, etc.)

3.8.5. Identifying Sub-Accounts By Domain: 900Email shall identify a sender as a member of a Corporate EPostage Account by the Domain ID in the senders Email ID.

3.8.6. Identifying Sub-Accounts By Email ID: Alternatively, 900Email shall identify a sender as a member of a Corporate EPostage Account by his unique Email ID that the Corporate EPostage Account administrator has listed in their membership list.

Example—Sub-Account By Email ID: If JD & Associates established a Corporate EPostage Account and listed a dozen different Email IDs as members of their corporate account, then 900Email would automatically debit that account to pay for email deliveries from senders listed as members on that account (JackConsultant@aol.com, JillConsultant@hotmail.com, etc.).

3.9. Safeguards

900Email shall support these Safeguard requirements:

Business Note—Expectations: These Safeguards protect Customers from paying more than they expect when sending an Email message to a Client, and they help to protect an EPostage account from unauthorized funds transfer.

3.9.1. Automatic Charge Limit: 900Email shall enable a Customer to set a default maximum rate for his account, which rate he is willing to have debited from his EPostage Account automatically in order to send an Email message to a Client.
3.9.2. Business Rule—Suggested Automatic Charge Limit: Management shall be able to change the Suggested Automatic Charge Limit for EPostage that 900Email displays when a Customer is setting that value. Initial value: 0.50¢.

3.9.3. High Postage Override: 900Email shall enable a Customer to override the default maximum rate that his account is set to pay.

3.9.3.1. Override Syntax: A 900Email Customer shall provide high postage override authority for an individual message by specifying ProfessionalBoxer.200@900Email.com.

Business Note—Pitney Bowes: This feature mimics the safeguard that Pitney Bowes has built into their postage meter machines. When applying a high postage amount to an envelope, Pitney Bowes first requires the user to approve the higher-than-normal postage amount. In the above example, the Customer authorizes payment of up to $200.00 to deliver this particular Email message to the recipient Client.

3.9.3.2. Override Auto Reply: If a 900Email Customer sends a message to a Client who requires more EPostage than the Client has authorized, 900Email shall send an Automated Reply to the Customer requesting authorization to pay the higher amount.

3.9.4. EPostage Rate Request: 900Email shall support these Rate Request requirements for a sender to query our system to find out the current EPostage rates for one or more of our Clients:

3.9.4.1. Rate Request Address: 900Email shall enable a sender to email RateRequest@900Email.com for current EPostage Rates for particular Clients.

3.9.4.2. Rate for Whom: 900Email shall enable a sender to find out the current EPostage Rate for a particular Client ID or IDs (e.g., FormerPresident@900Email.com, FormerFirstLady@900Email.com) as listed in the subject line or body of the email.

3.9.4.3. Rate Request Response: 900Email shall respond with an Automated Reply (8.5.17, p. 161) for the selected Clients listing the current:
3.9.4.3.1. EPostage Rate;
3.9.4.3.2. Guaranteed Reply Rate: if one applies to the requester, via a Priced Tier or the Public Tier.

Technical Note—Based on Tiers: Since Clients can charge different rates to different Email IDs and domains (see Tiered EPostage, 2.5, p. 50). Therefore, 900Email shall return the rate applicable to the particular sender. So, if a Client has a $0.05 Family Tier that lists MomCallahan@aol.com, then if MomCallahan is the sender, she will receive back the rate of $0.05. If that same Tier has a Guaranteed Reply Rate of 0.50¢, she will also receive that information, while an unknown sender must pay the 0.50¢ rate of the Public Tier and a $5 Guaranteed Reply Rate.

3.9.4.4. Request Syntax: 900Email shall support requests emailed to RateRequest@900Email.com that list one or more comma-delimited 900Email-supported Email IDs in the Subject and/or Body of the message.

3.9.4.5. Syntax Violation: As soon as parsing of the comma-delimited list of 900Email IDs encounters anything other than a bona fide Email ID, 900Email stops processing the request and returns any rates it may have already looked up.

3.9.4.6. Hacker Attack: 900Email shall trigger an alarm for the apparent over-use of this feature by a hacker attempting a Denial-Of-Service (DOS) attack.

3.9.4.7. Currency Conversion: If the requester is a Customer or Client, 900Email shall respond to the Rate Request by converting the Rates into the currency selected (3.1.1.3, p. 92) by that requester based on up-to-the-minute currency conversion rates.

Business Note—Excess Postage: Imagine that a Customer has purchased $30 of EPostage only to send a message to a celebrity-priced Client. However, that EPostage Rate is an out-of-date rate since that Client long ago had lowered his EPostage rate to $9.95 but forgot to update his own homepage to that effect. Or, perhaps the Customer has not recently Requested the Rate required to send an Email message to that Client. This Customer will find out about his unexpectedly high EPostage account balance when he receives his regularly scheduled Customer Statement (3.10, p. 106).

3.9.5. Sender Authentication: 900Email shall support these requirements to Authenticate the Sender:

Technical Note—Prevent Hacker Theft: 900Email shall prevent EPostage theft by imposters who use a forgery in an Email's FROM field to debit another Customer's EPostage account. A hacker may attempt to steal money out of an EPostage Account by sending himself an incoming message from a wealthy account by forging the FROM field. For example, JohnHacker@SomeISP.com realizes that WealthyExec@SomeISP.com might maintain a large EPostage balance since he sends messages to Celebrity Clients at 900Email.com. So, the crook opens an account at JohnHacker@900Email.com and prices his Public Tier at $1,000. He then uses Microsoft Outlook to send himself Email messages, but rather sending them using his old JohnHacker@SomeISP.com, he changes the FROM field and sends them from WealthyExec@SomeISP.com. If 900Email did not bother to authenticate senders, then John Hacker could steal funds from WealthyExec at a rate of $1,000 per Email by using this method, until he wiped out his victim's account. JohnHacker@900Email.com could then cash out his EPostage account and abscond with the stolen funds. Or, the hacker might carefully time his theft by sending his emails minutes before 900Email runs its monthly Payout report. If not somehow alerted, moments later we might automatically transfer his stolen funds electronically into an ill-gotten bank account under his control. The thief then cashes out his account at 8:00 a.m. the next business day, and has converted WealthyExec's money into cash (which money our Customer might try to recover from us!). Thus, 900Email must be able to authenticate senders and/or validate EStamps with a high degree of certainty.

Internet security options improve over time. The free world is vulnerable to crime and terror, and Internet protocols provide huge opportunity for criminals to impersonate the FROM field in Email messages. Improvements in security technology, increased accessibility, acceptance and use of security measures eventually may change the nature of web communications. But for now, 900Email faces the serious challenge of how to authenticate senders over the open and vulnerable Internet. With our first release, we will use a combination of features as follows, from most onerous (but easily implemented), to least difficult to use (but hard to impose upon Customers):
1. Auto-reply for Verification
2. Authentication EStamp
3. 900Email.com Send Email Page
4. 900Email Digital ID Certificates
5. 3rd-Party (Verisign, Thawte, etc.) Digital ID Certificate

Other security options are identified in a technical note below, Alternative Security, and may become viable for various subsets of our Customer base.

3.9.5.1. Auto-Reply for Verification: If an incoming Email is not authenticated, 900Email shall send an automated reply to the Customer for verification of his identify.

3.9.5.1.1. Click Verification: If a Customer receives an Auto-Reply for Verification Email message, 900Email shall enable him to CLICK on an HTML hyperlink to go to a 900Email.com website which action verifies the Customer's intent to spend EPostage to deliver his message.

3.9.5.1.1.1. Not HTML Enabled: If a Customer's Email account is not HTML-enabled, he shall still be able to use the Verification hyperlink by copying the text of that message out of the Auto-Reply email and pasting it into his browser's URL field and clicking ENTER.

3.9.5.1.2. Reply Verification: Alternatively, if a Customer receives an Auto-Reply for Verification Email message, 900Email shall enable him to REPLY to that message, which action verifies the Customer's intent to spend EPostage to deliver his message.

3.9.5.1.3. Verification Time Out: If the Customer does not respond to the Auto-Reply Verification within a specified period of time, 900Email shall refuse to deliver the Email message.
3.9.5.1.4. Business Rule: Automatic Reply for Verification Time-Out Period—Management shall be able to change the length of time that must transpire before 900Email will no longer accept an Auto-Reply for Verification response. Initial value: 1 day.

3.9.5.1.5. No Verification Action: If 900Email does not receive a verification within the Verification Time-Out Period, 900Email shall automatically return the Customer's Email message to him with an explanation.

3.9.5.1.6. Reverse DNS Lookup: To add a layer of security to our Auto-Reply for Verification, prior to sending the Auto-Reply for Verification, 900Email shall first make a Domain Name Service call to verify the origin of such an incoming Email message.

Technical Note—Not Foolproof: A Reverse DNS Lookup enables 900Email to compare the IP address of the domain from which the incoming Email purports to originate from, with the IP address coded into the envelope of that incoming message. When the IP address for the actual sending server does not match the IP address of the Domain Name in the FROM field, 900Email shall identify that Email message as invalid, and refuse to deliver that message, and it shall alert our internal security personnel of the possible attempted theft. However, a hacker could alter the IP addresses in the From field, and thus thwart this security effort. However, while this will not catch the sophisticated hacker, this may catch less knowledgeable would-be EPostage thieves.

3.9.5.1.7. Customer Notification: If we find a counterfeit FROM field via a Reverse DNS Lookup, 900Email shall notify our Customer that we have thwarted a hacker who was attempting to steal the Customer's EPostage.

Technical Note—Can't Warn Hacker: We will not be able to send a warning email to the hacker, since we will not know his email ID. We might know his domain IP address, but that does not provide us with enough address information to send him an Email message.

3.9.5.1.8. DNS Alarm Report: If we find a counterfeit FROM field via a Reverse DNS Lookup, 900Email shall report that circumstance to the appropriate Operations personnel (see 7.5.10, p. 132).

3.9.5.2. Authentication EStamp: 900Email shall accept a valid EStamp Type 4 (2.7.4, p. 63) as authentication.

3.9.5.2.1. Reverse DNS Lookup: To enhance the security provided by our Authentication EStamp, 900Email shall also make a Domain Name Service call to verify the origin of incoming Email messages.

3.9.5.2.2. Customer Notification: If we find a counterfeit FROM field via a Reverse DNS Lookup, 900Email shall notify our Customer that we have thwarted a hacker who was attempting to steal the Customer's EPostage.

3.9.5.2.3. DNS Alarm Report: If we find a counterfeit FROM field via a Reverse DNS Lookup, 900Email shall report that circumstance to the appropriate Operations personnel (see 7.5.10, p. 132).

3.9.5.3. 900Email.com Send Email Page: 900Email shall enable Customers to send Email messages from our 900Email.com/SendEmail.htm web page.

3.9.5.3.1. Authenticate Customer: 900Email shall authenticate a Customer by requiring that he submit his username and password sometime during his online session at our website in order for him to send an Email message for which we shall apply EPostage out of his personal EPostage Account.

3.9.5.3.2. Encourage Use: Senders who have emailed a message with Insufficient EPostage shall be directed by 900Email to this Send Email web page.

3.9.5.4. 900Email Digital ID Certificates: 900Email shall become a Certificate Authority and issue our own Digital ID Certificates to our Customers.

3.9.5.4.1. From Website: 900Email.com shall enable a Customer to obtain a 900Email-issued Digital ID, at sign-up or anytime thereafter.

3.9.5.4.2. From Plug-In: The 900Email MS Outlook and Outlook Express plug-in shall enable a Customer to obtain a 900Email-issued Digital ID.

3.9.5.4.2.1. Automatic Installation: After generating the Customer's Digital ID, the 900Email Outlook plug-in shall automatically install it.

3.9.5.4.2.2. Linux Support: 900Email shall eventually port our MS Outlook Plug-in to run on the Linux operating system.

3.9.5.4.2.3. Apple Support: 900Email shall eventually port our MS Outlook Plug-in to run on the Apple operating systems.

3.9.5.4.2.4. Windows Non-Outlook Support: 900Email shall eventually port our MS Outlook Plug-in to run with other popular non-Outlook client software that runs on MS Windows (such as PocoMail).

3.9.5.4.3. Authenticate Customer: 900Email shall authenticate any Customer's incoming message when it has a valid 900Email-issued Digital ID attached.

3.9.5.4.4. Invalid Certificate: If we find an invalid certificate, 900Email shall refuse to deliver the Email message to which it was attached.

3.9.5.4.5. Invalid Certificate Notice: If we find an invalid certificate, 900Email shall notify the sender that the Digital ID attached to his email is invalid.

3.9.5.5. 3rd-Party Digital ID Certificates: 900Email shall authenticate any Customer's incoming Email message when it has a valid 3rd-party Digital ID attached.

3.9.5.5.1. Same As Above: Whether a Customer uses a 900Email-issued Certificate or a 3rd-party certificate, 900Email shall function the same.

3.10. Account Statements

900Email shall support these Account Statement requirements:

On a quarterly basis, 900Email shall email Customer Statements (or shall make them available on the Customer's My EPostage web page). These statements will indicate current account balance, and provide a link to a 900Email.com web page showing the recent history of the Customer's account.

3.11. Multiple Addressees

900Email shall support the following requirements:

3.11.1. Insufficient Postage for All: If a Customer sends a single Email message to multiple addressees and if an insufficient EPostage balance exists in his account to deliver that message to all of the intended recipients, then 900Email shall deliver the message to as many recipients as it can based upon the available balance.

3.11.2. Return to Sender: 900Email shall return a copy of the message to the Customer with a list of the addressees who did not receive the message due to insufficient EPostage, along with an explanation.

3.12. Refunds

In addition to the requirements listed in the Client Features, Refunds section (2.16, p. 86), 900Email shall support the Refund requirements below:

3.12.1. Requested Refund: 900Email shall enable a Customer to request and receive a refund of some or all of the EPostage funds which he has purchased, which were not consumed and are still residing in his EPostage account.
3.12.2. Business Rule—Requested Refund Fee: Management shall be able to change the Requested Refund Fee. Initial value: $1.

3.12.3. Early Payout: 900Email shall charge a fee to a Customer who requests an early payout of some or all of the Client Portion funds he has earned which are residing in his EPostage account.
3.12.4. Business Rule—Early Payout Fee: Management shall be able to change the Early Payout Fee. Initial value: $5.
   3.13. Collections

When a Customer owes us money, 900Email shall support these Collection requirements:

Technical Note—Collections Overview: 900Email will not give credit to a sender to cover the EPostage he needs to deliver a message. We will not allow him to charge for incoming EPostage if that charge creates a negative Customer balance. EPostage paid to deliver a message to a Client must leave the Customer's EPostage Account balance greater than or equal to zero. However, we will give credit of up to two dollars to cover a Client's Prepaid EPostage and Customer and Client Fees. Thus, a Client's mail account can accept incoming Prepaid emails even if he has a negative EPostage balance, down to minus two dollars (−$2).

Of course, when the Customer has a sufficient EPostage Account balance to cover any charge, 900Email shall simply debit his account. If the Customer has signed up for Automatic Purchase (3.6, p. 97) and his EPostage balance is insufficient to pay the EPostage due on a message he has sent, then 900Email shall attempt to buy for him the EPostage needed to deliver that message.

3.13.1. Corporate Collection: To collect on a Corporate EPostage Account, follow the Customer Collections process just below (3.13.2).

3.13.2. Customer Collection: To collect on a Customer EPostage Account, 900Email shall support these collection requirements:

3.13.2.1. Sufficient On Hand Funds: If the Customer has sufficient EPostage on account to cover a particular charge, 900Email shall debit his account by that amount, otherwise:

3.13.2.2. If Automatic Purchase is Enabled: If the Customer has authorized EPostage Automatic Purchase (3.6, p. 97), then if: (the amount he owes)=(his current EPostage balance)+(the remaining available Automatic Purchase funds for the month), then 900Email shall charge his bank account (credit card, etc., 3.3, p. 94) according to the following:

3.13.2.2.1. Purchase Incremental Amount: If (the amount he owes)=(his current EPostage balance)+(his established Incremental Amount) then 900Email shall execute an Automatic Purchase of the Incremental amount he established (3.6.5, p. 98), otherwise:

3.13.2.2.2. Purchase Incremental Amount*x: If (the amount he owes)=(his current EPostage balance)+(some multiple of his established Incremental Amount) then 900Email shall execute an Automatic Purchase of the smallest multiple of his Incremental amount (as available) that will cover his debt, otherwise:

3.13.2.2.3. Purchase Maximum Available Amount: 900Email shall execute an Automatic Purchase of the total available funds up to his monthly maximum, otherwise:

3.13.2.3. If Sending an Email: If this request for payment regards EPostage to deliver an Email message which the Customer is sending to a Client, and the Customer has Insufficient EPostage in his account and there are no Automatic Purchase funds available, then 900Email shall send an Insufficient EPostage Reply (8.5.4, p. 148) to our Customer, otherwise (the charge is for a fee or Prepaid EPostage):

3.13.2.4. Extending Non-qualifying Credit: If the amount owed will not bring the Customer's balance to more than two dollars in the hole, then without any other consideration, 900Email shall extend credit to the Customer (to pay a Fee or for Prepaid EPostage) by decrementing his EPostage Account, even though he is now in debt to 900Email, Inc., otherwise (this debit would bring him to more than minus two dollars):

3.13.2.5. Extending Qualified Credit: If the amount owed will not bring the Customer's balance to more than ten dollars in the hole, and if the Customer has generated more than two dollars of accrued Service Fee in the last three months, then 900Email shall extend credit to the Customer (to pay a Fee or for Prepaid EPostage) by decrementing his EPostage Account, otherwise:

3.13.2.6. Extending Qualified Credit: If the amount owed will not bring the Customer's balance to more than twenty dollars in the hole, and if the Customer has generated more than twenty dollars of accrued Service Fee in the last three months, then 900Email shall extend credit to the Customer (to pay a Fee or for Prepaid EPostage) by decrementing his EPostage Account, otherwise:

3.13.2.7. Insufficient EPostage: 900Email shall refuse to extend credit for the Prepaid EPostage or the Fee so that the Customer will not be able to use our service until he brings his account current.

3.13.2.7.1. Mark Inactive for Non-Payment: If this Customer has a Client Email Account, 900Email shall mark that account as Inactive due to non-payment (2.18.3, p. 89).

Technical Note—Only Clients Get Negative: By our business logic, the EPostage Account of someone who is exclusively a Customer (and not a Client) cannot go negative, since we do not extend credit to pay for standard EPostage, Guaranteed Replies, and other such retail services. However, we do extend some credit for fees and “wholesale” rates (like EStamps) that we charge to our own Clients' EPostage Accounts. Thus, a Client (who is also a Customer by default, p. 25) may develop a negative EPostage Account balance through use of Prepaid EPostage Tiers, EStamps, and the payment of various 900Email fees.

3.13.3. Outstanding Debt: 900Email shall not attempt to collect on a negative EPostage balance of down to minus two dollars except by:

3.13.3.1. Message: 900Email shall displaying a “Balance Due” message on the Customer's account webpage (4.4.3, p. 117); and,

3.13.3.2. Amount: 900Email shall indicate the Balance Due amount in the Customer's quarterly or annual statement (3.10106).

Business Note—Debt Scenarios: Other than the small credit extended to those Customers and Clients who are in good standing, 900Email should be able to operate without the need to manage a significant Accounts Receivable.

3.14. Inactive Customer Account

900Email shall support these Inactive Customer Account requirements (see also, Inactive Client Account, 2.18, p. 89):
3.14.1. Business Rule: Inactive Account Eligibility Customer Period—Management shall be able to change the length of time that must transpire from the last use of an account until deeming that Customer Account inactive. Initial value: 2 years.

3.14.2. Mark as Inactive: 900Email shall put a Customer's Account in Inactive status if he has no activity for the duration of the Inactive Customer Account Period (3.14.1).

3.14.3. Notify Customer: Send an Email message to the Customer to inform him of the Inactive status of his EPostage Account.

3.14.4. If Customer Logs In: 900Email shall display an alert to a Customer that his inactivity had led to his account being marked as Inactive.

3.14.5. Reactivate: When a Customer logs in while his account is Inactive, 900Email shall automatically reactivate his account.

3.14.6. Inactive Account Customer Grace Period: 900Email shall support these Grace Period requirements:
3.14.6.1. Business Rule: Inactive Customer Grace Period—Management shall be able to change the length of time that must transpire after a Customer Account is marked as Inactive before 900Email shall close that account. Initial value: 6 months.

3.14.6.2. Grace Period Expires: When a Customer does not reactivate an account for the duration of the Grace Period, then 900Email shall Close the Customer Account (3.15, p. 110).

3.14.7. Attempt to Refund EPostage Balance: 900Email shall attempt to Refund the remaining balance in an Inactive Customer Account.

3.14.8. Finally: If and when the Refund due on an Inactive Account is paid, then 900Email shall Close (3.15.3, p. 110) the Customer's Internal EPostage Account (8.2.3, p. 142).

3.15. Close Customer Account

3.15.1. Close Account Feature: 900Email shall support Closing a Customer account:
3.15.1.1. by Customer Request: by the Customer (4.4.5, p. 118);
3.15.1.2. by the System: by the 900Email system (3.14.6.2, p. 110); or,
3.15.1.3. by Customer Service: by Customer Service personnel (6.3.2, p. 121).

3.15.2. Close Out Payment: 900Email shall pay (by use of its own Reliable Funds Transfer utility, 8.4, p. 145) to the Customer's physical bank account the remaining balance of his EPostage Account (without charging an Early Payout Fee, 3.12.3, p. 107) when his account is being closed.

3.15.3. Purge Account: If we have successfully transferred his entire EPostage Account balance to the Customer, then 900Email shall delete all current records related to the Closed Account.

Business Note—Archives: Even though current records are deleted, historical records of that account will exist in both recent backups and older system archives. Thus, that Customer's account history will be available for audit and other legal and valid business purposes.

3.15.4. Undeliverable Funds: If the Payout electronic transfer to the Customer's bank account fails, then 900Email shall transfer any remaining funds in his Internal EPostage Account into our Undeliverable Funds Account (8.2.7, p. 144).

3.15.4.1. Mark as Dormant: If we cannot return the Customer's funds to his actual bank account, then mark his account Dormant; and, if he ever logs in:
3.15.4.1.1. Display Customer Service Phone Number: Display “We owe you $n.nn! Please call Customer Service now at 1-800-900Email.”
3.15.4.1.2. IM Session: Automatically put the Customer in an Instant Message session connected to one of our Customer Service Representatives.

3.15.4.2. If Customer Found: When the Customer logs on, 900Email shall offer the Customer the opportunity to:
3.15.4.2.1. Close Out: Close his Account and receive his Close Out payment; or,
3.15.4.2.2. Reopen: Reopen his Account.

3.15.4.3. If Customer Chooses: If the Customer makes a selection, then based on his choice, 900Email shall either:
3.15.4.3.1. Close Account: Close Customer's Account.
3.15.4.3.2. Reopen Account: Mark the Customer's EPostage Account as Active.
   4. Website: 900Email.com
   4.1. Website General Requirements

900Email shall support these General Website requirements:

4.1.1. Browsers: The 900Email website can be viewed and utilized via industry-standard browsers. (For details, see General Requirements, Interconnectivity, Web Browsers, p. 41.)

4.1.2. Website Performance: 900Email requires optimum performance from its websites. (For details, see General Requirements, Performance, Website Performance, p. 41.)

Delete: The 900Email website shall perform with optimal efficiency providing comparable response time to the best industry websites.

4.1.3. Conventions: All HTML pages will end in extension .htm (not .html).

4.1.4. Currency Presentation: Until 900Email supports use of Foreign Currency (1.6.7, p. 36), all EPostage rates must be shown in U.S. Currency (1.6.8, p. 36), on all our web pages (as well as in our desktop 900Email.exe software and all system software including our Business Rules Interface program).

4.1.4.1. Displaying 1-99¢: All 900Email websites and software programs display postage rates below one dollar using a dollar sign ($), a zero, a decimal point, and a two-digit representation of the number of cents.

Examples: $0.05, $0.25, $0.50, $0.75, and $0.99.

4.1.4.2. Displaying 1-10 Dollars: All amounts from one dollar to ten dollars are also displayed with a decimal point and the cents amount. Examples: $1.00, $2.50, $5.00, $7.50, and $10.00.

4.1.4.3. Displaying Over 10 Dollars: 900Email displays amounts above ten dollars with the cents shown only if the amount is not a whole dollar amount.

Examples: $10.50, $11, $22.22, $99, $150, $200, $3,000, and $10,000.

4.1.5. Culture: 900Email shall support these Culture requirements:

4.1.5.1. Default Culture: 900Email shall default to American culture by:
4.1.5.1.1. Text: displaying text in US (American) English; and,
4.1.5.1.2. Currency: displaying and calculating money in US Dollars.

4.1.5.2. Language Selection: 900Email shall enable a user to choose the language setting for his account from among our list of supported languages (1.6.6, p. 35).

4.1.5.3. Currency Selection: 900Email shall enable a user to choose the currency setting for his account from among our list of supported currencies (1.6.7, p. 36; 7.6.1.2, p. 133).

4.1.5.4. Diversity: 900Email shall enable a user to choose a Language and Currency independently of each other.

Example—Unrelated Settings: A recent German immigrant to the U.S. might choose German for a language and select US Dollars for his default currency.

4.1.6. Favorite Icon: 900Email web site shall customize the icon listed in the Favorites drop-down menu by MS Internet Explorer to display our own “favicon” company icon rather than the standard IE icon.

4.2. Visitor Page

4.2.1. 900Email Home Page

4.2.2. Client Sign-Up

4.2.2.1. Suggested Rate: When the Client is selecting his own EPostage Rate for his incoming messages, he shall see a suggested Rate.
4.2.2.2. Business Rule—Default Sign-Up Rate: Management shall be able to change the default EPostage rate displayed to a user as he sets up his new Client account. Initial value: 0.34¢ (U.S. Stamp Rate).

4.2.2.3. Initial EPostage: At Sign Up, 900Email asks the Client if he would like to purchase some amount of EPostage to simplify sending Email messages to other Clients.

4.2.2.4. Default EPostage Purchase Suggestion: When the Client signs up and has the opportunity to first purchase EPostage, 900Email suggests an amount, the Default EPostage Purchase Suggestion. That amount is the first $5 multiple above the average initial EPostage purchase by a Client. This Default Suggestion updates once a week automatically, without requiring a Policy variable adjustment by management.

4.2.2.5. Client Agreement: To finalize the account creation process, the user must view and agree to the “Client Agreement.”

This entire agreement shall appear on the Client's screen. (Consider keeping the agreement onscreen for a policy-specified period of time, say 30 seconds.) 900Email requires the user to indicate his agreement in order to complete the creation of his account and become a 900Email Client. Find the text for the Client Agreement in the 900Email Policies Publication, under Client Integrity Policy. This agreement indicates the Client's obligation to his senders, as to what he must read (and perhaps reply to), and what he is not required to read.

4.2.2.6. Reserved Celebrity IDs: 900Email shall not allow a member of the general public to sign up via our website and obtain an actual celebrity name for their Email account.

4.2.3. Customer Sign-Up Sent by an IEP:

4.2.4. Normal Customer Sign-Up

4.2.4.1. Default Signup Culture: 900Email shall default to setting up a Customer Account to the Culture (language and currency) he is using in the display of the web pages.

4.2.4.2. Allow Cultural Conversion: While defaulting to the web page Culture being displayed, the sign-up process provides the user with the opportunity to change (independently) the language and currency of his account.

4.2.5. Corporate Client Sign-Up

4.2.6. Revenue Chart

4.2.7. EStamp Explanation

4.2.8. Surveys

4.2.9. Privacy & Security

4.2.10. Company Info

4.2.11. Contact Us

4.3. Client Pages

4.3.1. Logging In

4.3.1.1. Masked Password: When logging on, mask password by replacing typed keystrokes with asterisks.

4.3.2. My Email

My Account Web Page: enables Clients to view subject lines, read, download, delete, forward, etc. their Email messages, and create and send new messages, and supports optimization for wireless email readers.

4.3.3. EStamp

This page explains EStamps for Clients.

4.3.4. Bulk Mail Permit

Enables a Client to classify his account as bulk-mail permitted. He qualifies for this permission by answering questions to the effect that he only sends out Email messages to people whom he knows have requested mail from him. Shall include a message similar to: “900Email views with skepticism the companies that sell large lists of supposedly “opt-in” Email IDs. Mailing to recipients on one of these lists is not a valid defense for violating 900Email's anti-spam policy. Many Internet users sign up for information, or register products on the web, and agree to receive product updates or relevant information, and list dealers exaggerate the user interest and willingness to receive a large quantity of junk with scant relationship to his original request for information.”

4.3.5. Celebrities Pages

4.3.7. My EPostage

4.3.5.1. EPostage Minimum Balance:

4.3.5.2. Password Recommendation: 900Email shall display a notice on the Client's My EPostage webpage recommending he occasionally change his password.
4.3.5.3. Business Rule—Password Change Notice: 900Email shall be able to change the Password Change Notice. Initial Value: “Occasionally changing your password increases the security of your account!”
   4.3.6. My Account: Modify

This page will allow a Client to change his Public Tier EPostage Rate, to authorize automated monthly EPostage purchases via credit card or direct deposit, to change financial information, his account language and currency, etc.

4.3.6.1. Customize Automatic IEP Reply: The Client can customize the Insufficient EPostage Reply.

4.3.6.1.1. Subject Edit Box: 900Email shall display the first of two Edit Boxes containing the IEP Reply Subject and allow the Client to modify or replace the subject.

4.3.6.1.2. Body Edit Box: 900Email shall display the second of two Edit Boxes containing the IEP Reply Body and allows the Client to modify or replace the subject.

4.3.6.1.3. Move between Boxes: 900Email shall enable the Client to click or tab between the two edit boxes.

4.3.6.1.4. Click When Done: 900Email enables a Client to click a [Save] button to indicate his desire to save his changes to his Customer EPostage Reply.

Technical Note—Edit Box: 900Email allows the Client to modify or replace the subject and body text of the standard Insufficient EPostage Reply, in order to create and save his own, personalized Custom Reply.

4.3.7. EPostage Tiers:

4.3.7.1. Create Tiers:

4.3.7.2. Edit Tier Memberships:

4.3.7.3. Price Tiers:

4.3.7.4. Delete Tiers:

4.3.7.5. Guaranteed Reply Pricing by Tier: 900Email shall enable a Client to establish a price, per Tier, that he shall charge a sender to Guarantee a Reply.

4.3.8. EStampLink.htm: A Client sees this page only by clicking on the [EStamped] link at the beginning of the first line of the body of a message which 900Email has determined was returned to him by way of an EStamp.

Technical Note—Explaining EStamps: This page explains the use of EStamps to a Client who may have successfully used an EStamp, but who may have forgotten details about its function.

4.3.9. Requested Refund

900Email shall support these Requested Refund requirements:

4.3.9.1. Enable Request: 900Email shall enable a Client to Request that we Refund EPostage to a sender of a particular Email message:

4.3.9.2. Send Notification: 900Email shall send an Automatic Reply (8.5, p. 147) informing the Customer of his Refund.

Business Note—Include No Personalized Message: Due to the foibles of human nature, we should not enable Clients to send a personalized message along with the Automatic Reply informing the Customer of his Refund. We charge the Client only the $0.05 EPostage Prepaid Rate to send the refund. If we implemented such a personal message feature and allowed Clients to send a message back along this low-cost ($0.05) route, by doing so we would unduly burden our Celebrity Clients. Here's how: Rush Limbaugh charges EPostage on his Public Tier. However, if we allowed our Clients to insert a personalized message in the Refund on Request Automatic Reply, then every Client Rush sends an Email message to could Refund their EPostage Rate back to him, say 0.25¢, and thereby send a message to Rush while evading his EPostage requirement.

4.3.10. Close My Account

900Email shall enable a Customer to Close his EPostage Account.

4.4. Customer Pages

4.4.1. Logging In

4.4.1.1. Masked Password: When logging on, mask password by replacing typed keystrokes with asterisks.

4.4.1.2. Changing Password

4.4.1.3. Inactive Account Alert: If the Customer's Account has been marked Inactive due to lack of activity (3.14.1, p. 109), then 900Email shall alert the Customer to that fact if he logs in.

4.4.2. Become a Client!

4.4.3. My EPostage

4.4.4. Refund Explanation

This page will display an explanation of the Customer's last refund event, if he has one. Perhaps no 900Email web page will link to this page, but rather, the Customer can click 25 here only from a Automated Refund Reply.

4.4.5. Close Account

4.5. Public Directories

Celebrity/General Directory/(Yellow Pages) Industry Directory (members pay a point off their Client Revenue percentage for inclusion in the Industry Directory. For example, Accountants wanting business referrals, contractors, etc., can list themselves here, and hope for business contacts, but this shall reduce their Client Revenue percentage.

Also, as another revenue stream: When a Client opts in or out of the public directory, if he opts in, then ask if he would want to receive “paid Email messages” from vendors and organizations interested in (and willing to pay for) contacting him. Sell both celebrity and general accounts, by EPostage Rate, geographically, or by any other demographic our Clients reveal. Data mining interface: Create an interactive, publicly available, filter access to our Client database which charges a penny per name for every sort criteria, user pays online and receives email IDs online in the same session.

5. Desktop

5.1. 900Email.exe

5.2. 3rd-Party Email Clients

Business Note: Third-Party Front Ends: 900Email supports Clients using MS Outlook and other third-party front-end email programs that use standard email protocols. With such front-end software (or with a browser via 900Email.com), Clients can access (view subject lines, read, save, download attachments, organize, print, forward, delete, etc.) their 900Email messages and create and send Email (including attachments) to other 900Email Clients as well as to non-900Email accounts.

5.2.1. Supported Front Ends

| | |
|---|---|
| 5.2.1.1. | Netscape Mail |
| 5.2.1.2. | Netscape Messenger |
| 5.2.1.3. | Netscape |
| | Communicator (supports LDAP) |
| 5.2.1.4. | Lotus Notes |
| 5.2.1.5. | CC:Mail |
| 5.2.1.6. | MS Outlook |
| | (supports LDAP) |
| 5.2.1.7. | MS Outlook Express |
| 5.2.1.8. | Pegasus |
| 5.2.1.9. | The Bat! |
| 5.2.1.10. | Eudora (supports |
| | LDAP) |
| 5.2.1.11. | Calypso |
| 5.2.1.12. | QuickMail Pro |
| | (supports LDAP) |
| 5.2.1.13. | Mulberry |
| | (supports LDAP) |
| 5.2.1.14. | Emailer (no LDAP |
| | Support) |
| 5.2.1.15. | PocoMail |

Business Note—Unsupported Front-Ends: At this time, we have not yet identified any Email client programs that we will definitely not support. As a continuing process, we will attempt to identify other systems to test for compatibility with 900Email.

6. Customer Service

6.1. Confirming Identity

6.1.1. Authenticate User

6.2. Forgotten Password

6.2.1. Reset Password: When a Client or a Customer forgets his password and 900Email can authenticate his identity (6.1.1, p. 121), then 900Email shall reset that Client's password.

Technical Note: can't Mail Password. Many membership sites on the web offer to email a member's forgotten password to him. Of course, email services do not have this option. For, 900Email could not email a Client's password to him, because if he doesn't know his password, he wouldn't be able to check his email to retrieve the password that we would have sent to him. Also, emailing a password is not secure since the text of an Email message is transmitted over the web in unencrypted form making it easy prey for an eager hacker.

6.2.2. Random Password: 900Email shall reset a password to a system-produced, randomly-generated password of eight alphanumeric characters.

6.2.3. Enforce Personalization: 900Email shall require the user to change his newly reset password upon login by not giving him access to any other feature until he changes his system-generated access code and creates his own personal password.

6.3. Account Management

6.3.1. Edit Contact Information: For Client and Customer Accounts, 900Email Customer Service personnel shall be able to edit contact information including Name, Address, Phone Numbers, Email ID.

6.3.2. Close Account: For Client and Customer Accounts, 900Email shall enable Customer Service personnel to close a user's account.

6.4. Support@900Email.com

When a Client or Customer contacts support@900Email.com with a technical or business question, he shall be charged postage just like anyone else mailing to a 900Email account. 900Email charges the minimum postage amount permitted under the operating parameters of the system. Thus, initially, 900Email.com charges 0.05¢ in order to email Support@900Email.com.

7. Operations

7.1. Data Center

7.1.1. Physical Facility

7.1.2. Availability

7.1.3. Passwords: The security policy of the data center shall allow no passwords to be sent in clear text.

7.1.3.1. From 1.5.1.5, p. 32, Double Firewall Protection: Once account information reaches 900Email, it resides on servers that are heavily guarded electronically, sitting behind two tiers of firewalls so that no data is directly connected to the Internet, and a hacker would need to break and enter through two different security devices.

7.2. Administration

Authorized 900Email employees and agents shall have, however, the ability to backup, restore, and delete an entire Email account, yet without the ability to “look inside” of such an account (see Security, Employee Controls, 1.5.3, p. 34).

7.2.1. Installation: 900Email needs to be able to install the entire system from CD-ROM. We might be requested to host a dedicated (non-shared) instance of our service for a Corporate Client. Or, a Corporate Client might license a cloned copy of our entire system to run on their own in-house computers.

7.2.2. Client Accounts: 900Email shall support the following requirements to administer Client Accounts:

7.2.2.1. Custom Client Portion: 900Email shall enable an authorized user to change the Client Portion earned by a recipient.

Business Note—Marketing: The ability to change the Custom Client Portion shall not appear via the Operations or Administrative software interface. Rather, a separate software program shall enable changes to the Client Portion. This Customize Client Portion (CCP) program will be used, not by Operations or Administration, but by Marketing. Also, whenever a Client Portion is changed, an Email message notification is sent to the persons listed in CCP's notification setting. Note: CCP is nowhere further defined as of yet.

7.2.2.2. Close Account: 900Email shall enable an authorized user to close a Client Account.

7.2.3. Customer Accounts: 900Email shall support the following requirements to administer Client Accounts:

7.2.3.1. Close Account: 900Email shall enable an authorized user to close a Customer Account.

7.2.4. Import Utility: 900Email enables an email system administrator to move his existing Email accounts from a 3rd-party email system into 900Email.

7.2.5. Export Utility: 900Email enables an administrator to export Email accounts in an MS Exchange format.

7.2.6. Adding a Domain: 900Email enables an authorized administrator to add a domain (1.8.2, p. 39).

7.2.7. Deleting a Domain: 900Email enables an authorized administrator to delete a domain (1.8.2, p. 39).

7.2.8. Uninstall Instructions: 900Email makes available a set of instructions for an administrator to follow to uninstall the entire system.

Business Note—Corporate Procedures: 900Email has Uninstall Instructions available for Corporate Clients who may require this to comply with their own procedures documentation system. These instructions explain an orderly method of removing the system from its server(s).

7.2.9. Email Engine Settings: 900Email shall support the following Email Engine Settings:

7.2.9.1. SMTP Verify: The administrator shall be able to (and shall be required by procedure to) turn off the setting for the SMTP Verify command to hinder hackers and spammers from querying our email user database to verify the existence of a particular Email account ID.

7.2.9.2. SMTP Expand: The administrator shall be able to (and shall be required by procedure to) turn off the setting for the SMTP Expand command to hinder hackers and spammers from querying our email user database to list all of our Email account IDs.

7.2.9.3. Telnet Connection: The administrator shall be able to (and shall be required to by procedure to) disallow a user from connecting to our system via Telnet.

Technical Note—Hinder Hackers: Hackers and spammers will attempt to access our system at the command level with Telnet to find vulnerabilities, but we will disallow that type of connection.

7.3. Alarms

900Email shall generate Alarms as necessary by supporting these requirements:

7.3.1. Alarm Elements: 900Email shall include the following data elements with each alarm communication:

7.3.1.1. Alarm Name: For example, “Exchange3 Server Not Responding May 13, 2002 1:22 am ET.”

7.3.1.2. Alarm Date: For example, “Exchange3 Server Not Responding May 13, 2002 1:22 am ET.”

7.3.1.3. Alarm Time: For example, “Exchange3 Server Not Responding May 13, 2002 1:22 am ET.”

7.3.1.4. Alarm Scope: 900Email shall identify the scope of the alarm condition as to whether the alarm applies to one or more servers, or indicates a system-wide condition:

7.3.1.5. Module Alarm: For example, “EPostage_Accounts on SQL3 Not Responding May 13, 2002 1:22 am ET.”

7.3.1.6. Server Alarm: For example, “Exchange3 Server Not Responding May 13, 2002 1:22 am ET.”

7.3.1.7. Multiple Server Alarm: If an alarm condition spans two or more servers, then each server shall be named in the alarm. For example, “SQL1 & SQL2 Workload Out of Balance by 15.1%, May 13, 2002 1:22 am ET.”

7.3.1.8. System Wide Alarm: If alarm applies to a system-wide condition, then the entire system shall be identified in the alarm. For example, “900Email System Down May 13, 2002 1:22 am ET.”

7.3.2. Alarm Modes: Each alarm can trigger different modes of notification, including:
7.3.2.1. Email alert,
7.3.2.2. Instant Message (IM) alert
7.3.2.3. Pop-Up Window alert
7.3.2.4. Audio alarm
7.3.2.5. Printout alert
7.3.2.6. Pager alert, and
7.3.2.7. Any combination of the above.

7.3.3. Alarm Recipients: Each alarm can be set up to notify one or more persons. A person can be identified, and then notified, by way of an:
7.3.3.1. Email ID,
7.3.3.2. Pager Phone Number
7.3.3.3. Workstation IP Address
7.3.3.4. Networked Printer Address
7.3.3.5. Any combination of the above.

Example: A Server Not Responding alarm might notify the onsite Interland Support Department via audio, instant message, and printout alerts, and it might send a pager message to the 900Email Operations Manager. Also, the 900Email Chief Operating Officer may elect to receive an Email notification of the most critical alarms.

7.3.4. Operational Alarm Thresholds: 900Email shall trigger an alarm when the status of the system crosses an Operational Alarm Threshold:

7.3.4:1. Low Available Disk Storage: Allows specification of a threshold, in percentage, of available disk space or in a fixed number of megabytes. Initial value: 20 percent.

7.3.4.2. Dangerously Low Available Disk Storage: Allows specification of a threshold, in percentage, of available disk space or in a fixed number of megabytes. Initial value: 5 percent.

Technical Note: As an emergency response to running out of disk space, the operator can map a virtual network drive letter to use storage on another server for temporary relief.

7.3.4.3. Disk Storage Availability Failure: 900Email triggers this alarm when notified of this condition by the server operating system.

7.3.4.4. Low Available RAM (i.e., Excessive Paging): Allows specification of a threshold in the extent of paging required to meet RAM demands.

[Marketing requests advice from Development on defining this requirement.]

7.3.4.5. Dangerously Low Available RAM (i.e., Excessive Paging): Allows specification of a threshold in the extent of paging required to meet RAM demands.

[Marketing requests advice from Development on defining this requirement.]

7.3.4.6. RAM Availability Failure: 900Email triggers this alarm when notified of this condition by the server operating system.

7.3.4.7. CPU Nearing Maximum Usage: 900Email shall trigger the CPU Nearing Maximum Usage alarm when a server's activity exceeds the following settings:

7.3.4.8. CPU Busy vs. Idle: Allows specification of CPU usage threshold, in percentage, of busy versus idle time. Initial value: 90% busy.

7.3.4.9. Duration of Busy State: Allows specification of the length of time in seconds during which the CPU must exceed the Busy vs. Idle threshold for more than half of those seconds. Initial value: 90 seconds.

7.3.4.10. CPU At Maximum Usage: 900Email shall trigger the CPU At Maximum Usage alarm when a server's activity exceeds the following settings:

7.3.4.11. Maximum CPU Usage: Allows the definition of a maximum CPU usage threshold for the purpose of triggering this alarm. Initial value: 99.9% busy.

7.3.4.12. Duration of Maximum Busy: Allows specification of the length of time in seconds during which the CPU must be at or exceed the Maximum CPU Usage threshold for more than half of those seconds. Initial value: 30 seconds.

7.3.4.13. Nearing Maximum Serviceable Requests (MS Exchange): 900Email shall trigger the Nearing Maximum Serviceable Requests (Exchange) alarm when a server's activity exceeds the following settings:

7.3.4.13.1. Nearing Maximum Requests (Exchange): Allows specification of a number of incoming requests for service, per second of time. Initial value: [TBD; to be set by the program manager].

7.3.4.13.2. Duration of Maximum Requests (Exchange): Allows specification of the length of time in seconds during which the number of actual service requests exceeds the Nearing Maximum Requests threshold for more than half of those seconds. Initial value: 60 seconds.

Technical Note—Averaging: Thus, if the Nearing Maximum Requests (Exchange) is set to 1,000 per second, and in a given 10-second period, an average of 1,100 requests comes in per second for four seconds, and 900 requests per second for six seconds, the Nearing Maximum Requests (Exchange) alarm would not trigger, because the activity exceeded the specified threshold for less than 50 percent of the time. However, if the number of requests for service exceeded the maximum number for six seconds, then 900Email would trigger the alarm.

7.3.4.14. Nearing Maximum Serviceable Requests (MS SQL Server): 900Email shall trigger the Nearing Maximum Serviceable Requests alarm when a server's activity exceeds the following settings:

7.3.4.14.1. Nearing Maximum Requests (SQL): Allows specification of a number of incoming requests for service, per second of time. Initial value: [TBD; to be set by the program manager].

7.3.4.14.2. Duration of Maximum Requests (SQL): Allows specification of the length of time in seconds during which the number of actual service requests exceeds the Nearing Maximum Requests (SQL) threshold for more than half of those seconds. Initial value: 60 seconds.

7.3.4.15. At Maximum Serviceable Requests (MS Exchange): 900Email shall trigger the At Maximum Serviceable Requests (Exchange) alarm when a server's activity exceeds the following settings:

7.3.4.15.1. At Maximum Requests (Exchange): Allows specification of a number of incoming requests for service, per second of time. Initial value: [TBD; to be set by the program manager]. 7.3.4.15.2. Duration of Maximum Requests (Exchange): Allows specification of the length of time in seconds during which the number of actual service requests meets or exceeds the At Maximum Requests (Exchange) threshold for more than half of those seconds. Initial value: 10 seconds.

7.3.4.16. At Maximum Serviceable Requests (MS SQL Server): 900Email shall trigger the At Maximum Serviceable Requests (SQL) alarm when a server's activity exceeds the following settings:

7.3.4.16.1. At Maximum Requests (SQL): Allows specification of a maximum number of incoming requests for service, per second of time. Initial value: [TBD; to be set by the program manager].

7.3.4.16.2. Duration of Maximum Requests: Allows specification of the length of time in seconds during which the number of actual service requests per second exceeds the At Maximum Requests (SQL) threshold for more than half of those seconds. Initial value: 5 seconds.

7.3.4.17. Workload Out of Balance: Allows specification of a threshold, in percentage, of the different amounts of work delivered to the different servers. Initial value: 15 percent.

7.3.4.18. Workload Out of Balance: Allows specification of a threshold, in percentage, of the different amounts of work delivered to the different servers. Initial value: 15 percent.

Example: Triggered: When the 900Email load-balancing effort does not function properly, assigning significantly more work to one server as compared to another performing the same function, 900Email shall trigger this alarm.

7.3.4.19. Server Not Responding: Names the server not responding.

Example: “SQL2 Server Not Responding May 13, 2002 1:22 am ET.”

7.3.4.20. Module Not Responding: Names the software module not responding.

Example: “900Email on Exchange2 Not Responding May 13, 2002 1:22 am ET.”

7.3.4.21. 900Email System Down: Triggered if the entire system is unavailable to users on the Internet.

7.3.5. Program Logic Error: 900Email shall trigger an alarm when notified by a subroutine of a program logic error. The alarm indicates an error code which identifies the subsystem, the subroutine, and the error condition.

7.3.6. Financial Alarm Thresholds: 900Email shall trigger an alarm when the status of the system crosses a Financial Alarm Threshold.

7.3.6.1. Excess Funds in Collected EPostage Account: When the balance of the Collected EPostage Account is greater than the Estimated Payout.

7.3.7. Hacker Attack Alarms: 900Email shall trigger an alarm when it identifies a possible hacker attack.

Over-use of Rate Request: When excessive Client EPostage Rate Requests (3.9.4, p. 100) come into the system, per sender and aggregately, 900Email shall trigger this alarm.

7.4. Backup

900Email shall support these System Reporting requirements:

Technical Note—The 900Email system shall be backed and archived according to industry norms for mission critical, public financial and Email Internet applications. We will research this issue and modify the following requirements accordingly.

7.4.1. On-site Archives: Backups shall be kept on-site for recovery from system failure such as server or storage failure.

7.4.2. Off-site Archives: Backups shall also be kept off-site for recovery from catastrophic failure due to fire, earthquake, flood, sabotage, etc.

7.4.3. Data Backup: Our Backup process shall protect the data in the system, but shall not Back Up the system software, since the system itself can be re-installed.

7.4.4. Daily Backups: Everyday at 4 a.m. Eastern Time, 900Email shall Backup all 900Email Customer and Client data and account information, transactions, etc. (1.3.3, p. 31).

7.4.5. System Archives

7.4.6. System Restore: If 900Email system software requires reinstallation (due to a server copy becoming corrupted, etc.), the Operations personnel shall reinstall the required software from the 900Email installation CD ROM(s), whether it be a subsystem on a single server, all the system software on an entire server, or systems spanning multiple servers, or the entire system spanning all servers.

7.4.6.1. On Hand System Software: Operations personnel responsible for Backup and Restore functions shall have available the latest in-use version of all system software components, storing them close at-hand for emergency restore needs.

7.4.7. Data Restore: 900Email Operations personnel shall be able to restore data selectively, having the ability to restore:
7.4.7.1. All system data: (mail, accounting, etc, and on all servers);
7.4.7.2. Data by Customer account: (in case one or more accounts get corrupted);
7.4.7.3. Data by Domain name: (in case a Hosted Email system gets corrupted);
7.4.7.4. Data by Corporate account: (in case a Corporate Account get corrupted);
7.4.7.5. Data by server: (in case of catastrophic server failure); and,
7.4.7.6. Data by hard disk: (in case of catastrophic failure of an entire redundant array of disks).

7.4.8. Restore Exercises: Monthly, 900Email Operations personnel shall restore test account data and system software by server and by subsystem to ensure familiarity with, and the proper functionality of, our backup and restoration procedures, software, and equipment.

7.5. System Reporting

900Email shall support these System Reporting requirements:

7.5.1. General Reporting Requirements

7.5.1.1. MS Excel: 900Email shall format reports for import into Microsoft Excel.

7.5.1.2. MS Word: 900Email shall format reports for import into Microsoft Word.

Operations: Performance Tuning

Report on CPU usage per server showing percentage of CPU time in idle vs. busy, peak usage times, and average usage per quarter hour segment, and a summary of these statistics for the entire system measuring CPU usage across all servers.

Report on amount and percentage of memory allocated and paging statistics, and a summary of these statistics for the entire system measuring memory usage across all servers.

Report of summary-level traffic showing total communications to and from each hardware and software module, including number and aggregate size of communications, and a summary of these statistics for the entire system showing total communications between all modules and servers.

Provide trending in n-minute intervals, of summary statistics of all sent and received communications.

Reporting: 900Email system reports can be run on demand, or scheduled to run and forward results automatically to a list of managers.

7.5.1.3. Report Formatting: 900Email shall enable on demand formatting regarding the aspects of the report like bold, italics, underline, color, graphs & charts, rounding to the nearest dollar, thousand, million, etc.

7.5.2. Overview Report: 900Email management can request an Overview report which provides:
a list of which domain names our entire system is supporting;
the total number of Client accounts
the total number of Customer accounts
the number of Client accounts by domain
the number of Customer accounts by domain
summary activity on numbers of Email messages received
summary totals on combined EPostage account balances
summary totals on combined Client Portion earned
summary totals on combined Client Portion payouts
report on all policy (Business Rule) variable values

7.5.3. Clients Report: Indicates the number of 900Email Clients, with a breakdown of the number at various postage rate ranges:

900Email Client Accounts
Jan. 1, 2004 through Dec. 31, 2004

| | | Avg Msgs | | 91% Client | 9% Service |
|---|---|---|---|---|---|
| Postage Range | # of Accts | Per Day | Gross Revenue | Portion | Fee |
| .05-09 [symbol] | 2,000 | 6 | $12,450 | $11,330 | $1,121 |
| .10-24 [symbol] | 5,000 | 6 | 62,251 | 56,648 | 5,603 |
| .25-34 [symbol] | 6,600 | 5 | 205,427 | 186,939 | 18,488 |
| .34-49 [symbol] | 4,000 | 4 | 169,322 | 154,083 | 15,239 |
| .50-74 [symbol] | 2,000 | 5 | 124,502 | 113,296 | 11,205 |
| .75-99 [symbol] | 400 | 4 | 37,350 | 33,989 | 3,362 |
| Totals: | 20,000 | (Weighted) x | $611,302 | $556,285 | $55,017 |
| $1-1.99 | 182 | 5 | $23,904 | $21,753 | $2,151 |
| 2-4.99 | 145 | 4 | 37,350 | 33,989 | 3,362 |
| 5-9.99 | 114 | 4 | 70,966 | 64,579 | 6,387 |
| 10-24.99 | 78 | 5 | 97,111 | 88,371 | 8,740 |
| 25-49.99 | 42 | 4 | 130,727 | 118,961 | 11,765 |
| 50-99.99 | 16 | 3 | 99,601 | 90,637 | 8,964 |
| 100-199.99 | 5 | 4 | 62,251 | 56,648 | 5,603 |
| $200 & up | 8 | 1 | 74,701 | 67,978 | 6,723 |
| Totals: | 600 | (Weighted) x | $596,611 | $542,916 | $53,695 |
| Total | 20,600 | | $1,207,914 | $1,099,201 | $108,712 |
| Clients | | | | | |

7.5.3.1. Clients Report Timeframe: 900Email shall report on the above Client information for annual, quarterly, monthly, weekly, or daily time periods.

7.5.4. Number of Customers Report: Indicates the number of 900Email Customers that maintain EPostage accounts, with the average daily balance of all accounts combines. Also shows the number of accounts in various ranges of average balances, $0-4.99; $5-10, $ 10-20, etc. Also provides the percentage of Clients who maintain a positive balance in their EPostage accounts. And the average EPostage balance for all Clients, versus the average balance for all non-clients. The report will function properly even if the number of Customers goes into the billions.

7.5.5. Revenue Report: Indicates the amount of gross revenue collected including Client Portion funds, amount of 900Email gross income from the Service Fee and premium services, over a specified period of time, daily, weekly, monthly, quarterly, and annually. The report will function properly even if the revenue numbers go into the trillions.

7.5.6. Domain Report: This report shall list the number of unique domain names from which incoming Email messages arrive; the number of messages from each domain and the percent of all messages originating from that domain.

7.5.6.1. Domain Size Ranges

7.5.7. Over Usage Report: An automatic report function alerts management to users sending 500 or more emails per day.

7.5.8. Pending Revenue Report: Value of Service Fee charges sitting in Client's inboxes for messages that have not yet been downloaded or read. Include length of stay in Clients' inbox before the average message is read.

7.5.9. Overdue Balance Report: When a Client carries a debt to 900Email . . .

7.5.10. Security Violation Reports: For example, see Authentication EStamp Type 4 misuse (2.7.4.12.4, p. 65); and see the DNS Alarm Report which indicates a counterfeit FROM field found via a Reverse DNS Lookup (3.9.5.2.3, p. 103).

7.5.11. Other

7.6. Management Needs

900Email shall support these Management requirements:

7.6.1. Business Rules

900Email enables management to change the settings of the system parameters defined in this document as Business Rules (such as the Service Fee, the EPostage Minimum Rate, and even text strings like the Insufficient EPostage Reply Subject) by supporting these Business Rules requirements:

7.6.1.1. Single Interface: 900Email shall enable management to change all the implemented Business Rules from a single user interface (7.6.1.4, p. 133) application.

7.6.1.2. Currency Pricing Independence: 900Email shall be able to price all its services independently by currency.

Technical Note—Currency Rules: Supporting Currency Pricing Independence requires the implementation of every financial Business Rule in multiple currencies. Thus, the Service Fee business rule, (1.6.10, p. 36), currently set at 9% in US Dollars, will not be internally identified in the code simply as the “ServiceFee” rule, but the “USServiceFee” rule. Similarly, the EPostageMinimumRate is really the USEPostageMinimumRate. (We should use “US” rather than “Dollar” because many countries identify their currency units in “Dollars.”) Our Business Rules interface shall enable 900Email management to adjust these same charges in Germany's currency, by changing, for example, the MarkServiceFee and the MarkEPostageMinimumRate.

7.6.1.3. Rule Multiplication: As we add support for each new currency, 900Email automatically creates a complete new set of Financial Business Rules for that new currency. For example, if for a single currency there are fifteen distinct Financial Business Rules, then supporting both US Dollars and German Marks shall require the use of thirty Rules. By this example, when we add support for French Francs, 900Email shall automatically add another fifteen Financial Business Rules, these controlling the value of all Rates and Fees for customers paying us in Francs.

7.6.1.4. BRIEF: 900Email Business Rules InterFace, BRIEF.exe, shall enable management to modify the value of all of the Business Rules variables described throughout this Requirements Document.

7.6.1.4.1. Non On the Web: BRIEF.exe, a desktop software program, shall load and run off of a corporate officer's local hard drive.

7.6.1.4.2. Password Protected: Before exposing its user interface, at startup BRIEF.exe shall require a user-name and password.

7.6.1.4.3. Three Users: BRIEF.exe allows an administrator user to manage a maximum of two other user accounts.

7.6.1.5. Financial Rules Currency Selection: BRIEF.exe shall require selection of a currency (US Dollars, Yen, Mark, etc.) before providing access to the Financial Business Rules.

7.6.1.6. Text Riles Language Selection: BRIEF.exe shall require selection of a language (US English, German, Japanese, etc.) before providing access to the Text Business Rules.

7.6.1.7. Automatic Rule Generation: As we add support for each new language, 900Email automatically creates a complete new set of Text Business Rules for that new language.

7.6.1.8. Two-Stage Authorization: These changes shall occur only after strict authorization, requiring two authorized users to make the change. The change is initiated by the COO, and then approved by the CTO, before going into effect.

Technical Note—Purpose of Business Rule Boxes: Remember, the purpose of the Business Rule boxes is to call attention to those system variables which management shall be able to make a change in value without requiring programming intervention, that is, no code modifications, and no re-compiling for the new values to take effect. To change a Business Rule via BRIEF.exe requires two (2) username and password authentications, the first initiating a change, and the second, approving that change. 900Email may require policy changes to be effected by the Chief Technical Officer and the Chief Operating Officer, who both keep their passwords secure, but available to the Board of Directors through some extraordinary effort in the case of death or incapacity.

7.6.1.9. Cents & Dollars: BRIEF.exe shall allow entry and display dollar and cents amounts with the same format as our website and all other 900Email software (4.1.4, p. 112).

7.6.1.10. Time Periods: BRIEF.exe shall allow users to enter time periods, such as a Reply Retry Delay or an EStamp Lifespan, in years, months, days, hours, minutes, or seconds.

7.7. Accounting Needs

900Email shall support these Accounting requirements:

7.7.1. Controlled Transfer Tool

Business Note—Funds Security: Throughout much of the 900Email process, EPostage funds remain in our physical EPostage Bank Account, except when transferred to Money Market funds to earn higher interest. Funds transferred out of our EPostage Bank Account, whether into our own corporate checking account, a Money Market fund, or into a Client's personal checking account, shall not be transferred by way of a commercial bank's website or by a bank's online transaction software or services, but rather, through a 900Email program called the Controlled Transfer Tool (CTT). Why? CTT only allow transfers out of and into pre-authorized accounts. Also, CTT regulates the amount of funds transferred, not allowing the transfer of more money than our Business Rules permit. A commercial bank's online banking service would allow up to 100% of the funds in an account to be transferred. And either maliciously, or by accident, a 900Email manager might attempt to transfer funds into an unauthorized account, or, he might attempt to transfer a larger than acceptable amount of funds out of our EPostage bank account. Imposing a procedure that permits only the transfer of funds through our own software interface enables us to enforce our own Business Rules upon all such transfers, from the moving of dollars into Money Market funds, to the monthly payout to Clients. So, with this Controlled Transfer Tool, 900Email shall not allow a transfer into an unauthorized checking account. Nor, for example, shall CTT allow a transfer into a Money Market Fund that leaves insufficient funds to cover any scheduled distribution for that day. Nor will it allow a transfer even into our own corporate checking account that leaves insufficient funds to cover any scheduled pending distribution to our Clients.

Until such a tool is developed, the 900Email System shall not impede our Cash Management department's ability to move, manually and temporarily, physical EPostage funds between that account and various Money Market accounts. Nor shall the system impede our Cash Management department's ability to transfer manually interest earned on our EPostage bank account from that account into our corporate checking account. And finally, nor shall the system impede our Cash Management department's ability to transfer accrued revenue into our corporate checking account.

7.7.1.1. Authorized User Access: The Controlled Transfer Tool (CTT) shall require dual authorization (initiator and authorizer) to perform the financial functions of entering account numbers, accessing accounts, and transferring funds.

Technical Note—Standard High Security: This dual-authorization requirement is similar to the authorization required form management to change any of the 900Email Business Rules (7.6.1.8, p. 134).

7.7.1.2. Setup Accounts: CTT shall enable its users to enter routing and account numbers (which sets up CTT to access those accounts).

7.7.1.3. Indicate Account Type: CTT shall enable its users to indicate the type of account represented by a particular account number, either:
7.7.1.3.1. EPostage Bank Account;
7.7.1.3.2. Money MarketAccounts;
7.7.1.3.3. our Undeliverable Funds Bank Account; or,
7.7.1.3.4. the 900Email Inc. General Bank Account (that is, our corporate checking account).

7.7.1.4. Transfer Funds: CTT shall call our Reliable Funds Transfer function (8.4, p. 145) to do the actual transfer of funds between physical bank accounts.

7.7.1.5. Transfer Rules: CTT shall not allow a transfer of funds in violation of 900Email Business Rules.

7.7.1.5.1. Authorized Accounts: CTT shall enable its users to transfer funds only between established, dually-authorized accounts.

7.7.1.5.2. Retain Client Payout: CTT shall not allow any transfer out of the EPostage Bank Account that would leave insufficient funds to cover a “Pending” Payout to our Clients from the EPostage Bank Account into our Clients' personal accounts.
7.7.1.5.3. Business Rule—Client Payout Pending: Management shall be able to change the length of time prior to a scheduled monthly Client Payout during which 900Email shall not permit transfer of funds out of the EPostage bank account that would leave that account with insufficient funds to cover the pending Client Payout. Initial value: 5 days.

7.7.1.5.4. Retain Daily Paycheck: CTT shall not allow a transfer out of the EPostage Bank Account into a Money Market account that would leave insufficient funds to cover that day's scheduled transfer of the entire balance of our Internal Accrued Revenue Account from the EPostage bank account into our 900Email Inc. General Bank Account.

7.7.1.6. Deleting Accounts: CTT shall only require a single user to delete reference to an established account.

7.7.1.7. Transfer Records: CTT shall create a database archive of all actions recording for each action performed in CTT including:
7.7.1.7.1. the initiator user ID;
7.7.1.7.2. the authorizer user ID;
7.7.1.7.3. the date of the action;
7.7.1.7.4. the time (in the local time of the 900Email headquarters);
7.7.1.7.5. the account number(s); and, if recording a funds transfer:
7.7.1.7.6. the amount of transfer; and,
7.7.1.7.7. the direction of transfer.

7.7.1.8. Client Payouts: CTT shall perform the monthly Client Payout function:

7.8. Threat Assessment and Mitigation

Address intersystem Recursion & DOS (Denial-of-Service) Attacks. If a virus or a junk mail provider uses an algorithm that automatically resends a message to any account that responds, then 900Email.com might get into an infinite loop with such a system, forever responding to a never-ending stream of junk messages triggered by 900Email's own replies. Internal monitoring identifies this possible condition and alerts the 900Email operations manager (not the on-site hosting supervisor). The operations manager can add the offender to a blacklist of Email accounts and domain names for which no Automatic Reply is sent. Also, monitor real-time performance statistics, RAM, Storage, CPU. Write to PerfMon for accessing remotely over the web. Support SMP System Management Protocol.

Likewise, if a sender has an out-of-office feature on his Email account, which sends an Automatic Reply to every incoming Email message (as with MS Outlook), then make sure the system does not get into a recursive loop in that scenario.

7.9. Anti-Spam Policy

See the 900Email Policies Publication in our Corporate Library. Sending spam is a violation of our Client Policy and may result in the cancellation of the offending account. We will keep the guilty account holder's name and address combination, account numbers, and credit card numbers on file to stop him from easily opening up a new account under a different Email ID. 900Email supports the industry anti-spam organizations.

8. System Engine

900Email shall support these System Engine requirements:

Technical Note—The Engine: Not all 900Email functionality fits into classifications like Client or Customer Features. This section describes requirements like Transaction Processing, which do not logically fit elsewhere.

8.1. Transaction Processing

900Email shall support these Transaction Processing requirements:

Technical Note—Indivisible Transactions: Transaction Processing software keeps track of multiple operations that together form a single transaction. For example, a bank application may debit one account and credit another. If their system crashed after the debit occurred but before recording the credit, the accuracy of their account data would be at risk, and it might be difficult to restore its veracity. Transaction Processing software requires that those operations either both occur or not occur. Thus, if the debit happens and not the credit, then, after the system is rebooted, the Transaction Processing software may roll back the debit, and retry the entire operation. Thus, the Transaction Processor enables the system to view complex transactions as single, indivisible events which, if they occur at all, occur completely. 900Email requires this functionality to ensure consistency between our EPostage accounts, and between those accounts and our Email webstore. For example, if we debit a Customer's account for delivering an Email message to a Client, the system must guarantee that both the debit and the delivery occur. The Transaction Processor would prevent internal corruption whenever a server crashed after the first event and before the second. Also, when a Client retrieves a sender-paid Email, three things must occur as an “atomic” transaction after we record the retrieve event: we must debit the Collected Funds account, credit the Client Portion, and credit our own Service Fee.

Technical Note—Resource Managers: Transaction Processing software logically sits above the actual engine or engines executing the transactions. An engine that performs transactions tracked by a Transaction Processor is called a Resource Manager. Database engines typically support Transaction Processing “out-of-the-box,” and are therefore ready to be deployed as Resource Managers. Depending upon our implementation, we may or may not need to view our Email engine as a Resource Manager monitored by our Transaction Processing software. If so, however, we would have to design a wrapper around our Email engine (or engines) in order to comply with our Transaction Processing needs. This wrapper would effectively turn our Email engine into a Resource Manager.

8.1.1. Physical Transactions: 900Email's Transaction Processor shall ensure the logical integrity of transactions flowing between physical bank accounts (such as our Customers' personal bank accounts, our company EPostage bank account, our Client's bank accounts, our Undeliverable Funds bank account, and our 900Email, Inc. general bank account, see sections 8.2.1, 8.2.2, 8.2.6, 8.2.7, and 8.2.8).

8.1.2. Logical Transactions: 900Email's Transaction Processor shall ensure the logical integrity of transactions between our internal accounts (such as internal Customer EPostage, Collected EPostage, and Accrued Revenue accounts, see sections 8.2.3, 8.2.4, and 8.2.5).

8.1.3. Email and EPostage Transactions: Again, only if our implementation requires this, the Kernel wrapper will turn our Email server engine into a Resource Manager supporting the needs of our Transaction Processing server. (See 9.2.1, p. 164 for details.)

8.2. System Accounts

900Email shall support these requirements to transfer funds between actual and internal (logical) accounts:

Business Note—Physical Account: Remember, money is described herein as residing “physically” in an account when that account is an actual bank account. Also, an actual bank account (as contrasted with an internal bookkeeping account), is referred to as a “physical” account.

Technical Note—List of Accounts: 900Email shall use the following internal (bookkeeping) and external (bank) accounts as explained in the requirements below.
Banks: Customer Bank Accounts
Bank: EPostage Bank Account
Internal: EPostage Accounts
Internal: Collected Funds Account
Internal: Accrued Revenue Account
Banks: Client Bank Accounts
Bank: Undeliverable Funds Bank Account (Refunds & Payouts)
Bank: 900Email Inc. General Bank Account
Bank: 900Email Inc. Payroll Bank Account

Business Note—Purpose of Accounts: Below, find the debit and credit access requirements for each account. In this note here, find a description of the purpose for each account.
Customer Bank Accounts: 900Email shall need to access Customer checking accounts (and credit card accounts, etc., see Payment Methods, 3.3, p. 94) to fulfill EPostage Automatic Purchase requests (3.6, p. 97), and when necessary to Refund (3.12, p. 107) EPostage purchases. 900Email shall only have debit authority on a Customer's bank account if that Customer has signed up for EPostage Automatic Purchases.
EPostage Bank Account: When Customers purchase EPostage, their physical funds must move into a 900Email-owned bank account. 900Email shall need access to these logical and physical funds to transfer and disperse them as directed by our business logic. EPostage funds remain in this physical bank account throughout much of the 900Email process except when transferred into Money Market Funds to earn higher yields. (The 900Email system software does not need the ability to transfer funds electronically into and out of our Money Market accounts. That function will be the responsibility of our Cash Management department, which will report to our CFO.)
Internal EPostage Accounts: As our Customers repeatedly send Email messages to our Clients, 900Email shall debit and credit their individual, logical EPostage accounts, for a combined number of transactions ultimately reaching, perhaps, millions of operations per day. The balances of our Customers' discrete internal accounts refer to funds that physically reside in our EPostage bank account and/or in our Money Market accounts. Since the EPostage debiting and crediting mostly occurs internally (except for purchases, payouts, requested refunds, and account closings), the vast majority of these housekeeping transactions will not require electronic funds transfer with an outside banking institution. Funds enter a Client's EPostage account by EPostage purchases (3.2.1, p. 92), Client Portion credits (2.3, p. 46), Guaranteed Reply earnings (2.10, p. 74), and Refunds (3.12, p. 107). Funds leave a Client's EPostage account when he sends an Email message to a Client (2.2.4, p. 45), in scheduled Payouts (to himself, 2.15.1, p. 82), when he pays for Premium Services (2.12, p. 78), when he Requests a Refund of EPostage he has purchased (3.12.1, p. 107), and when his account is closed (3.15, p. 110).
Internal Collected Funds Account: This phantom account is really just a balance indicating specially designated funds residing logically throughout our Clients Internal EPostage Accounts. Here is how it works. 900Email collects EPostage funds just prior to delivery of an Email message into a Client's inbox. However, 900Email shall not distribute those funds as Client Portion or take our Service Fee as income until the Client takes a step toward fulfilling his obligation to the sender (2.3.8, p. 49) by Retrieving that Email message. In the case of a particular message, this Internal Collected Funds balance contains the collected EPostage until that amount is transferred into:
   a) the recipient Client's Internal EPostage Account and our Internal Accrued Revenue Account (determined by the Client Portion and our Service Fee); or,
   b) the sender's Internal EPostage Account by way of a Refund.
The dollars represented by the Internal Collected Funds balance logically reside in our Customer's Internal EPostage Accounts and they physically reside in our EPostage Bank Account and/or in our Money Market accounts. Consider a customer who has $10 in his Internal EPostage Account. He sends a 0.25¢ email. We “collect” that money by leaving it in his EPostage Account but decrementing his available funds field by 0.25¢. Thus, his account still contains $10 but the Client can only see his available balance of $9.75. When the recipient Retrieves the 0.25¢ message, at that point 900Email debits the actual balance of the Customer's EPostage Account by that 0.25¢. And then we credit the recipient Client's Internal EPostage account by his Client Portion of the fee, and we take our Service Fee. Thus, the Collected Funds remain logically in the Customer's Internal EPostage Account until actually credited to the Client and recorded by 900Email.
Implementation note: Rather than keeping track of the actual and available balances within each Customer's Internal EPostage Account, we could create a duplicate EPostage database by Customer within the Collected Funds Account to perform the same function. But it is likely more efficient to add a field to each record of the existing database, rather than to duplicate that database. But why not just put all the Collected EPostage into an actual, one-lump-sum Collected EPostage Account rather than keeping track of it all by Customer? A few reasons already appear. This enables us to determine how much sent but not-yet-retrieved EPostage a Customer has outstanding, which information might help marketing. And when a Customer closes an account, it may be helpful to know how much of his outstanding but not-yet-retrieved EPostage still exists in the system. Also, we do this for auditing purposes, as a checks and balances effort to be able to track down related errors that may occur during the lifetime of this product. Otherwise, we would maintain a single quantity of collected EPostage Funds, perhaps totaling hundreds of millions of dollars, with millions of daily credits and debits, which all should, without fail, reconcile perfectly, hopefully. But in the case of a hard-to-identify programming logic error, a computer glitch, or even a malicious hacker, we might have a much better chance of correcting a problem if we can narrow down its scope. For example, imagine that the Collected Funds Account balance is $467 million and it has a $34,567.89 shortfall. Where would we even begin to look for the cause of the imbalance? By using this Phantom Collected Funds Account system, we will be able to search for the source of the error among our Customer's Internal EPostage Accounts, and we should be able to follow the transaction history in those accounts and find two accounts that have $34,567.89 more than they should in available funds. Then we would investigate how those Customer's accounts ended up in that condition. Conversely, if the Collected Funds Account ends up over funded by $400, that overage might appear in the specific EPostage accounts of four senders, and that information may help us identify or at least narrow the source of the error. If a dozen servers process Customer accounts by making credit transactions to a single Internal Collected Funds Account (which might reside on a single server), then perhaps the transactions that contained the four errors originated on only one of those twelve servers, thus indicating a problem on that server. Again, this check and balance function keeps collected funds segregated by use of an available balance indicator, but those funds logically remain within their sender's EPostage account.
Internal Accrued Revenue Account: 900Email shall take its Service Fee by crediting those funds into our Internal Accrued Revenue Account. Funds in this logical account reside physically in our EPostage bank account. The physical EPostage bank account must retain enough money each day to cover the transfer of our accrued income into our corporate checking account. Thus, while 900Email management shall regularly move money from the EPostage bank account to Money Market accounts, management must make sure to leave sufficient funds to cover our daily paycheck to ourselves, retaining funds in the EPostage bank account of an amount at least equal to the balance of our Internal Accrued Revenue Account. In this way, final distribution of funds occurs through this single account, and not among multiple accounts. Each day at 8 a.m. Eastern Time, 900Email shall automatically transfer the entire balance of the Internal Accrued Income Account into our 900Email Inc. General Bank Account.
When 900Email fulfills it obligation to the sender of an Email message, which is the moment the recipient retrieves (views or downloads) that message, then 900Email shall take its Service Fee of 9% of the EPostage for that message out of the Internal Collected Funds Account and deposit it into our Internal Accrued Revenue Account.
Client Bank Accounts: 900Email shall require electronic access to Client checking accounts (and credit cards, etc. see Payment Methods, 3.3, p. 94) to payout Client Portion earnings (2.15.1, p. 82). (Since Clients are also Customers, the 900Email requirements regarding Customer account access shall apply to Clients also.)
Undeliverable Funds Bank Account: When 900Email cannot successfully transfer funds owed to a Customer or Client (Refunds or Payouts, because of a closed account, a wrong account number, etc.), the 900Email shall transfer all undeliverable funds into a physical bank account operated by 900Email named our Undeliverable Funds account.
900Email Inc. General Bank Account: 900Email shall maintain its primary corporate bank account with a major international banking firm. The 900Email System software shall have the ability to transfer funds into our 900Email Inc. General Bank Account. The system software shall not have, however, the authority needed to withdraw funds out of our corporate account.
900Email Inc. Payroll Bank Account: 900Email shall maintain a payroll bank.

The 900Email System software shall have the ability to transfer funds from our 900Email Inc. General Bank Account into our Payroll bank account.

8.2.1. Customer Bank Accounts: 900Email shall have electronic access to external Customer bank accounts (and credit cards, etc., see Payment Methods, 3.3, p. 94).

8.2.1.1. Debit Access: 900Email shall be able to debit Customer checking accounts (and credit cards, etc.) to execute Customer orders to Automatically Purchase EPostage (3.6, p. 97).

8.2.1.2. Credit Access: 900Email shall be able to credit Customer checking accounts (and credit cards, etc.) to Refund (3.12, p. 107) EPostage purchases when necessary.

8.2.2. EPostage Bank Account: 900Email shall have electronic access to our external, company-owned bank account that holds the funds Customers spent to purchase EPostage from 900Email.

Business Note—Controlled Funds Transfers: To avoid violating any of our own Business Rules through accidental or malicious money transfers, 900Email procedures shall permit the transfer of funds by our Cash Management department only through our own Controlled Transfers Tool (7.7.1, p. 134).

8.2.2.1. Debit Access: The 900Email System software shall be able to debit our physical EPostage Bank Account (via CTT, 7.7.1, p. 134) to support the following:

8.2.2.1.1. Service Fee Revenue Transfer: 900Email shall be able to transfer funds from our EPostage Bank Account that logically reside in our Internal Accrued Revenue Account into our corporate checking account.

8.2.2.1.2. Automatic Transfer: Daily at 8 a.m. Eastern Time, 900Email shall automatically debit our EPostage bank account (via CTT) and transfer all the funds represented by the balance of our Internal Accrued Revenue Account into our 900Email Inc. General Bank Account.

Business Note—Daily Paycheck: The funds transferred every day out of the Internal Accrued Revenue Account were generated via our Service Fee and via collections made for charges on other premium services and can be referred to as 900Email's Daily Paycheck.

8.2.2.1.3. Interest Transfer: The 900Email Cash Management department shall be able to use the CTT to transfer EPostage Bank Account earned interest to our corporate checking account.

8.2.2.1.4. Client Payout: 900Email shall use the CTT to remit to our Clients their earned Client Portion revenue for each scheduled monthly Payout (2.15.1, p. 82).

8.2.2.1.5. Customer Refund: 900Email shall use the CTT to pay a Refund into a Customer's personal checking account.

8.2.2.1.6. Undeliverable Funds: 900Email shall use the CTT to transfer undeliverable funds into our Undeliverable Funds Bank Account.

8.2.2.2. Credit Access: 900Email shall require the ability to credit funds into the EPostage Bank Account only in the unlikely event of a need to return funds erroneously withdrawn due to a programming logic error (or some other error or security breach).

Technical Note—Implementation: The Credit Access requirement for the EPostage Bank Account may be initially fulfilled by requiring a manual process of using a deposit slip and making a manual bookkeeping ledger entry, and later fulfilled with the use of our Controlled Transfer Tool for funds transfer.

8.2.3. Internal EPostage Accounts: 900Email shall automatically maintain an accounting record of each individual EPostage account for each Customer.

8.2.3.1. Transaction History: 900Email shall keep a transaction history for each Customer's individual EPostage account.

8.2.3.2. Actual Balance: 900Email shall maintain an internal, hidden balance called the Customer's Actual Balance, which figure reflects the total of his Available Balance (8.2.3.3, p. 142) and the amount of EPostage spent on his sent but not-yet-retrieved messages.

8.2.3.3. Available Balance: 900Email shall keep track of the amount of funds Available in each Internal EPostage Account, which funds a Customer may use to pay for EPostage to send messages.

8.2.3.3.1. Less Available: When a Customer sends a message, 900Email shall lower the Available Balance indicator for that particular Internal EPostage Account by the amount of EPostage collected for delivery of that particular message.

8.2.3.3.2. Less Actual: When a Client retrieves a message, 900Email shall decrease the Actual Balance of that sender's Internal EPostage Account by the amount of EPostage distributed out of that Customer's EPostage Account to pay the Client Portion fee and to pay our 900Email Service Fee for that message.

8.2.3.3.3. More Available: When a Refund event occurs (3.12, p. 107), 900Email shall credit a Customer's EPostage Account by increasing only his Available Balance indicator (since the logical funds for that transaction were still reflected in his Actual Balance).

8.2.3.4. Credit Access: 900Email shall be able to credit a Customer's internal EPostage account to indicate:
8.2.3.4.1. EPostage Purchases
8.2.3.4.2. Client Portion: earnings on a received Email message (2.3, p. 46);
8.2.3.4.3. Guaranteed Reply: earnings (2.10, p. 74);
8.2.3.4.4. Refunds: whenever applicable (3.12, p. 107).

8.2.3.5. Debit Access: 900Email shall be able to debit a Customer's internal EPostage account to:
8.2.3.5.1. Pay the EPostage Rate: due on a sent Email message (2.2, p. 45);
8.2.3.5.2. Pay Client Payout: earnings to his own personal checking account (2.15.1, p. 82);
8.2.3.5.3. Pay for Premium Account Services: (2.12, p. 78);
8.2.3.5.4. Refund by Request: some EPostage he has purchased back into his own checking account (3.12.1, p. 107); and,
8.2.3.5.5. Close his Account: remitting the closing balance to the Customer (3.15, p. 110).

8.2.4. Internal Collected Funds Account: 900Email shall use this phantom account (see extensive note above, p. 139) to keep track of Collected Funds on emails that have been sent but not-yet-retrieved.

Technical Note—Deferred Revenue: This Internal Collected Funds Account shall exist because we take our Service Fee not upon delivery of the message into the recipient's inbox, but when that Client Retrieves (2.8.9, p. 71) that message. Such timing enables us to provide a much more valuable service to our Customer. Also, we credit the Client Portion at Retrieve. So when we need to “hold on to” Collected EPostage Funds until the recipient Retrieves a message, this account shall do the “holding.”

8.2.4.1. Credit Access: 900Email shall increase the Internal Collected Funds Account balance by incrementing it by the amount of EPostage Collected (2.8, p. 65) with the delivery of every Email message sent to our Clients.

8.2.4.2. Debit Access: 900Email shall be able to debit the Internal Collected Funds Account to:
8.2.4.2.1. Pay the Client Portion: (2.3, p. 46) to the our Clients' Internal EPostage Accounts;
8.2.4.2.2. Refund EPostage: (2.16, p. 86) back to Internal EPostage Accounts; and to,
8.2.4.2.3. Pay the Service Fee: (1.6.10, p. 36) to our corporate 900Email Inc. General Bank Account.

8.2.5. Internal Accrued Revenue Account: 900Email shall be able to keep track of our accrued revenues by maintaining our Internal Accrued Revenue Account balance.

8.2.5.1. Credit Access: 900Email shall credit the Internal Accrued Revenue Account with the amount of our Service Fee each time we fulfill our stated obligation to a Customer regarding delivery of an Email message.

8.2.5.2. Debit Access: 900Email shall debit our Internal Accrued Revenue Account automatically each day at 8 a.m. Eastern Time by transferring the entire current balance of that account into our 900Email Inc. General Bank Account.

8.2.6. Client Bank Accounts: 900Email shall have electronic access to external Client bank accounts (and credit cards, etc., see Payment Methods, 3.3, p. 94).

8.2.6.1. Credit Access: 900Email shall be able to credit Client checking accounts (and credit cards, etc.) to payout scheduled Client Portion earnings (2.15.1, p. 82).

Technical Note—Clients as Customers: Since Clients are also Customers, the 900Email requirements regarding Customer account access (8.2.1, p. 141) shall apply to Clients also.

8.2.7. Undeliverable Funds Bank Account: 900Email shall have electronic access to this external bank account.

8.2.7.1. Credit Access: Whenever an electronic funds transfer ultimately fails (8.4.10, p. 147), whether a payout to a Client's Bank Account, or a Refund to a Customer's Bank Account, then 900Email shall deposit the amount of that undeliverable transfer into our Undeliverable Funds Bank Account.

8.2.7.2. Debit Access: Authorized employees in the 900Email accounting department shall be able to disperse funds from this account:

8.2.7.2.1. Into Undeliverable Funds Accts: to the various Secretary of State's undeliverable funds consolidation accounts as required by law; or,

8.2.7.2.2. To Rightful Owners: to those to whom the money rightfully belongs when we become aware of their current account information; or,

8.2.7.2.3. Back Into Use: to our corporate EPostage Account after a previously Inactive Customer logs back into his account thereby reactivating it (3.14.5, p. 109).

Technical Note—Implementation: The Debit Access requirement for the Undeliverable Funds Bank Account may be initially fulfilled by requiring a manual process of writing a check and making a manual bookkeeping ledger entry for that account; and later fulfilled with the use of our Controlled Transfer Tool (7.7.1, p. 134) for funds transfer.

Business Note—Legislation: Changes in federal and state laws may mandate changes to the Refund Period. If various states have legislated different periods of time before unclaimed funds must be remitted to their state government, then for simplicity sake, 900Email shall use the shortest period required for any of the states, unless we see an offsetting financial benefit to comply on a state-by-state basis.

8.2.8. 900Email Inc. General Bank Account: 900Email shall have access to our external corporate bank account in order to make automatic daily transfers of our Accrued Revenue (8.2.5, p. 143) into our bank account.

8.2.9. Account Security: 900Email shall safeguard system accounts as specified in our General Requirements (see 1.5, p. 32).

8.3. Commissions

900Email shall support the following requirements:

Business Note—Sales Referral: 900Email shall be able to maintain sales information and be able to calculate commissions. The system will track inside and outside salesmen and referral entities (such as third-party websites).

8.3.1. Salesmen: 900Email shall be able to track when a salesman has enlisted a Client or Customer.

8.3.2. Referral Tracking: 900Email shall be able to track when a referring entity (group or website) has enlisted a Client or Customer.

8.3.2.1. Third-Party Sales: When a Client or Customer signs up via a third-party website, 900Email shall attribute that account to that website's URL.

8.3.2.2. Non Web-based Sales.

8.3.2.3. 900Email: When a Client signs up directly apart from a salesman's intervention, 900Email shall attribute the sale to 900Email.com.

8.3.3. Salesman & Referring Entity: 900Email shall be able to keep track of both salesman and referring entity information for each Client and Customer account.

8.3.4. Sales Commissions: 900Email shall be able to calculate sales commissions by tracking revenue based upon which salesman and/or referral entity has enlisted which Clients.

8.3.5. Referral Link: When a Customer or Client signs up, 900Email shall capture the link that he followed to our site, if any, and record it into a Referral Link field.

Technical Note: Affiliations: If the referral link is from a website affiliated with the 900Email strategic marketing plan, then 900Email shall identify that website as the referring entity for that Client or Customer. Most links may arise from websites that we have no partnership agreement with. Marketing will want to see all referral links, regardless of partnership status.

Business Note—Referrals: Use of this functionality depends upon our marketing plan.

8.4. Reliable Funds Transfer

900Email shall support these Reliable Funds Transfer requirements:

Any 900Email utility (calling subroutine, including from the Controlled Transfer Tool (7.7.1, p. 134) shall be able to call upon this RFT feature to reliably and electronically transfer funds:

8.4.1. From Routing Number: The RFT shall allow the calling subroutine to specify a From account Routing Number.

8.4.2. From Account Number: The RFT shall allow the calling subroutine to specify a From Account Number.

8.4.3. Transfer Amount: The RFT shall allow the calling subroutine to specify a Transfer Amount.

8.4.4. To Routing Number: The RFT shall allow the calling subroutine to specify a To account Routing Number.

8.4.5. To Account Number: The RFT shall allow the calling subroutine to specify a To Account Number.

8.4.6. Action on Success: The RFT shall allow the calling subroutine to specify whether it requires notification of a successful funds transfer.

8.4.7. Action on Failure: The RFT shall allow the calling subroutine to specify what action it should take on failure:
8.4.7.1. Retries Number: The RFT shall allow the calling subroutine to specify the number of retries that the RFT shall make in attempting to electronically transfer funds.
8.4.7.2. Retries Number Default: The RFT shall default to a single retry if not specified by the calling subroutine.
8.4.7.3. Retry Number Range: While the default value is one retry, the RFT accepts numbers in the range of 0 to 50.
8.4.7.4. Retries Delay: For each retry of the transfer, the RFT allows the calling subroutine to specify the delay, in seconds before attempting that retry.
8.4.7.5. Retries Delay Default: The RFT shall default to a retry delay of whatever the delay on the previous retry was plus 1 second (so that the default delay for each retry increa8.4.7.6.ses by one second for each successive attempt).
8.4.7.7. Retry Delay Range: The valid Retry Delay range varies from 1 millisecond up to one month (specified in seconds).
8.4.7.8. Retry Failure Notification: The RFT shall allow a calling subroutine to specify whether to notify it of the failure of each transfer retry.
8.4.7.9. Notify User Only: Upon failure of an initial attempt to transfer funds, the RFT shall do nothing but notify the calling subroutine of that failure; or,
8.4.7.10. Notify & Retry: Upon any failure to transfer funds, the RFT shall notify the calling subroutine of the failure of the first transfer attempt and retry the transfer according to the above requirements (8.4.1 to 8.4.7); or,
8.4.7.11. Retry Without Notification: Upon any failure to transfer funds, the RFT shall retry the transfer according to the above requirements (8.4.7.1 to 8.4.7.11) without notifying the calling subroutine.

8.4.8. Parameters Out of Range: The RFT shall be able to trigger a Program Logic Error Alarm (7.3.5, p. 128) if any parameter values (8.4.1 to 8.4.7) are of the wrong data type or are out of range.

8.4.9. Attempt the Transfer: The RFT shall attempt the transfer of the funds between Bank Accounts as specified above.

8.4.10. Transfer Ultimately Fails: In the case of a failure of the electronic funds transfer, the RFT shall take whatever action the calling subroutine has specified in section 8.4.7.

8.4.11. Transfer Successful: The RFT shall notify the calling subroutine of the successful transfer if so requested (8.4.6).

8.4.12. Currency Conversion: If our banking institution performs automatic currency conversion, then RFT shall report back to the calling subroutine the actual conversion amount.

8.5. Automatic Replies

900Email shall support these Automatic Replies requirements:

Technical Note—Utility: This section describes a utility function required by our business logic. This service will be called upon by various 900Email subroutines. By supporting the following requirements, 900Email shall provide a robust Automatic Reply service that is customizable to meet the needs of various subroutines to send out their automated messages.

8.5.1. HTML in Email Text: This 900Email Automatic Reply service shall support HTML code within Email text:
8.5.1.1. only if the original message to which we are replying was HTML-enabled (otherwise all replies shall contain only plain text);
8.5.1.2. enabling hyperlinks to web pages;
8.5.1.3. enabling mailto; and,
8.5.1.4. enabling all other standard HTML functionality.

8.5.1.5. Mailto: If the underline highlights an Email ID, clicking on that ID will automatically execute a mailto: command by opening up a Send New Email window with that Email ID in the To: field.

Technical Note—Underlines: In this Requirements Document, underlined words in emails, web pages, and screen shots typically refer to hyperlinks that link to the appropriately corresponding web pages. This assumes implementation of this HTML in Email Text requirement.

8.5.2. Original Message Intact: Whenever sending an Automated Reply to a Customer, whether with a Refund or with an Insufficient Funds notice, 900Email shall return the original Email message along with the reply.

Technical Note—Attachments: When 900Email returns an original Email message back to a sender, that return message includes the entire message, wholly intact, including any attachments.

8.5.3. Retries: Whenever an Automated Reply is returned by a Mailer Daemon due to an Email account cancellation, a server failure, an Internet routing failure, etc., 900Email shall support the following Retries requirements:

8.5.3.1. Second Attempt: When 900Email receives an incoming Email message whose envelope header information indicates that an Automatic Reply failed to reach its destination, then 900Email shall resend that same Automatic Reply one minute later.

8.5.3.2. Third Attempt: If the Reply again returns undeliverable and is recognized as having already been sent twice, 900Email shall then resend it one hour later.

8.5.3.3. Fourth Attempt: If the Reply again returns undeliverable and is recognized as having already been sent three times, 900Email shall resend it one day later.

Technical Note—Returned Message Database: To resend undeliverable messages as requested here requires maintenance of an Undeliverable Messages database consisting of transient records that shall forever disappear without record of their existence after 24 hours.

8.5.3.4. Quit: If after 24 hours, the reply returns undeliverable again, 900Email shall end the process of attempted re-delivery by deleting its record of the original message and its attempted retries.
8.5.3.5. Business Rule—Automatic Reply Retries Number: Management shall be able to change the number of retries that the system shall make when an Automatic Reply is returned as undeliverable. Initial value: 4.
8.5.3.6. Business Rule—Automatic Reply Retries Delay: For each retry of an Automatic Reply, management shall be able to set the time delay before 900Email shall make that retry. Initial value: See 8.5.3.1 through 8.5.3.3.

8.5.4. Insufficient EPostage Standard Reply

900Email shall support these Automatic IEP Standard Reply requirements:

Technical Note—When to Send an IEP: When a sender has provided no EPostage, or only Insufficient EPostage, and the recipient has not Prepaid for delivery of his message, then our business logic requires 900Email to Automatically Reply.

Example—WWII Vet: A WWII veteran sends to his favorite author an account of a battle he fought in. If he does not provide for the required EPostage, and if the Client did not customize his Automatic Reply, then the vet shall receive a Reply Subject as follows:
8.5.4.1. Business Rule—IEP Standard Reply Subject: Management shall be able to change the Subject text of the automatic reply sent to the Customer who sends an Email message that has Insufficient EPostage available. Initial value:
“I haven't yet received your Email message. -FamousAuthor@900Email”.

Technical Note—Signed with Client's ID: Notice that the Client's own 900Email ID is appended to the message subject line.
8.5.4.2. Business Rule—IEP Standard Reply Non-Customer Body: Management shall be able to change the Body text of the automatic reply sent to the non-Customer who sends an Email message that has Insufficient EPostage available. Initial value: see 8.5.4.3.

8.5.4.3. IEP Standard Reply Non-Customer Actual Body: reads as follows:

Body: Dear [sender's Email ID], I am looking forward to reading your Email message, but I haven't received it yet. So that I can devote more attention to important email like yours, I am filtering out junk mail by charging a postage fee. The required postage for my account is [insert the Client EPostage Rate; this example uses:] $25 for an incoming email message. 900Email.com enables you to get control over your email inbox by requiring EPostage on all incoming messages. If you want to send your current Email message to me, please affix $25 of EPostage, and I promise I shall read your mail. (After all, if you value your mail enough to apply EPostage to it, that tells me that it must be worthwhile!) Thank you, -FamousAuthor@900Email.com

[One blank line]

Click here to purchase $25 of EPostage to send this message to FamousAuthor, or click here for more information (4.4.2, p. 117) about 900Email.com.
8.5.4.4. Business Rule—IEP Standard Reply Customer Body: Management shall be able to change the text of the Insufficient EPostage Reply Customer Body text. Initial value: see 8.5.4.3.

8.5.4.5. IEP Standard Reply Customer Actual Body: reads as follows:

Body: Dear [Customer's Email ID], I am looking forward to reading your Email message, but I haven't received it yet. As you know, my 900Email account enables me to filter out junk mail by charging a postage fee. My account requires [insert the Client EPostage Rate; this example uses:] $25 of EPostage for an incoming email message. If you want to send your current Email message to me, please affix $25 of EPostage, and I promise I shall read your mail. (After all, if you value your mail enough to apply EPostage to it, that tells me that it must be worthwhile!) Thank you, -FamousAuthor@900Email.com

[One blank line]

Click here to purchase $25 of EPostage to send this message to FamousAuthor.

Technical Note—Signed with Client's ID: Notice that the Client's own 900Email ID is appended to the message body of both the Customer and non-Customer IEP replies.

8.5.4.5.1. Click to Purchase: When a sender responds to an IEP by clicking to purchase EPostage, 900Email shall redirect his browser differently based on whether he already has an EPostage account or not.

8.5.4.5.1.1. Existing Customer: When one of our existing Customers responds to an IEP, 900Email shall redirect his browser to his own EPostage Account (4.4.3, p. 117).

Technical Note—Customize his Page: Directing the sender to his EPostage Account, he will be required to enter his username and password, and when we display his account page, it shall be customized for this link to indicate: “To send your message to FamousAuthor purchase $25 of EPostage.”

8.5.4.5.1.2. Non-Customer: When a non-Customer responds to an IEP, 900Email shall redirect his browser to our Customer Sign Up Account.

Technical Note—Customize Sign Up Page: Directing the sender to our Customer Sign Up page, he will be required to enter his payment information like name, credit card number (checking account, etc., 3.3, p. 94), billing address. However, that standard page shall be customized for this link to indicate: “To send your message to FamousAuthor purchase $25 of EPostage.”

8.5.4.6. IEP Reply FROM Field: The Automatic Reply (whether standard or custom) for Insufficient EPostage originates from the Client's own Email ID account.

Business Note—IEP Reply Origination: The reply for Insufficient EPostage should originate from the Client's own ID to add credibility to the marketing offers contained in the reply. And logically, this Automatic Reply should originate from the Client's account, since his own sender-pays Email account requires this intrinsic function to succeed in the marketplace.

8.5.5. Insufficient EPostage Custom Reply

900Email shall support these Automatic IEP Custom Reply requirements:

8.5.5.1. Custom IEP Reply: 900Email shall enable a Client to modify or completely replace the standard reply with his own words.

8.5.6. Reply Format

900Email shall format all Automated Email messages (replies) according to the following requirements, unless specified otherwise.

Technical Note—Shared Format: Generally, all messages sent out by the system without human intervention shall have the same format, whether a Refund on Timeout Reply (2.16.5, p. 87), an Insufficient EPostage Reply, etc. An automated message that is initiating a communication rather than responding to one (such as a Credit Card Expiration Date is Approaching Reply, 3.3.8, p. 94), will therefore not be returning an Original Message, and so, in that circumstance, 900Email can ignore requirement.

8.5.7. Invalid EStamp Reply

900Email shall support these Invalid EStamp Reply requirements:

8.5.7.1. Send an Invalid EStamp Reply: If we have found an EStamp that cannot be validated, then 900Email shall issue to the sender an Insufficient EPostage Reply (IEP) modified as follows.

8.5.7.2. Replace IEP Subject: In the case of an Invalid EStamp, 900Email shall replace the Subject Line of the automatic IEP Reply (whether standard or custom) with this subject:
8.5.7.3. Business Rule: Invalid EStamp Reply Subject—Management shall be able to change the text of the Invalid EStamp Reply subject line. Initial value:
“Your email to ClientID@900Email.com had an invalid EStamp”.
8.5.7.4. Business Rule—Invalid EStamp Reply Preface: Management shall be able to change the text of the Invalid EStamp Reply Preface text. Initial value: see 8.5.7.5.

8.5.7.5. Reply Preface: In the case of an invalid EStamp, 900Email shall preface the Body of the Automatic Reply with this paragraph:

“The [Estamp 0.50¢ Y5vi] is invalid. If you copied it incorrectly, please feel free to recopy the correct EStamp to the beginning of the first line of your message and resend it. (If you included You should be able to find.) The rest of this message explains our email system more fully and contains your original message. Thank you, -900Email.com.”

8.5.7.6. Append Original Subject: The Subject Line of the automatic IEP Reply that was replaced with our Invalid EStamp Reply Subject will now be appended after one blank line to the preface just added.

8.5.7.7. Invalid EStamp Reply FROM Field: 900Email shall send this Reply From: Service@900Email.com.

8.5.8. Refund on Timed-Out Reply

900Email shall support these Refund on Timeout Reply requirements: Technical Note—Refund Events: Various conditions can trigger a Refund Event, such as an incoming Email message not being retrieved throughout the Refund Period (2.16.1, p. 86), an Email message being deleted by the Client without having been Retrieved, a Client requesting a Refund for a particular sender (2.16.7, p. 88), and an un-retrieved message being deleted as a result of an account termination (2.16.6, p. 88). 900Email shall notify the sender of these Refund Events with Automatic Replies tailored to the cause of the Refund. A Refund is typically recorded (credited) to a Customer's (Internal) EPostage Account (8.2.3, p. 142).

8.5.8.1. Timed-Out: When a Client allows an incoming Email message to timeout without ever having Retrieved it, 900Email shall send an automatic Refund on Timeout Reply to the Customer whose message was never read.

Example—Rapper: A rapper has not retrieved an inbox message for so long that the Refund Period has expired (3 months). All Customers whose Email messages expired shall receive a Refund on Timeout Reply.
8.5.8.2. Business Rule—Refund on Timed-Out Reply Subject: Management shall be able to change the Refund on Timeout Reply subject line. Initial value: “Your refund for your email to Rapper@900Email.com”.
8.5.8.3. Business Rule—Refund on Timed-Out Reply Body: Management shall be able to change the Refund on Delete Reply Body text. Initial value: see 8.5.8.4.

8.5.8.4. Refund on Timeout Reply Actual Body: reads as follows:

Body: Below, please find the message that you sent to Rapper@900Email.com back on [Mon. Day, Year, for this example:] Apr. 5, 2002. 900Email apologizes that your message was never read. We have automatically deleted it out of Rapper's inbox. Therefore, we have refunded your EPostage for that message to you and have credited it back to your EPostage Account. Sincerely, Service@900Email.com

[One blank line]

Sending a reply to this message shall address your response to our Service@900Email.com account which charges 0.05¢ EPostage to receive an Email message. Or click for more information about 900Email.com.

8.5.8.5. Refund on Timeout Reply FROM Field: 900Email shall send a Refund on Timeout Reply From: Service@900Email.com.

8.5.9. Refund on Delete Reply

8.5.9.1. Deleted: When a Client deletes an incoming Email message without ever having Retrieved it, 900Email shall send an automatic Refund on Delete Reply to the Customer whose message was never read.

Example—Ex-Husband: An ex-husband sends an email with sufficient EPostage to his former wife. She noticed the return Email ID and deleted the message without reading it. That Customer shall receive a Refund on Delete Reply.
8.5.9.2. Business Rule—Refund on Delete Reply Subject: Management shall be able to change the Refund on Delete Reply subject line. Initial value: “Your refund for your email to FormerWife@900Email.com”.
8.5.9.3. Business Rule—Refund on Delete Reply Body: Management shall be able to change the Refund on Delete Reply Body text. Initial value: see 8.5.9.4.

8.5.9.4. Refund on Delete Reply Actual Body: reads as follows:

Body: Below, please find the message that you sent to BigStar@900Email.com. 900Email apologizes that your message was not read but rather, was deleted by the recipient. Therefore, we have refunded your EPostage for that message to you and have credited it back to your EPostage Account. Sincerely, President@900Email.com

[One blank line]

Sending a reply to this message shall address your response to our Service@900Email.com account which charges 0.05¢ EPostage to receive an Email message. Or click for more information about 900Email.com.

8.5.9.5. Refund on Delete Reply FROM Field: 900Email shall send a Refund on Delete From: Service@900Email.com.

Business Note—Refunds vs. IEP FROM Fields: Notice that the Automatic Reply for the most of the Refunds originate from Service@900Email.com rather than from the Client's own Email ID account. Refund Automatic Replies generally should not originate from the Client's account for two reasons. First, they contain an apology made not by the Client but by 900Email. Second, if the Client intentionally ignored or deleted an unwanted message, replying in the name of, or even just from the account of, that Client might confuse the Customer and would misrepresent the circumstances. Thus, while the IEP Reply should originate from the Client's own Email ID, most Refund Replies should not. The exception to this is the Refund by Request, which Automated notification message originates from the Client's Email ID, since the Client in actuality originated that refund.

8.5.10. Refund by Request Reply

900Email shall support these Refund by Request Reply requirements:

8.5.10.1. Requested: When a Client Requests a Refund be sent to a Customer regarding a particular Email message, (4.3.9, p. 117), 900Email shall send an automatic Refund by Request Reply to the Customer receiving the refund.

Example—Talk Show Host: A talk show host receives an email message from a

FormerFirstLady@SomeISP.com and realizes that she paid his Public Tier rate in order to get the message to him. The talk show host then requests that we refund her EPostage to her, and so we also send this automated reply.
8.5.10.2. Business Rule—Refund by Request Reply Subject: Management shall be able to change the Refund on Timeout Reply subject line. Initial value: “TalkShowHost@900Email.com has refunded your EPostage to you”.
8.5.10.3. Business Rule—Refund by Request Reply Body: Management shall be able to change the Refund on Request Body text. Initial value: see 8.5.10.4.

8.5.10.4. Refund by Request Reply Actual Body: reads as follows:

8.5.10.4.1. Body: BigStar@900Email.com has refunded the EPostage funds you paid to email him a message back on [Mon. Day, Year, for this example:] Apr. 5, 2002. Sincerely, President@900Email.com

8.5.10.4.2. [One blank line]

8.5.10.4.3. [One blank line]

8.5.10.4.4. Sending a reply to this message shall address your response to our Service@900Email.com account which charges 0.05¢ EPostage to receive an Email message. Or click for more information about 900Email.com.

8.5.10.4.5. Refund by Request FROM Field: 900Email shall send a Refund on Timeout Reply From: BigStar@900Email.com.

8.5.11. Refund on Account Closure Reply

900Email shall support these Refund on Account Closure Reply requirements:

8.5.11.1. Closed: 900Email shall Refund the EPostage on any un-accessed messages remaining in an Account when that account is closed (2.19, p. 90).
8.5.11.2. Business Rule—Refund on Account Closure Reply Subject: Management shall be able to change the Refund on Account Closure subject line. Initial value:
“Your refund for your email to DeceasedCelebrity@900Email.com”.
8.5.11.3. Business Rule—Refund on Account Closure Reply Body: Management shall be able to change the Refund on Account Closure Reply Body text. Initial value: see 8.5.11.4.

8.5.11.4. Refund on Account Closure Reply Actual Body: reads as follows: Body: Below, please find the message that you sent to BigStar@900Email.com back on [Mon. Day, Year, for this example:] May 15, 2002. We apologize that your Email message had never been read. This account has just been closed, so we have refunded your EPostage for that message to you, and have credited it back to your EPostage Account. Sincerely, Service@900Email.com

[One blank line]

Sending a reply to this message shall address your response to our Service@900Email.com account which charges 0.05¢ EPostage to receive an Email message. Or click for more information about 900Email.com.

8.5.11.5. Refund on Account Closure Reply FROM Field: 900Email shall send a Refund on Timeout Reply From: Service@900Email.com.

8.5.12. External Refund Failed Message: 900Email shall support these External Refund Failed automatic message requirements:

Technical Note—Refund Failed: When 900Email is not able to make an actual funds transfer into a Customer's physical bank account (for a Refund) then the following Automatic Message will be sent.
8.5.12.1. Business Rule—External Refund Failed Message Subject: Management shall be able to change the External Refund Failed Message subject line. Initial value:
“Our attempt to Refund money to you has failed. Please help us . . . ”
8.5.12.2. Business Rule—External Refund Failed Message Body: Management shall be able to change the External Refund Failed Message Body text. Initial value: see 8.5.12.3.

8.5.12.3. External Refund Failed Message Actual Body:

Body: Dear [Customer Name, not Email ID, but use FirstName LastName],

We have tried but failed to make an electronic funds transfer into your account in order to refund $n.nn to you. Our record of your financial information may be out of date. If you could please take a moment to update your 900Email EPostage account information, we would be happy to retry the refund. You can help us by following these steps:
1. Log in to your 900Email Customer account
2. Go to your account Profile
3. Click on “Financial Information”
4. Choose the radio button next to the account you would like to update and click ‘Edit’
5. Enter your up-to-date account information
6. Click ‘Save’

Click here to get started:
https://900Email.com/MyEPostage

Thank you,

900Email.com

Protect Your Password

NEVER give your password to anyone and ONLY log in at 900Email.com. If anyone asks for your password, please follow the Security Tips instructions at 900Email.com.

8.5.12.4. Click-able Refund Amount: If the Customer clicks on the Refund Amount, $n.nn, 900Email shall redirect his browser to a page which explains the cause of the current refund (4.4.4, p. 1117).

8.5.12.5. External Refund Failed Message FROM Field: 900Email shall send an External Refund Failed Message From: Service@900Email.com.

8.5.13. Payout Message

8.5.13.1. Successful Payout: When we have successfully transferred Payout funds into a Client's physical bank account (on a monthly, quarterly, or annual run), 900Email shall send an Automatic Message to the Client informing him of his Payout.
8.5.13.2. Business Rule—Payout Message Subject: Management shall be able to change the Payout Message subject line. Initial value:
“900Email has transferred your Payout to your account”.
8.5.13.3. Business Rule—Payout Message Body: Management shall be able to change the Payout Message Body text. Initial value: see 8.5.13.4.

8.5.13.4. Payout Message Actual Body: reads as follows:

8.5.13.4.1. Body: Dear [FirstName LastName], we have transferred your current Payout amount of $4nn.nn into your checking account on [Mon. Day, Year, for this example:] Jul. 19, 2002. Thank you so much for doing business with us. We hope we are helping to meet your communication needs. Sincerely, ArtRisley@900Email.com

8.5.13.4.2. [One blank line]

8.5.13.4.3. Sending a reply to this message shall address your response to our Service@900Email.com account which charges 0.05¢ EPostage to receive an Email message. Or click for more information about 900Email.com.

Business Note—Checking Account Security: We will not plainly indicate both the date and amount of an electronic transfer in an unencrypted Email transmission. If an unauthorized person attempts to get account information from a Customer's bank via the telephone, the bank will attempt to authenticate the identity of the caller. Some financial institutions will ask for date and amount of a recent deposit as corroborating evidence for the caller's identify. Thus, 900Email will not clearly spell out the amount of a deposit but will only indicate the magnitude in this manner, $4nn.nn, or $2.nn, or $8,nnn,nnn.nn.

8.5.13.5. Payout Message FROM Field: 900Email shall send a Payout Message From: Service@900Email.com.

8.5.13.6. Payout Attempt Failed Message: 900Email shall support these Payout Attempt Failed automatic message requirements:

Technical Note—Payout Failed: When 900Email is not able to make an actual funds transfer into a Client's physical bank account (for a scheduled Payout) then the following Automatic Message will be sent.
8.5.13.6.1. Business Rule—Payout Attempt Failed Message Subject: Management shall be able to change the Payout Attempt Failed Message subject line. Initial value:
“Our attempt to pay you has failed. Please help us . . . ”
8.5.13.6.2. Business Rule—Payout Attempt Failed Message Body: Management shall be able to change the Payout Attempt Failed Message Body text. Initial value: see 8.5.13.6.3.

8.5.13.6.3. Payout Attempt Failed Message Actual Body:

Body: Dear [Customer Name, not Email ID, but use FirstName LastName],

We have tried but failed to make an electronic funds transfer into your account in order to pay you the [insert amount of Payout, for this example:] $27.92 that we owe you. Our record of your financial information may be out of date. If you could please take a moment to update your 900Email EPostage account information, we would be happy to retry the refund. You can help us by following these steps:
1. Log in to your 900Email Customer account
2. Go to your account Profile
3. Click on “Financial Information”
4. Choose the radio button next to the account you would like to update and click ‘Edit’
5. Enter your up-to-date account information
6. Click ‘Save’

Click here to get started:
https://900Email.com/MyEPostage

Thank you,

900Email.com

Protect Your Password

NEVER give your password to anyone and ONLY log in at 900Email.com. If anyone asks for your password, please follow the Security Tips instructions at 900Email.com.

8.5.13.6.4. Click-able Payout Amount: If the Customer clicks on the Payout Amount [in the example above, $27.92], 900Email shall redirect his browser to a page which shows his EPostage Account history which indicates all the recent credits and debits to his EPostage Account (4.4.3, p. 117).

8.5.13.6.5. Payout Attempt Failed Message FROM Field: 900Email shall send a Payout Attempt Failed Message From: Service@900Email.com.

8.5.14. Credit Card Expiring Message

900Email shall support these Credit Card Expiring (3.3.8, p. 94) Automatic Reply requirements:
8.5.14.1. Business Rule—Credit Card Expiring Message Subject: Management shall be able to change the text of the Credit Card Expiring Message subject line. Initial value:
“Your Credit Card expiration date is approaching. -Service@900Email.com”.
8.5.14.2. Business Rule—Credit Card Expiring Message Body: Management shall be able to change the text of the Credit Card Expiring Message Body text. Initial value: see 8.5.14.3.

8.5.14.3. Credit Card Expiring Actual Body: reads as follows:

Body: Dear [Customer Name, not Email ID, but use FirstName LastName],

Your credit card ending in 9999 [last 4 digits] will expire soon.

To avoid any interruption to your service including the ability to send messages to 900Email accounts, please update your credit card information. You can either provide us with a new credit card, or give us the updated expiration for your existing card, by following these steps:
1. Log in to your 900Email Customer account
2. Go to your account Profile
3. Click on the ‘Credit Card’ link in the Financial Information column
5. Choose the radio button next to the credit card you would like to update and click ‘Edit’
6. Enter your credit card verification number (the last 3 digits on the back of the card) [900Email Internal Note: This verification number helps to protect against theft of card numbers from transaction slips since most such records do not include these numbers, and therefore a thief would need the physical card to know this number.]
7. Enter the [new] credit card [information and/or] expiration date
8. Click ‘Save’

Click here to get started:
https://900Email.com/CREDITCARD

Thank you,

900Email.com

Protect Your Password

NEVER give your password to anyone and ONLY log in at 900Email.com. If anyone asks for your password, please follow the Security Tips instructions at 900Email.com.

8.5.14.4. Credit Card Expiring Message FROM Field: 900Email shall send a Payout Message From: Service@900Email.com.

8.5.15. Payment Due Message

900Email shall support these Payment Due (2.18.3, p. 89) automatic message requirements:

8.5.15.1. Payment Due Message: When a Client's EPostage Account is in arrears, if he attempts to log on to his Email account, instead of his inbox, he sees his Payment Due Inbox, which initially contains only a single Email message in which 900Email shall indicate:
8.5.15.2. Business Rule—Payment Due Message Subject: Management shall be able to change the Payment Message subject line. Initial value: “900Email has transferred your Payment to your account”.
8.5.15.3. Business Rule—Payment Due Message Body: Management shall be able to change the Payment Message Body text. Initial value: see 8.5.15.4.

8.5.15.4. Payment Message Actual Body: reads as follows:

8.5.15.4.1. Body: Dear [FirstName LastName], your 900Email account is Inactive with an outstanding balance due of $13.25. You can pay this balance from your EPostage Account web page or by calling our Customer Service at 800-900Email. While your account remains inactive, all new incoming messages will be returned as undeliverable. However, your inbox currently has [number of un-accessed inbox messages] 4 new messages and [number of inbox messages that have already been retrieved] 15 old messages, and as soon as you bring your account current, these will become available to you again. However, if your account closes after expiration of the current grace period, then all new messages will be returned, the EPostage refunded to the senders and you will not be able to collect your Client Portion revenue from those messages. If we do close the account, then all messages will be permanently deleted. We hope to avoid that, and keep you as a satisfied Client. Thank you for allowing us to serve you. Sincerely, Service@900Email.com

8.5.15.4.2. [One blank line]

8.5.15.4.3. Sending a reply to this message shall address your response to our Service@900Email.com account which charges 0.05¢ EPostage to receive an Email message. Thus, to reply to this message via email, you first will need to bring your account current. Click for more information about 900Email.com.

8.5.15.5. Payment Due Message FROM Field: 900Email shall send a Payment Due Message From: Service@900Email.com.

8.5.16. Reactivate Timed-Out Account Message

900Email shall support these Reactivate Timed-Out Account (2.18.5.2, p. 90) automatic message requirements:

8.5.16.1. Reactivate Timed-Out Account Message: When a Client has neglected his Email Account long enough that it has been marked Inactive (2.18.4, p. 89), if he attempts to log on to his Email account, instead of his inbox, he sees his Reactivate Timed-Out Account Inbox, which initially contains only a single Email message in which 900Email shall indicate:
8.5.16.2. Business Rule—Reactivate Timed-Out Account Message Subject: Management shall be able to change the Reactivate Timed-Out Account Message subject line. Initial value:
“We have marked your Email account inactive. To reactivate it . . . ”.
8.5.16.3. Business Rule—Reactivate Timed-Out Account Message Body: Management shall be able to change the Reactivate Timed-Out Account Message Body text. Initial value: see 8.5.16.4.

8.5.16.4. Reactivate Timed-Out Account Message Actual Body: reads as follows:

8.5.16.4.1. Body: Dear [FirstName LastName], you last checked your Email account on [Month Day, Year, for e.g.:] Aug. 21, 2002. Therefore, we have marked your account inactive. While your account remains inactive, all new incoming messages will be returned as undeliverable. To reactive your account, simply send a message to us at ReactivateAccount@900Email.com from this mailbox. This will automatically reactivate your account and give you access to the [number of new messages in his inbox] 2 new messages in your inbox and the [number of old messages] 7 old messages. Your EPostage balance is $n.nn. However, if your account closes after expiration of the current grace period, then all new messages will be returned, the EPostage refunded to the senders and you will not be able to collect your Client Portion revenue from messages you have not accessed. If we do close the account, then all messages will be permanently deleted. We hope to avoid that, and keep you as a satisfied Client. Thank you for allowing us to serve you. Sincerely, Service@900Email.com

8.5.16.5. Reactivate Timed-Oit Account Message FROM Field: 900Email shall send a Payment Due Message From: Service@900Email.com.

8.5.17. EPostage Rate Request Reply Format: 900Email shall support the following Rate Request (3.9.4, p. 100) replies for requests for a single, or for multiple, rates:
8.5.17.1. Business Rule—Rate Request Reply Subject: Management shall be able to change the Rate Request Reply subject line. Initial value: see ______
8.5.17.2. Business Rule—Rate Request Reply Body: Management shall be able to change the Rate Request Reply Body. Initial value: see ______.

8.5.18. Guaranteed Reply IEP Reply: If a sender requests a Guaranteed Reply but has Insufficient EPostage to pay for that service, 900Email shall send an Automatic Reply to that Client indicating the following:
8.5.18.1. Business Rule—Guaranteed Reply IEP Subject: Management shall be able to change the Subject text of the Automatic Reply sent to the Customer who sends an Email message that has Insufficient EPostage available. Initial value: “I haven't yet received your Email message. -BigStar@900Email”.
8.5.18.2. Business Rule—Guaranteed Reply IEP Non-Customer Body: Management shall be able to change the Body text of the Automatic Reply sent to the non-Customer who sends an Email message requesting a Guaranteed Reply, but with Insufficient EPostage available. Initial value: see 8.5.18.3.

8.5.18.3. Guaranteed Reply IEP Non-Customer Actual Body: reads as follows:

Body: Dear [sender Email ID], I am looking forward to reading and replying to your Email message, but I haven't received it yet. So that I can devote more attention to important requests like yours, I am filtering out junk mail by charging a postage fee of [insert the Client EPostage Rate; this example uses:] $25 for all incoming email, or a fee of [insert the Client Guaranteed Reply Rate, this example uses:] $100 to guaranteed that I will reply to you personally. If you want to get a reply to your current Email message, please affix [appropriate rate] $100 of EPostage, and I promise I shall reply to your mail. (After all, if you value your mail enough to apply EPostage to it, that tells me that it must be worthwhile!) Thank you, -BigStar@900Email.com

[One blank line]

Click here to purchase $125 of EPostage to send this message to FamousAuthor, or click here for more information (4.4.2, p. 117) about 900Email.com.
8.5.18.4. Business Rule—Guaranteed Reply IEP Customer Body: Management shall be able to change the Body text of the Automatic Reply sent to the Customer who sends an Email message requesting a Guaranteed Reply, but with Insufficient EPostage available. Initial value: see 8.5.18.5.

8.5.18.5. Guaranteed Reply IEP Customer Actual Body: reads as follows:

Body: Dear [Customer's Email ID], I am looking forward to reading and replying to your Email message, but I haven't received it yet. As you know, my 900Email account enables me to filter out junk mail by charging a postage fee and an additional Guaranteed Reply fee. My account requires [insert the Client EPostage Rate; this example uses:] $25 of EPostage for delivery of an incoming email message, and an additional fee of [insert the Client Guaranteed Reply Rate, this example uses:] $100 to guaranteed that I will reply to you personally. If you want to get a reply to your current Email message, please affix [insert the total of the EPostage and Reply rates] $125 of EPostage, and I promise I shall reply to your mail. (After all, if you value your mail enough to apply EPostage to it, that tells me that it must be worthwhile!) Thank you, -BigStar@900Email.com

[One blank line]

Click here to purchase the EPostage required to send this message to BigStar.

Technical Note—Signed with Client's ID: Notice that the Client's own 900Email ID is appended to the message body of both the Customer and non-Customer Guaranteed Reply IEP replies.

9. Email Kernel Wrapper

900Email shall operate by way of a Wrapper around our Email Kernel (MS Exchange or otherwise) according to the following requirements:
Wrapper Reliability: atomic transaction processing and support for different Email access platforms
Incoming Mail: 900Email gets control over every incoming Email before it reaches the engine
StoredMail Mail: notifies 900Email when a stored Email message is retrieved by the Client
Performance: the wrapper implementation is designed to maximize message handling speed
   9.1. General Wrapper Requirements

900Email shall support these General Wrapper requirements:

9.1.1. Multiple Email Engines: The Kernel wrapper shall operate on two different Email server engines.

9.2. Wrapper Reliability

900Email shall support these Wrapper Reliability requirements:

9.2.1. Resource Manager: The wrapper will turn our Email server engine into a Resource Manager supporting the needs of our Transaction Processing server.

Technical Note—See 8.1. Transaction Processing: See the note at 8.1, p. 137 which explains our need for Transaction Processing to maintain integrity between our EPostage and Email accounts.

9.2.1.1. Incoming Transaction: The Wrapper shall communicate with the Transaction Processor to inform it of the successful or unsuccessful save of an incoming Email message into a Client's inbox.

9.2.1.2. Roll Back Incoming Save: Depending upon the implementation of the Transaction Processor, the Wrapper may be required to roll back (delete) an Email message that has just been saved into a Client's inbox.

9.2.2. POP3/IMAP4 Clients: The StoredMail events (below) shall fire reliably whenever email is viewed or accessed via a desktop email client such as MS Outlook Express.

Technical Note—Repetition & Ports: These events fire every time a message is retrieved (viewed or downloaded, whether deleted or not) from the server. These events track POP3 activity on port 110 and IMAP4 activity on port 143.

9.2.3. HTTP/WebDAV Clients: The StoredMail events (below) must fire reliably whenever email is viewed or accessed via a web-based email client such as Outlook Web Access (OWA).

Technical Note—Repetition & Ports: These events fire every time a message is retrieved (viewed or downloaded, whether deleted or not) from the server. These events track HTTP activity on port 80.

9.3. Incoming Functionality

900Email shall have access to every Email message attempting to enter our system prior to it arriving at the email engine:

9.3.1. InMail Interface

900Email shall support these InMail Interface requirements:

9.3.1.1. InMail API: The name of the interface and its associated methods shall be:
9.3.1.1.1. IKernelInMailEvents
9.3.1.1.2. OnInMailEvent( )

9.3.1.2. Protocols: The OnInMailEvent( ) method shall support the following protocols:
9.3.1.2.1. SMTP
9.3.1.2.2. X400
9.3.1.2.3. MAPI
9.3.1.2.4. Etcetera: 900Email shall perhaps support more protocols not yet identified.

9.3.1.3. Message Access: The OnInMailEvent( ) method shall provide access to all email content including the From:, To:, Subject:, Body, and any Attachments.

Technical Note—Business Logic: 900Email components will require the ability to verify that the sender has an EPostage account with sufficient postage, that the intended recipients have valid 900Email system accounts, that the subject of the mail can be modified when replying to the sender during error conditions, that the body of the message can be prefixed or appended with text from the 900Email system, that attachments are accessible, etc.

9.3.1.4. Expand Groups: The OnInMailEvent( ) method shall provide the expanded contents of the To: field (and also the CC and the BCC fields) whenever groups are used so that 900Email shall be able to examine each of the individual recipients.

Business Note—Per Recipient: 900Email business logic requires that we verify each intended recipient as having a legitimate 900Email Client account, and we must determine EPostage rates based upon individual Client account settings.

Technical Question—Transport or Protocol: Regarding the need to expand the email group names, does this imply implementation as a transport event or a protocol event? This expansion is something that Exchange (or another server) would do on its own. Does this raise questions that we should consider? Also, is it at this level that 900Email supports the high-level requirement for allowing free passage of Mailer Daemon messages (2.14.2, p. 81) which inform our Clients when they send out misaddressed Email messages?

9.3.1.5. Abort Processing: The OnInMailEvent( ) method shall allow the programmer to return a value that aborts all subsequent processing of an email through the system.

Technical Note—Insufficient EPostage: 900Email business logic will use this event to reject emails from senders who do not have a 900Email EPostage account or when Insufficient EPostage is detected.

9.3.2. InMail Security Event Interface

900Email shall support these InMail Security Event Interface requirements:

9.3.2.1. InMail Security Event API: The name of the interface and its associated methods shall be:
9.3.2.1.1. IKernelInMailSecurityEvents
9.3.2.1.2. OnInMailSecurityEvent( )

9.3.2.2. Pure Relay: The OnInMailSecurityEvent( ) method shall fire whenever a pure TO envelope relay is detected where the From envelope is a non-900Email system Domain.

Technical Note—Pure Email Relaying: The word “pure” indicates that the sender is not from a 900Email domain and none of the recipients listed in the TO field reside at a 900Email domain. 900Email will have SMTP pure email relaying turned off (to prevent hackers residing on other systems from using our server to send spam). If any sender lists two people in the TO: field, one a Client at 900Email.com, and another at AOL.com, we will always accept this type of relay, since it likely represents valid usage. Whenever a Pure Relay event fires the OnInMailSecurityEvent( ), 900Email shall send a message to Logistics that the email server (MS Exchange?) is not set up correctly, and that Relaying must be switched off. [This is in case Logistics makes a mistake and administers this function incorrectly by turning Relaying on.]

9.3.2.3. SMTP FROM Forgery: The OnInMailSecurityEvent( ) method shall fire whenever the SMTP FROM envelope does not match the SMTP FROM header.

9.3.2.4. SMTP Received Forgery: The OnInMailSecurityEvent( ) method shall fire whenever a DNS forgery is detected in the SMTP Received: header.

9.3.2.4.1. Reverse Lookup: 900Email shall need to do a reverse DNS lookup to detect this condition (9.3.2.4).

Technical Note—Reverse Lookup: A reverse-DNS lookup will be necessary to detect this condition. Regarding a reverse DNS lookup, the Windows 2000 SMTP service will do the reverse DNS lookup for us as long as it is enabled by the administrator, and it will insert an uncertified SMTP header, and all we will have to do is parse it.

9.3.2.5. SMTP VERIFY: The OnInMailSecurityEvent( ) method shall fire whenever a SMTP VERIFY command is detected.

Technical Note—Fishing Expedition: Hackers sometimes call this Verify call with randomly generated Email IDs to find valid accounts on a server, and then spam those IDs. This event will enable Logistics to identify such behavior.

9.3.2.6. SMTP EXPAND: The OnInMailSecurityEvent( ) method shall fire whenever a SMTP EXPAND command is detected.

Technical Note—Crown Jewels: Hackers sometimes try the EXPAND call to get a list of the entire directory of Email IDs from our server in order to spam those IDs. This event will enable Logistics to identify such behavior.

9.3.2.7. Patterns: The OnInMailSecurityEvent( ) method shall fire whenever non-standard send patterns are detected.

Technical Note—Out of Order: For instance, if the protocol sequence is out of order, or if non-standard protocol commands are received, fire this event for suspicious activity (then Logistics can start logging activity for a couple of minutes).

9.3.2.8. Telnet: The OnInMailSecurityEvent( ) method shall fire whenever a Telnet connection is attempted.

9.3.3. InMail Security Interface

900Email shall support these InMail Security Interface requirements:

9.3.3.1. In Mail Security API: The name of the interface and its associated methods shall be:
9.3.3.1.1. IKernelInMailSecurity
9.3.3.1.2. StartInMailSecurityLogging(time span)
9.3.3.1.3. StopInMailSecurityLogging( )
9.3.3.1.4. SendInMailSecurityNotification( )
   9.4. StoredMail Functionality

The Wrapper shall support these StoredMail Interface requirements to notify the 900Email system of actions taken (either copy or delete) on messages already stored in a Client's inbox:

9.4.1. StoredMail Interface

900Email shall support these StoredMail Interface requirements:

9.4.1.1. StoredMail API: The name of the interface and its associated methods shall be:
9.4.1.1.1. IKernelStoredMailEvents
9.4.1.1.2. OnStoredMailEvent( )

9.4.1.2. The OnStoredMailEvent( ) method shall support the following protocols:
9.4.1.2.1. POP3
9.4.1.2.2. IMAP4
9.4.1.2.3. MAPI
9.4.1.2.4. Etcetera: 900Email shall perhaps support more protocols not yet identified.

9.4.1.3. Delete Without Retrieve: The OnStoredMailEvent( ) method shall fire whenever email is deleted without retrieval.

Technical Note—For Refunds: 900Email will use this event to consider whether it needs to Refund EPostage (due if the Client had not yet retrieved the Email message).

9.4.1.4. Copied but Not Deleted: The OnMailProcessEvent( ) method shall fire whenever email is copied (retrieved) but not deleted from the server.

9.4.1.5. Copied and Deleted: The OnStoredMailEvent( ) method shall fire whenever email is copied and deleted from the server.

Technical Note—Distinguished Actions: The Wrapper shall distinguish between copy with and copy without a delete in case we need this for future functionality.

9.4.2. StoredMail Security Events Interface

900Email shall support these StoredMail Security Event Interface requirements:

9.4.2.1. StoredMail Security Event API: The name of the interface and its associated methods shall be:
9.4.2.1.1. IKernelStoredMailSecurityEvents
9.4.2.1.2. OnStoredMailSecurityEvent( )

9.4.2.2. Repeated Logon Failure: The OnStoredMailSecurityEvent( ) method shall fire whenever any user fails to establish a logon session after five consecutive attempts within a 10 minute period.

9.4.2.3. Patterns: The OnStoredMailSecurityEvent( ) method shall fire whenever non-standard retrieval patterns are detected.

Technical Note—Out of Order: For instance, if a POP3 log on session sends a TOP command with no subsequent message retrieval, then fire this event for suspicious activity (then Logistics can start logging activity for a couple few minutes).

9.4.3. StoredMail Security Interface

900Email shall support these StoredMail Security Interface requirements:

9.4.3.1. StoredMail Security API: The name of the interface and its associated methods shall be:
9.4.3.1.1. IKernelStoredMailSecurity
9.4.3.1.2. StartStoredMailSecurityLogging(time span)
9.4.3.1.3. StopStoredMailSecurityLogging( )
9.4.3.1.4. SendStoredMailSecurityNotification( )
   9.5. Performance

9.5.1. Simultaneous Incoming Messages: A single server running an email engine shall be able to support n number of simultaneous connections through the wrapper (while at the same time supporting our Retrieve capacity requirement just below, 9.5.2). [Marketing requires input from the wrapper developer to set this performance requirement.]

9.5.2. Simultaneous Retrieve Sessions: A single server running an email engine shall be able to support n number of simultaneous connections through the wrapper (while at the same time supporting our Incoming capacity requirement just above, 9.5.1). [Marketing requires input from the wrapper developer to set this performance requirement.]

Glossary

Accrued Revenue: 900Email recognizes our income only after we have completed our obligation to our Customer, that is, after the Client has retrieved the message (or in the case of a Guaranteed Reply, after he has replied).

Charge: Moving logical funds, like those needed to cover our Service Fee, from one account, like the Internal Collected Funds Account, into another, like our own corporate Accrued Revenue Account.

Client: Someone who has established a 900Email mail account with his own unique identifier (Email ID) on the system.

Collect: Crediting an EPostage amount consisting of the Client's required Rate (which includes his Client Portion and our Service Fee) to the Internal Collected Funds Account (by debiting the Customer's EPostage Account). These funds will not be recorded to the Client's EPostage Account, nor to our own Accrued Revenue Account, until the Client retrieves his message.

Credit: Adding a sum to the balance of an internal, logical bookkeeping account.

Custom Tier: A list of Email and Domain IDs, which list a Client creates, names and prices, which price 900Email charges to deliver an incoming message sent by a member of this group; a Client rate grouping.

Customer: Someone who maintains an EPostage account or who pays to send just a single message to a 900Email Client. The one who pays the bill is the true Customer. So, though the email senders may be far more remote from 900Email than our Clients, still, the email sender is our actual Customer to whom we have the greater obligation. We must please the Customer, or we fail. However, every Client automatically gets an EPostage account, so every Client is also a Customer.

Debit: Deducting a sum from the balance of an internal, logical bookkeeping account.

Domain ID: (also, Domain) That part of an Email ID that lies to the right of the @ sign. Vatican.org is an example of a Domain ID from PopeJohnPaulII@Vatican.org.

Email ID: The web-wide unique alphanumeric name, which distinguishes a single user's Email account. Arnold@900Email.com is an example Email ID.

EPostage System: This software enables the continuous buying, consuming, and crediting of the electronic postage used to send 900Email messages.

Guaranteed Reply: 900Email assures the Customer that a Client has pledged to respond personally to any Email message for which the sender pays both its EPostage Rate and the “Guaranteed Reply Rate.” The recipient Client has selected this rate, and expectedly, most Clients will price this feature higher than their EPostage Rates. If the Client does not Reply to the sender within the Guaranteed Reply Refund Period of 1 month, then 900Email will refund to the Customer both his EPostage and the Guaranteed Reply Rate that he paid to send that message. And to help cover our costs for the refund event, we charge the Client as though he had given the sender Prepaid EPostage, that is, $0.05.

Insufficient EPostage: An incoming Email message has this status when 900Email exhausts all possible sources of payment on behalf of the sender, Client Prepaid, Customer EPostage Account, and Automatic Purchase, while trying to cover the Client's delivery Rate.

Logical Account: Money is described as residing “logically” in an account when that account is an internal booking account, rather than in an actual, physical bank account.

Month-End System: This software enables 900Email to process accounts at the end of each calendar month in order to payout funds owed to our Clients.

Pay Out: Transferring physical funds out of a 900Email bank account to a Client in the form of a check or an electronic transfer into his own physical bank account or other third-party financial services account (like PayPal.com).

Payout Amount: The dollar total which 900Email calculates to remit to a Client that consists of funds in excess of the combined total of his specified EPostage Minimum Balance plus the EPostage he has purchased but not consumed (consumed, that is, by way of sending emails, refunds, premium fees, storage purchases, etc.).

Physical Account: Money is described as residing “physically” in an account when that account is an actual bank account. Also, an actual bank account (as contrasted with an internal bookkeeping account), is referred to as a “physical” account.

Prepaid Email: The Client can pay (with actual funds or with his good credit) to cover the cost of an incoming message. Thus, the sender does not have to pay EPostage to transmit a message to a recipient in this situation, and for this service 900Email charges our Client our EPostage Prepaid Rate of $0.05 (which currently equals our EPostage Minimum Rate).

Public Tier: A default category for all senders not identified on a Client's Custom Tiers, which Tier a Client cannot name, but he can price, which price 900Email charges to deliver an incoming message sent by a member of this group (i.e., sent by anyone not identified on any of a Client's Customer Tiers); a Client's default EPostage Rate.

Purchase: Acquiring EPostage (or some other product or service) by paying for it with actual money out of a Customer's physical bank account or other third-party payment service (like PayPal.com).

Record: After the Client retrieves an Email from his inbox, we charge our Service Fee (by debiting the Internal Collected Funds Account and crediting our own corporate Accrued Revenue Account), and we credit the recipient his Client Fee (by again debiting the Internal Collected Funds Account and crediting the Client's EPostage Account). Similarly, regarding Guaranteed Replies, we do not record the Client Portion, nor our Service Fee, until the Client sends a reply to the Customer.

Refund by Request: 900Email shall return a Customer's money to his EPostage Account whenever a Client has failed to retrieve a message from his inbox throughout the duration of the Refund Period.

Refund on Account Closure: 900Email shall return a Customer's money to his EPostage Account whenever a Client has failed to retrieve a message from his inbox throughout the duration of the Refund Period.

Refund on Delete: A refund triggered by a Client's active deletion of a message from his inbox without having been retrieved.

Refund on Timeout: 900Email shall return a Customer's money to his EPostage Account whenever a Client has failed to retrieve a message from his inbox throughout the duration of the Refund Period.

Refund Period: The length of time during which a Client can retrieve (view or download) a message from his inbox and receive his Client Portion. If the Refund Period expires without the Client ever accessing a message, that message is returned to the sender and his EPostage refunded to the Customer's EPostage Account.

Retrieve: When a Client accesses an Email message from his inbox, whether simply by displaying it on his screen, or by downloading it to his local disk storage. Service Fee. The percentage of EPostage collected on each retrieved Email message that 900Email charges.

Validate. Identifying the availability of a sufficient EPostage balance to pay for delivery of a particular Email message to a recipient Client.

1. A method for conducting fee-based email messaging comprising:
establishing by a prospective recipient of an email message a price for transmission of said email message;
collecting a non-zero fee equal to said established price from a sender of said email message; and
transmitting said email message to said recipient.

2. The method of claim 1, further comprising paying at least a portion of said collected fee to an entity designated by said recipient.

3. The method of claim 2 wherein said entity is said recipient.

4. The method of claim 1 wherein said message is an electronic text message.

5. The method of claim 1 wherein said message is an email voice message.

6. The method of claim 1 wherein said message includes audio-visual information.

7. The method of claim 1 wherein said collecting comprises receiving, along with said transmitted message, electronic postage corresponding to said established price.

8. The method of claim 1 wherein said collecting comprises debiting a private account of said sender an amount corresponding to said established price.

9. The method of claim 1 wherein said collecting comprises debiting said collected price from a credit card account of said sender.

10. The method of claim 1 wherein said establishing comprises:
providing a plurality of sender tiers, each said tier corresponding to a different category of senders and each said tier having a separate established price; and
determining the tier of said sender.

11. The method of claim 10 wherein said price for one of said plurality of tiers is zero.

12. The method of claim 1 wherein:
said establishing further comprises establishing by said prospective recipient of a client service price for performing a client service related to said email message;
said method further includes performing said client service; and
said collecting further includes collecting a client service fee corresponding to said client service price from said sender of said email message.

13. The method of claim 12 wherein said service comprises a service selected from the group consisting of reading said message, responding to said message, and forwarding said message within a defined time period.

14. The method of claim 12 wherein said service further includes reading said message, responding to said message, or forwarding said message within a rushed time frame.

15. The method of claim 12 and further comprising guaranteeing said service.

16. The method as in claim 15 wherein said guaranteeing comprises:
determining if said client service has been performed; and
refunding said collected client service fee to said sender if said service has not been performed.

17. The method of claim 12 wherein said establishing said client service price comprises:
providing a plurality of sender tiers, each said tier corresponding to a different category of senders and each said tier having a separate established price; and
determining the tier of said sender.

18. A method for conducting fee-based email messaging, said method comprising:
establishing a plurality of tiers of senders of email messages to a recipient, each said tier corresponding to a different category of senders; and
determining a price for email message transmission to said recipient for each said established tier of senders;
determining the recipient of an email message;
determining the tier of the sender of said email message to said recipient; and
charging said sender said price corresponding to said tier for an email message sent by said sender to said recipient.

19. The method of claim 18 wherein said determining comprises setting said message transmission price to zero for at least one of said established tiers.

20. The method of claim 18 further comprising transmitting said message from said identified sender to said recipient.

21. The method of claim 18 wherein one of said plurality of tiers includes substantially only immediate family members and friends of said recipient.

22. The method of claim 18 wherein one of said plurality of tiers includes substantially only work colleagues of said recipient.

23. The method of claim 18 wherein one of said plurality of tiers includes substantially only commercial advertisers.

24. A method for conducting fee-based messaging comprising:
establishing, for each of a plurality of recipients, a plurality of tiers of senders of messages to said recipient; and
determining a price for message transmission to said recipient for each said established tier of senders;
determining said recipient;
determining the tier of a sender of a message to said recipient; and
charging said sender said price corresponding to said tier for a message sent by said sender to said recipient.

25. A method for conducting fee-based messaging comprising:
presenting a sender with a price for transmission of a message to a recipient;
transmitting said message only if said sender pays said presented price; and
guaranteeing a transmission by said recipient of a responsive message to said sender within a defined time period.

26. The method of claim 25 wherein said guaranteeing comprises guaranteeing said transmission of said responsive message within a rushed time frame, wherein said rushed time frame is shorter than said defined time period.

27. The method of claim 25 wherein said defined time period is between one day and three days.

28. The method of claim 26 wherein said rushed time frame is less than one day.

29. The method of claim 25 wherein said presenting comprises consulting a database of prices established by said recipient.

30. The method of claim 25 wherein said guaranteeing comprises refunding said paid presented price to said sender if said recipient fails to reply to said sender within a defined time period.

31. The method of claim 25 wherein said guaranteeing comprises refunding said paid presented price to said sender if said recipient fails to reply to said sender within a rushed time frame.

32. The method of claim 25 wherein said message is an email message.

33. A method for conducting fee-based messaging comprising:
presenting a sender with a price for a transmission of a message to a recipient;
collecting a fee from said sender corresponding to said presented price;
transmitting said message to said recipient; and
refunding said collected fee if said transmitted message is not read by said recipient within a defined time period.

34. The method of claim 33 wherein said refunding comprises refunding said collected fee if said transmitted message is not read by said recipient within a rushed time frame.

35. The method of claim 33 wherein said presented price is established by said recipient.

36. The method of claim 33 wherein said presented price depends upon a tier of said sender.

37. The method of claim 33 wherein said refunding comprises crediting an account of said sender.

38. The method of claim 33 wherein said collecting comprises debiting a private account of said sender.

39. The method of claim 33 wherein said collecting comprises debiting a credit card account of said sender.

40. The method of claim 33, and further comprising paying a portion of said collected fee to said recipient.

41. The method of claim 33 wherein said message is an email message.

42. A method for conducting fee-based messaging comprising:
establishing a price for a transmission of a message based upon an identity of a prospective recipient of said message;
presenting a sender with said established price for said transmission of said message; and
transmitting said message only if said sender pays said presented established price.

43. The method of claim 42 wherein said price for transmission of said message is established by said recipient.

44. The method of claim 42 wherein said establishing further comprises:
providing a plurality of sender tiers, each said tier corresponding to a different category of senders and each said tier having a separate established price; and
determining the tier of said sender.

45. The method of claim 42, and further comprising paying a portion of said established price to said recipient.

46. The method of claim 42 wherein said established price is also based upon a degree of promptness with which said transmitted message is read by said recipient.

47. The method of claim 42 wherein said established price is paid employing stored indicia of electronic postal value.

48. The method of claim 42 wherein said transmitted message is an email message.

49. The method of claim 42 wherein said transmitted message is a voice message.

50. The method of claim 42 wherein said transmitted message comprises graphical information.

51. The method of claim 42 wherein said transmitting comprises a live telephone conversation.

52. The method of claim 42 wherein said transmitted message comprises audio-visual information.

53. The method of claim 42, further comprising:
establishing a price for composing and communicating a message to said sender in response to said transmitted message; and
sending said composed responsive message to said sender only if said sender pays said established price for said composed responsive message.

54. A computer program product having a computer readable medium having a computer program logic recorded thereon for conducting fee-based messaging, the computer program product comprising:
code for receiving an identity of a recipient from a sender;
code for determining a price for transmission of a message to said recipient based on said received identity;
code for collecting said determined price from said sender; and
code for transmitting said message to said recipient.

55. The computer program product of claim 54 further comprising code for maintaining a database of variables affecting a price of message transmission.

56. The computer program product of claim 55 wherein said database includes data describing a tier of said sender.

57. The computer program product of claim 55 wherein said database includes a list of services performable by at least one of a group of possible message recipients.

58. The computer program product of claim 55 wherein said database includes a registry of possible message recipients.

59. The computer program product of claim 55 wherein said database includes a list of data formats available for transmission to said recipient.

60. Apparatus for conducting fee-based messaging, comprising:
a global network;
a plurality of user sites, each said user site including communication equipment suitable for communicating data over said global network by both senders and recipients;
a plurality of communication links coupling said plurality of user sites to said global network; and
a service provider system coupled to said global network, said service provider system including a computer system and a database of communication recipients, and being configured to identify a price, determined by each said recipient, to be charged to a sender for contacting each said communication recipient.

61. The apparatus of claim 60 wherein said price is identified based on an identity of said sender.

62. The apparatus of claim 60 wherein said communication equipment included in at least one of said user sites is a personal computer.

63. The apparatus of claim 60 wherein said global network is the Internet.

64. The apparatus of claim 60 wherein said global network is a private network.

65. The apparatus of claim 60 wherein said user sites are usable by both said senders and said recipients.

66. The apparatus of claim 60 wherein said service provider system further includes a database of communication cost variables.

67. The apparatus of claim 66 wherein said database of communication cost variables includes information describing a tier of said sender.

68. The apparatus of claim 66 wherein said database of communication cost variables includes information describing a data format of a message.

69. The apparatus of claim 66 wherein said database of communication cost variables includes information describing a service performable by each said recipient.

70. A method for authenticating the identity of a sender of a message to a recipient over a network, the method comprising:
combining an identification of said sender and an identification of said recipient into a single combined identification;
encrypting said combined identification; and
transmitting a message including said encrypted combined identification.

71. The method of claim 70 wherein said combining comprises establishing a defined time period after which said combined identification expires.

72. A method for communicating over a network, the method comprising:
composing a message, by a sender, for communication to a recipient in a fee-based messaging system;
including an encrypted message within said composed message thereby creating a flagged message, said included encrypted message indicating a right to cost-free transmission of said flagged message through said fee-based messaging system; and
transmitting said flagged message without charge to said recipient.

73. A method for controlling access to a recipient, the method comprising:
establishing a plurality of tiers of communication with a recipient by a sender;
determining a separate access code for each said tier, thereby establishing a plurality of access codes; and
providing a selected access code, of said plurality of access codes to said sender, corresponding to a particular tier of said tiers.

74. The method of claim 73 wherein said providing comprises adding said sender to a list of senders authorized to access said particular tier.
